(19) United States
(12) Patent Application Publication
(10) Pub. No.: US 2015/0329927 A1
(43) Pub. Date: Nov. 19, 2015

(54) Sugar Separation and Purification Through Filtration

(71) Applicant: Sweetwater Energy, Inc., Rochester, NY (US)

(72) Inventor: Sarad Parekh, Pittsford, NY (US)

(21) Appl. No.: 14/713,906

(22) Filed: May 15, 2015

Related U.S. Application Data
(60) Provisional application No. 61/994,840, filed on May 17, 2014.

(51) Int. Cl. C13K 1/04; C13K 13/00

(52) U.S. Cl. CPC C13K 1/04; C13K 13/002; C13K 13/00; C13K 13/007

(57) ABSTRACT

Methods are disclosed that separate xylose from glucose in pretreated and enzyme-hydrolyzed cellulosic and/or lignocellulosic biomass. Filtration, especially diafiltration is used to reduce fermentation-impeding substances and xylose from glucose and growth-promoting factors.

### CROSS-REFERENCE

This application claims the benefit of U.S. Provisional Application No. 61/994,840, filed May 17, 2014, which application is incorporated herein by reference in its entirety.

### BACKGROUND OF THE INVENTION

Filtration methods have been used to separate monosaccharides, such as glucose or mannose from oligosaccharides and polysaccharides from starch hydrolysates. Nanofiltration has also been used to separate chemical compounds having a small molar mass from compounds having only a slightly larger molar mass in spent sulphite liquor. To date, no one method utilizes ultrafiltration or nanofiltration to separate pentose sugars (C5 sugars) from hexose sugars (C6 sugars), which can be a much more difficult task given the similar properties of these molecules. Yet, many fermentation organisms cannot use pentose sugars or, if co-fermenting, only use them after hexose sugars are exhausted in the fermentation process.

This is not a problem in starch-sourced fermentation plants. The hydrolysis of the starch yields only glucose, a C6 sugar. However, with the inclusion of cellulosic or lignocellulosic materials, C5 sugars such as xylose and arabinose can amount to, for example, 10-50% of the total sugar yields following pretreatment and enzymatic hydrolysis.

Further, pretreatment of these plant materials can result in the production of inhibitors (or their extraction from plant materials), such as acids (especially acetic acid), furans, phenols, HMF (hydroxymethyl furfural), and other compounds that can interfere with fermentation. Lignins can also be extracted and may need to be separated from sugars.

Given the right parameters, filtration can separate lignin from hydrolyzed monosaccharides and even reduce the inhibitor content. For certain fermentation operations, however, the problem is to separate C5 sugars from C6 sugars. Described herein are methods and systems for recovering xylose from biomass hydrolysates and from glucose.

### SUMMARY OF THE INVENTION

In a first aspect, disclosed herein are methods of clarifying and refining a sugar hydrolyzate comprising C5 sugars and C6 sugars, the method comprising: contacting the sugar hydrolyzate with a first nanofiltration membrane to produce a C6 enriched retentate and a C5 enriched filtrate, wherein the contacting is diafiltration wherein water is added to the sugar hydrolyzate during the contacting.

The methods of the first aspect can further comprise contacting the sugar hydrolyzate with an ultrafiltration membrane to remove color molecules and suspended solids. In some embodiments, the sugar hydrolyzate is contacted with the ultrafiltration membrane prior to the nanofiltration membrane.

The methods of the first aspect can further comprise contacting the sugar hydrolyzate with a second nanofiltration membrane to remove one or more inhibitors. In some embodiments, the one or more inhibitors are removed prior to producing the C6 enriched retentate and the C5 enriched retentate. In some embodiments, the one or more inhibitors comprise furfural, hydroxymethylfurfural, acetic acid, formic acid, or a combination thereof.

The methods of the first aspect can further comprise contacting the C6 enriched retentate or the C5 enriched retentate with a reverse osmosis membrane to concentrate the sugars.

In some embodiments of the first aspect, the C6 enriched retentate comprises a C6 sugar content that is at least about a 1.1 times higher than the sugar hydrolyzate, based on total sugar content. In some embodiments, the C6 enriched retentate comprises a C6 sugar content that is at least about a 1.5 times higher than the sugar hydrolyzate, based on total sugar content. In some embodiments, the C6 enriched retentate comprises a C6 sugar content that is at least about a 2 times higher than the sugar hydrolyzate, based on total sugar content.

In some embodiments of the first aspect, the C6 enriched retentate has a transparency that is at least about 2 fold higher than the sugar hydrolyzate when measured at 600 nm. In some embodiments, the C6 enriched retentate has a transparency that is at least about 5 fold higher than the sugar hydrolyzate when measured at 600 nm. In some embodiments, the C6 enriched retentate has a transparency that is at least about 10 fold higher than the sugar hydrolyzate when measured at 600 nm. In some embodiments, the C6 enriched retentate has a transparency that is at least about 10% higher than the sugar hydrolyzate when measured at 600 nm. In some embodiments, the C6 enriched retentate has a transparency that is at least about 25% higher than the sugar hydrolyzate when measured at 600 nm. In some embodiments, the C6 enriched retentate has a transparency that is at least about 50% higher than the sugar hydrolyzate when measured at 600 nm.

In some embodiments of the first aspect, the C6 enriched retentate comprises an amount of one or more inhibitors that is, individually, at least about 10% lower than in the sugar hydrolyzate by weight. In some embodiments, the C6 enriched retentate comprises an amount of one or more inhibitors that is, individually, at least about 50% lower than in the sugar hydrolyzate by weight. In some embodiments, the C6 enriched retentate comprises an amount of one or more inhibitors that is, individually, at least about 75% lower than in the sugar hydrolyzate by weight. In some embodiments, the C6 enriched retentate comprises an amount of one or more inhibitors that is, individually, from 10% to about 100% lower than in the sugar hydrolyzate by weight. In some embodiments, the one or more inhibitors comprise furfural, hydroxymethylfurfural, acetic acid, formic acid, or a combination thereof.

In some embodiments of the first aspect, the C5 enriched filtrate comprises a C5 sugar content that is at least about a 1.1 times higher than the sugar hydrolyzate, based on total sugar content. In some embodiments, the C5 enriched filtrate comprises a C5 sugar content that is at least about a 1.5 times higher than the sugar hydrolyzate, based on total sugar content. In some embodiments, the C5 enriched filtrate comprises a C5 sugar content that is at least about a 2 times higher than the sugar hydrolyzate, based on total sugar content.

In some embodiments of the first aspect, the C5 enriched filtrate has a transparency that is at least about 2 fold higher than the sugar hydrolyzate when measured at 600 nm. In some embodiments, the C5 enriched filtrate has a transparency that is at least about 5 fold higher than the sugar hydrolyzate when measured at 600 nm. In some embodiments, the C5 enriched filtrate has a transparency that is at least about 10 fold higher than the sugar hydrolyzate when measured at 600 nm. In some embodiments, the C5 enriched filtrate has a transparency that is at least about 10% higher than the sugar hydrolyzate when measured at 600 nm. In some embodiments, the C5 enriched filtrate has a transparency that is at least about 25% higher than the sugar hydrolyzate when measured at 600 nm. In some embodiments, the C5 enriched filtrate has a transparency that is at least about 50% higher than the sugar hydrolyzate when measured at 600 nm.

In some embodiments of the first aspect, the C5 enriched filtrate comprises an amount of one or more inhibitors that is, individually, at least about 10% lower than in the sugar hydrolyzate by weight. In some embodiments, the C5 enriched filtrate comprises an amount of one or more inhibitors that is, individually, at least about 50% lower than in the sugar hydrolyzate by weight. In some embodiments, the C5 enriched filtrate comprises an amount of one or more inhibitors that is, individually, at least about 75% lower than in the sugar hydrolyzate by weight. In some embodiments, the C5 enriched filtrate comprises an amount of one or more inhibitors that is, individually, from 10% to about 100% lower than in the sugar hydrolyzate by weight.

In some embodiments of the first aspect, the one or more inhibitors comprise furfural, hydroxymethylfurfural, acetic acid, formic acid, or a combination thereof.

In some embodiments of the first aspect, the first nanofiltration membrane is a NF99, NF99HF, NF-45, NF-90, NF-200, NF-400, SU-210, SU-220, SU-600, SU-610, NF9790, or NF 9940 membrane. In some embodiments, the first nanofiltration membrane is a NF9790 membrane. In some embodiments, the first nanofiltration membrane is a NF9940 membrane.

In some embodiments of the first aspect, the first nanofiltration membrane is a spiral wound nanofiltration membrane. In some embodiments, the first nanofiltration membrane is a tubular nanofiltration membrane. In some embodiments, the first nanofiltration membrane is a hollow fiber nanofiltration membrane.

In some embodiments of the first aspect, the first nanofiltration membrane has a pore size of about 1 nm to about 2 nm. In some embodiments, the first nanofiltration membrane has a molecular weight cutoff of about 0.1 kDa to about 5 kDa.

In some embodiments of the first aspect, the first nanofiltration membrane has a MgSO₄ rejection of at least about 80%. In some embodiments, the first nanofiltration membrane has a MgSO₄ rejection of about 80% to about 99%. In some embodiments, the first nanofiltration membrane has a MgSO₄ rejection of about 99%. In some embodiments, the first nanofiltration membrane has a MgSO₄ rejection of about 97%.

In some embodiments of the first aspect, the first nanofiltration membrane has a NaCl rejection of at least about 30%. In some embodiments, the first nanofiltration membrane has a NaCl rejection of about 30% to 99%. In some embodiments, the first nanofiltration membrane has a NaCl rejection of about 40%. In some embodiments, the first nanofiltration membrane has a NaCl rejection of about 90%.

In some embodiments of the first aspect, the second nanofiltration membrane is a NF99, NF99HF, NF-45, NF-90, NF-200, NF-400, SU-210, SU-220, SU-600, SU-610, NF9790, or NF 9940 membrane. In some embodiments, the second nanofiltration membrane is a NF9790 membrane. In some embodiments, the second nanofiltration membrane is a NF9940 membrane.

In some embodiments of the first aspect, the second nanofiltration membrane is a spiral wound nanofiltration membrane. In some embodiments, the second nanofiltration membrane is a tubular nanofiltration membrane. In some embodiments, the second nanofiltration membrane is a hollow fiber nanofiltration membrane.

In some embodiments of the first aspect, the second nanofiltration membrane has a pore size of about 1 nm to about 2 nm.

In some embodiments of the first aspect, the second nanofiltration membrane has a molecular weight cutoff of about 0.1 kDa to about 5 kDa.

In some embodiments of the first aspect, the second nanofiltration membrane has a MgSO₄ rejection of at least about 80%. In some embodiments, the second nanofiltration membrane has a MgSO₄ rejection of about 80% to about 99%. In some embodiments, the second nanofiltration membrane has a MgSO₄ rejection of about 99%. In some embodiments, the second nanofiltration membrane has a MgSO₄ rejection of about 97%.

In some embodiments of the first aspect, the second nanofiltration membrane has a NaCl rejection of at least about 30%. In some embodiments, the second nanofiltration membrane has a NaCl rejection of about 30% to 99%. In some embodiments, the second nanofiltration membrane has a NaCl rejection of about 40%. In some embodiments, the second nanofiltration membrane has a NaCl rejection of about 90%.

In some embodiments of the first aspect, the ultrafiltration membrane is an ES404 membrane.

In some embodiments of the first aspect, the ultrafiltration membrane has a pore size of about 2 nm to about 100 nm.

In some embodiments of the first aspect, the ultrafiltration membrane has a molecular weight cutoff of from about 5 kDa to about 5000 kDa. In some embodiments, the ultrafiltration membrane has a molecular weight cutoff of about 4000 kDa.

In some embodiments of the first aspect, contacting the sugar hydrolysate and the first nanofiltration membrane is performed in a cross-flow configuration. In some embodiments, contacting the sugar hydrolysate and the first nanofiltration membrane is performed in a dead-end configuration.

In some embodiments of the first aspect, contacting the sugar hydrolysate and the ultrafiltration membrane is performed in a cross-flow configuration. In some embodiments, contacting the sugar hydrolysate and the ultrafiltration membrane is performed in a dead-end configuration.

In some embodiments of the first aspect, contacting the sugar hydrolysate and the second nanofiltration membrane is performed in a cross-flow configuration. In some embodiments, contacting the sugar hydrolysate and the second nanofiltration membrane is performed in a dead-end configuration.

In some embodiments of the first aspect, contacting the sugar hydrolyzate with the first nanofiltration membrane or the second nanofiltration membrane is performed at a pressure of about 10 psi to about 1000 psi. In some embodiments, contacting the sugar hydrolyzate with the first nanofiltration membrane or the second nanofiltration membrane is performed at a pressure of about 100 psi to about 900 psi. In some embodiments, contacting the sugar hydrolyzate with the first nanofiltration membrane or the second nanofiltration membrane is performed at a pressure of about 250 psi to about 750 psi. In some embodiments, contacting the sugar hydrolyzate with the first nanofiltration membrane or the second nanofiltration membrane is performed at a pressure of about 500 psi to about 600 psi.

In some embodiments of the first aspect, the sugar hydrolyzate is at a temperature of about 20° C. to about 80° C.

In some embodiments of the first aspect, the sugar hydrolyzate is at a pH of from about 1 to about 14. In some embodiments, the sugar hydrolyzate is at a pH of from about 3 to about 11. In some embodiments, the sugar hydrolyzate is at a pH of from about 4 to about 9.

In some embodiments of the first aspect, the water is added in an amount of from about 0.1 to about 10 diafiltration volumes. In some embodiments, the water is added in an amount of from about 0.25 to about 6 diafiltration volumes. In some embodiments, the water is added in an amount of from about 0.1 to about 1 diafiltration volumes. In some embodiments, the water is added in an amount of from about 0.1 to about 0.5 diafiltration volumes.

In some embodiments of the first aspect, the water is added continuously.

In some embodiments of the first aspect, the water is added one or more times during contacting. In some embodiments, the water is added when a retentate volume reaches from 10% to about 75% of a starting volume of the sugar hydrolyzate. In some embodiments, the water is added when a retentate volume reaches from 15% to about 50% of a starting volume of the sugar hydrolyzate. In some embodiments, the water is added when a retentate volume reaches about 25% of a starting volume of the sugar hydrolyzate.

In some embodiments of the first aspect, the C6 sugars comprise glucose. In some embodiments, the C5 sugars comprise xylose, arabinose, or a combination thereof.

In some embodiments of the first aspect, the sugar hydrolyzate comprises from about 1% to about 90% sugars by weight. In some embodiments, the sugar hydrolyzate comprises from about 1% to about 50% sugars by weight. In some embodiments, the sugar hydrolyzate comprises from about 1% to about 35% sugars by weight. In some embodiments, the sugar hydrolyzate comprises from about 5% to about 50% sugars by weight.

In some embodiments of the first aspect, the sugar hydrolyzate comprises the C5 sugars and the C6 sugars in a 5:95% ratio to a 95:5% ratio by weight. In some embodiments, the sugar hydrolyzate comprises the C5 sugars and the C6 sugars in a 25:75% ratio to a 75:25% ratio by weight.

In some embodiments of the first aspect, the sugar hydrolyzate was produced by pretreating or hydrolyzing a biomass comprising cellulosic, hemicellulosic, or lignocellulosic material. In some embodiments, pretreating or hydrolyzing the biomass comprises mechanical size reduction, hot water treatment, acid treatment, base treatment, steam explosion, acid-catalyzed steam explosion, ammonia fiber/freeze explosion, enzymatic hydrolysis, or a combination thereof. In some embodiments, pretreating or hydrolyzing the biomass comprises mechanical size reduction, acid treatment and enzymatic hydrolysis. In some embodiments, the sugar hydrolysate was produced by: (1) hydrating the biomass in an acidic medium; (2) mechanical size reduction of the biomass; (3) heating the biomass; and (4) enzymatically hydrolyzing the biomass. In some embodiments, the sugar hydrolysate was produced by: (1) pretreating the biomass comprising lignocellulosic material with hot water or an acid to solubilize hemicellulose in the biomass, (2) substantially separating solubilized hemicellulose from remaining lignocellulosic solids, and (3) enzymatically hydrolyzing cellulose in the remaining lignocellulosic solids. In some embodiments, the sugar hydrolysate was produced by: (a) pretreating a biomass comprising cellulosic, hemicellulosic, or lignocellulosic material to produce a pretreated biomass comprising solid particles, wherein at least 50% of the solid particles have a size of less than 1.5 mm, and optionally a yield of C5 monomers and/or dimers that is at least 50% of a theoretical maximum, wherein pretreating comprises: (i) hydration of the biomass in an aqueous medium to produce a hydrated biomass, (ii) mechanical size reduction of the hydrated biomass to produce the solid particles, and (iii) heating the hydrated biomass for a time sufficient to produce the pretreated biomass comprising the optional yield of C5 monosaccharides and/or disaccharides; and (b) hydrolyzing the pretreated biomass composition with one or more enzymes for a time sufficient to produce the sugar hydrolyzate. In some embodiments, the aqueous medium comprises and acid. In some embodiments, the acid is sulfuric acid, peroxyacetic acid, lactic acid, formic acid, acetic acid, citric acid, phosphoric acid, hydrochloric acid, sulfurous acid, chloroacetic acid, dichloroacetic acid, trichloroacetic acid, trifluoroacetic acid, oxalic acid, benzoic acid, or a combination thereof.

In a second aspect, disclosed are methods of refining a sugar hydrolyzate comprising C5 sugars and C6 sugars, the methods comprising: (a) contacting the sugar hydrolyzate with a microfiltration or ultrafiltration membrane to remove color molecules and suspended solids; (b) contacting the sugar hydrolyzate with a first nanofiltration membrane to remove one or more inhibitors; (c) contacting the sugar hydrolyzate with a second nanofiltration membrane to produce a C6 enriched retentate and a C5 enriched filtrate.

In some embodiments of the second aspect, the contacting the sugar hydrolyzate with the first nanofiltration membrane is diafiltration wherein water is added to the sugar hydrolyzate during the contacting.

In some embodiments of the second aspect, the contacting the sugar hydrolyzate with the second nanofiltration membrane is diafiltration wherein water is added to the sugar hydrolyzate during the contacting.

In some embodiments of the second aspect, the contacting the sugar hydrolyzate with the microfiltration or ultrafiltration membrane is diafiltration wherein water is added to the sugar hydrolyzate during the contacting.

In a third aspect, disclosed are methods of refining a raw sugar hydrolyzate comprising C5 sugars and C6 sugars, the method comprising: (a) contacting the raw sugar hydrolyzate with a microfiltration or ultrafiltration membrane to produce a semi-refined sugar hydrolyzate by removing color molecules and suspended solids; (b) contacting the semi-refined sugar hydrolyzate with a first nanofiltration membrane to produce a refined sugar hydrolyzate by removing one or more inhibitors; (c) contacting the refined sugar hydrolyzate with a second nanofiltration membrane to produce a C6 enriched retentate and a C5 enriched filtrate. In some embodiments of the third aspect, the contacting the sugar hydrolyzate with the microfiltration or ultrafiltration membrane is diafiltration wherein water is added to the sugar hydrolyzate during the contacting.

In a fourth aspect, disclosed are methods of refining a sugar hydrolyzate comprising C5 sugars and C6 sugars produced by the pretreatment or hydrolysis of lignocellulosic material, the method comprising: (a) contacting the sugar hydrolyzate with a microfiltration or ultrafiltration membrane to produce a retentate comprising color molecules and suspended solids and a filtrate comprising C5 sugars and C6 sugars; (b) contacting the filtrate comprising C5 sugars and C6 sugars with a first nanofiltration membrane to produce a nanofiltration retentate comprising C5 and C6 sugars and a nanofiltration filtrate comprising one or more inhibitors; (c) contacting the nanofiltration retentate comprising C5 and C6 sugars with a second nanofiltration membrane to produce a C6 enriched retentate and a C5 enriched filtrate.

In some embodiments of the fourth aspect, contacting the filtrate comprising C5 sugars and C6 sugars with the first nanofiltration membrane is diafiltration wherein water is added to the filtrate comprising C5 sugars and C6 sugars during the contacting.

In some embodiments of the fourth aspect, contacting the nanofiltration retentate comprising C5 and C6 sugars with the second nanofiltration membrane is diafiltration wherein water is added to the nanofiltration retentate comprising C5 and C6 sugars during the contacting.

In some embodiments of the fourth aspect, contacting the sugar hydrolyzate with the microfiltration or ultrafiltration membrane is diafiltration wherein water is added to the sugar hydrolyzate during the contacting.

The methods of the fourth aspect can further comprise contacting the nanofiltration filtrate with a reverse osmosis membrane to recover water.

In a fifth aspect, disclosed are methods of producing sugars, the methods comprising: (a) pretreating a biomass composition comprising lignocellulosic material, wherein pretreating comprises: (i) hydration of the biomass composition in an aqueous medium, (ii) mechanical size reduction of the biomass composition to produce a mixture of solid particles wherein at least 50% of the solid particles have a size of less than 1.5 mm, and (iii) heating the biomass composition; (b) hydrolyzing the biomass composition with one or more enzymes to produce a sugar hydrolyzate comprising C5 sugars and C6 sugars; and (c) contacting the sugar hydrolyzate with a first nanofiltration membrane to produce a C6 enriched retentate and a C5 enriched filtrate.

In some embodiments of the fifth aspect, the contacting is diafiltration wherein water is added to the sugar hydrolyzate during the contacting.

The methods of the fifth aspect can further comprise contacting the sugar hydrolyzate with an ultrafiltration membrane to remove color molecules and suspended solids. In some embodiments, the sugar hydrolyzate is contacted with the ultrafiltration membrane prior to the nanofiltration membrane.

The methods of the fifth aspect can further comprise contacting the sugar hydrolyzate with a second nanofiltration membrane to remove one or more inhibitors. In some embodiments, the one or more inhibitors are removed prior to producing the C6 enriched retentate and the C5 enriched retentate.

In some embodiments of the fifth aspect, contacting the sugar hydrolyzate with the nanofiltration membrane is diafiltration wherein water is added to the sugar hydrolyzate during the contacting.

In some embodiments of the fifth aspect, contacting the sugar hydrolyzate with the second nanofiltration membrane is diafiltration wherein water is added to the sugar hydrolyzate during the contacting.

In some embodiments of the fifth aspect, contacting the sugar hydrolyzate with the ultrafiltration membrane is diafiltration wherein water is added to the sugar hydrolyzate during the contacting.

The methods of the second, third, fourth or fifth aspects can further comprise contacting the C6 enriched retentate or the C5 enriched retentate with a reverse osmosis membrane to concentrate the sugars.

In some embodiments of the second, third, fourth, or fifth aspects, the C6 enriched retentate comprises a C6 sugar content that is at least about a 1.1 times higher than the sugar hydrolyzate, based on total sugar content. In some embodiments, the C6 enriched retentate comprises a C6 sugar content that is at least about a 1.5 times higher than the sugar hydrolyzate, based on total sugar content. In some embodiments, the C6 enriched retentate comprises a C6 sugar content that is at least about a 2 times higher than the sugar hydrolyzate, based on total sugar content.

In some embodiments of the second, third, fourth, or fifth aspects, the C6 enriched retentate has a transparency that is at least about 2 fold higher than the sugar hydrolyzate when measured at 600 nm. In some embodiments, the C6 enriched retentate has a transparency that is at least about 5 fold higher than the sugar hydrolyzate when measured at 600 nm. In some embodiments, the C6 enriched retentate has a transparency that is at least about 10 fold higher than the sugar hydrolyzate when measured at 600 nm.

In some embodiments of the second, third, fourth, or fifth aspects, the C6 enriched retentate has a transparency that is at least about 10% higher than the sugar hydrolyzate when measured at 600 nm. In some embodiments, the C6 enriched retentate has a transparency that is at least about 25% higher than the sugar hydrolyzate when measured at 600 nm. In some embodiments, the C6 enriched retentate has a transparency that is at least about 50% higher than the sugar hydrolyzate when measured at 600 nm.

In some embodiments of the second, third, fourth or fifth aspects, the C6 enriched retentate comprises an amount of one or more inhibitors that is, individually, at least about 10% lower than in the sugar hydrolyzate by weight. In some embodiments, the C6 enriched retentate comprises an amount of one or more inhibitors that is, individually, at least about 50% lower than in the sugar hydrolyzate by weight. In some embodiments, the C6 enriched retentate comprises an amount of one or more inhibitors that is, individually, at least about 75% lower than in the sugar hydrolyzate by weight. In some embodiments, the C6 enriched retentate comprises an amount of one or more inhibitors that is, individually, from 10% to about 100% lower than in the sugar hydrolyzate by weight. In some embodiments, the one or more inhibitors comprise furfural, hydroxymethylfurfural, acetic acid, formic acid, or a combination thereof.

In some embodiments of the second, third, fourth or fifth aspects, the first nanofiltration membrane is a NF99, NF99HF, NF-45, NF-90, NF-200, NF-400, SU-210, SU-220, SU-600, SU-610, NF9790, or NF 9940 membrane. In some embodiments, the first nanofiltration membrane is a NF9790 membrane. In some embodiments, the first nanofiltration membrane is a NF9940 membrane.

In some embodiments of the second, third, fourth or fifth aspects, the first nanofiltration membrane is a spiral wound nanofiltration membrane. In some embodiments, the first nanofiltration membrane is a tubular nanofiltration membrane. In some embodiments, the first nanofiltration membrane is a hollow fiber nanofiltration membrane.

In some embodiments of the second, third, fourth or fifth aspects, the first nanofiltration membrane has a pore size of about 1 nm to about 2 nm.

In some embodiments of the second, third, fourth or fifth aspects, the first nanofiltration membrane has a molecular weight cutoff of about 0.1 kDa to about 5 kDa.

In some embodiments of the second, third, fourth or fifth aspects, the first nanofiltration membrane has a MgSO₄ rejection of at least about 80%. In some embodiments, the first nanofiltration membrane has a MgSO₄ rejection of about 80% to about 99%. In some embodiments, the first nanofiltration membrane has a MgSO₄ rejection of about 99%. In some embodiments, the first nanofiltration membrane has a MgSO₄ rejection of about 97%.

In some embodiments of the second, third, fourth or fifth aspects, the first nanofiltration membrane has a NaCl rejection of at least about 30%. In some embodiments, the first nanofiltration membrane has a NaCl rejection of about 30% to 99%. In some embodiments, the first nanofiltration membrane has a NaCl rejection of about 40%. In some embodiments, the first nanofiltration membrane has a NaCl rejection of about 90%.

In some embodiments of the second, third, fourth or fifth aspects, the second nanofiltration membrane is a NF99, NF99HF, NF-45, NF-90, NF-200, NF-400, SU-210, SU-220, SU-600, SU-610, NF9790, or NF 9940 membrane. In some embodiments, the second nanofiltration membrane is a NF9790 membrane. In some embodiments, the second nanofiltration membrane is a NF9940 membrane.

In some embodiments of the second, third, fourth or fifth aspects, the second nanofiltration membrane is a spiral wound nanofiltration membrane. In some embodiments, the second nanofiltration membrane is a tubular nanofiltration membrane. In some embodiments, the second nanofiltration membrane is a hollow fiber nanofiltration membrane.

In some embodiments of the second, third, fourth or fifth aspects, the second nanofiltration membrane has a pore size of about 1 nm to about 2 nm.

In some embodiments of the second, third, fourth or fifth aspects, the second nanofiltration membrane has a molecular weight cutoff of about 0.1 kDa to about 5 kDa.

In some embodiments of the second, third, fourth or fifth aspects, the second nanofiltration membrane has a MgSO₄ rejection of at least about 80%. In some embodiments, the second nanofiltration membrane has a MgSO₄ rejection of about 80% to about 99%. In some embodiments, the second nanofiltration membrane has a MgSO₄ rejection of about 99%. In some embodiments, the second nanofiltration membrane has a MgSO₄ rejection of about 97%.

In some embodiments of the second, third, fourth or fifth aspects, the second nanofiltration membrane has a NaCl rejection of at least about 30%. In some embodiments, the second nanofiltration membrane has a NaCl rejection of about 30% to 99%. In some embodiments, the second nanofiltration membrane has a NaCl rejection of about 40%. In some embodiments, the second nanofiltration membrane has a NaCl rejection of about 90%.

In some embodiments of the second, third, fourth or fifth aspects, the ultrafiltration membrane is an ES404 membrane.

In some embodiments of the second, third, fourth or fifth aspects, the ultrafiltration membrane has a pore size of about 2 nm to about 100 nm.

In some embodiments of the second, third, fourth or fifth aspects, the ultrafiltration membrane has a molecular weight cutoff of from about 5 kDa to about 5000 kDa. In some embodiments, the ultrafiltration membrane has a molecular weight cutoff of about 4000 kDa.

In some embodiments of the second, third, fourth or fifth aspects, contacting the sugar hydrolysate and the first nanofiltration membrane is performed in a cross-flow configuration. In some embodiments, contacting the sugar hydrolysate and the first nanofiltration membrane is performed in a dead-end configuration.

In some embodiments of the second, third, fourth or fifth aspects, contacting the sugar hydrolysate and the ultrafiltration membrane is performed in a cross-flow configuration. In some embodiments, contacting the sugar hydrolysate and the ultrafiltration membrane is performed in a dead-end configuration.

In some embodiments of the second, third, fourth or fifth aspects, contacting the sugar hydrolysate and the second nanofiltration membrane is performed in a cross-flow configuration. In some embodiments, contacting the sugar hydrolysate and the second nanofiltration membrane is performed in a dead-end configuration.

In some embodiments of the second, third, fourth or fifth aspects, contacting the sugar hydrolyzate with the first nanofiltration membrane or the second nanofiltration membrane is performed at a pressure of about 10 psi to about 1000 psi. In some embodiments, contacting the sugar hydrolyzate with the first nanofiltration membrane or the second nanofiltration membrane is performed at a pressure of about 100 psi to about 900 psi. In some embodiments, contacting the sugar hydrolyzate with the first nanofiltration membrane or the second nanofiltration membrane is performed at a pressure of about 250 psi to about 750 psi. In some embodiments, contacting the sugar hydrolyzate with the first nanofiltration membrane or the second nanofiltration membrane e is performed at a pressure of about 500 psi to about 600 psi.

In some embodiments of the second, third, fourth or fifth aspects, the sugar hydrolyzate is at a temperature of about 20° C. to about 80° C.

In some embodiments of the second, third, fourth or fifth aspects, the sugar hydrolyzate is at a pH of from about 1 to about 14. In some embodiments, the sugar hydrolyzate is at a pH of from about 3 to about 11. In some embodiments, the sugar hydrolyzate is at a pH of from about 4 to about 9.

In some embodiments of the second, third, fourth or fifth aspects, the water is added in an amount of from about 0.1 to about 10 diafiltration volumes. In some embodiments, the water is added in an amount of from about 0.25 to about 6 diafiltration volumes. In some embodiments, the water is added in an amount of from about 0.1 to about 1 diafiltration volumes. In some embodiments, the water is added in an amount of from about 0.1 to about 0.5 diafiltration volumes.

In some embodiments of the second, third, fourth or fifth aspects, the water is added continuously.

In some embodiments of the second, third, fourth or fifth aspects, the water is added one or more times during contacting. In some embodiments, the water is added when a retentate volume reaches from 10% to about 75% of a starting volume of the sugar hydrolyzate. In some embodiments, the water is added when a retentate volume reaches from 15% to about 50% of a starting volume of the sugar hydrolyzate. In some embodiments, the water is added when a retentate volume reaches about 25% of a starting volume of the sugar hydrolyzate.

In some embodiments of the second, third, fourth or fifth aspects, the C6 sugars comprise glucose.

In some embodiments of the second, third, fourth or fifth aspects, the C5 sugars comprise xylose, arabinose, or a combination thereof.

In some embodiments of the second, third, fourth or fifth aspects, the sugar hydrolyzate comprises from about 1% to about 90% sugars by weight. In some embodiments, the sugar hydrolyzate comprises from about 1% to about 50% sugars by weight. In some embodiments, the sugar hydrolyzate comprises from about 1% to about 35% sugars by weight. In some embodiments, the sugar hydrolyzate comprises from about 5% to about 50% sugars by weight.

In some embodiments of the second, third, fourth or fifth aspects, the sugar hydrolyzate comprises the C5 sugars and the C6 sugars in a 5:95% ratio to a 95:5% ratio by weight. In some embodiments the sugar hydrolyzate comprises the C5 sugars and the C6 sugars in a 25:75% ratio to a 75:25% ratio by weight.

In some embodiments of the second, third, fourth or fifth aspects, pretreating or hydrolyzing the biomass comprises mechanical size reduction, hot water treatment, acid treatment, base treatment, steam explosion, acid-catalyzed steam explosion, ammonia fiber/freeze explosion, enzymatic hydrolysis, or a combination thereof.

In some embodiments of the second, third, fourth or fifth aspects, pretreating or hydrolyzing the biomass comprises mechanical size reduction, acid treatment and enzymatic hydrolysis.

In some embodiments of the second, third, fourth or fifth aspects, the sugar hydrolysate was produced by: (1) hydrating the biomass in an acidic medium; (2) mechanical size reduction of the biomass; (3) heating the biomass; and (4) enzymatically hydrolyzing the biomass.

In some embodiments of the second, third, fourth or fifth aspects, the sugar hydrolysate was produced by: (1) pretreating the biomass comprising lignocellulosic material with hot water or an acid to solubilize hemicellulose in the biomass, (2) substantially separating solubilized hemicellulose from remaining lignocellulosic solids, and (3) enzymatically hydrolyzing cellulose in the remaining lignocellulosic solids.

In some embodiments of the second, third, fourth or fifth aspects, the sugar hydrolysate was produced by: (a) pretreating a biomass comprising cellulosic, hemicellulosic, or lignocellulosic material to produce a pretreated biomass comprising solid particles, wherein at least 50% of the solid particles have a size of less than 1.5 mm, and optionally a yield of C5 monomers and/or dimers that is at least 50% of a theoretical maximum, wherein pretreating comprises: (i) hydration of the biomass in an aqueous medium to produce a hydrated biomass, (ii) mechanical size reduction of the hydrated biomass to produce the solid particles, and (iii) heating the hydrated biomass for a time sufficient to produce the pretreated biomass comprising the optional yield of C5 monosaccharides and/or disaccharides; and (b) hydrolyzing the pretreated biomass composition with one or more enzymes for a time sufficient to produce the sugar hydrolyzate. In some embodiments, the aqueous medium comprises and acid. In some embodiments, the acid is sulfuric acid, peroxyacetic acid, lactic acid, formic acid, acetic acid, citric acid, phosphoric acid, hydrochloric acid, sulfurous acid, chloroacetic acid, dichloroacetic acid, trichloroacetic acid, trifluoroacetic acid, oxalic acid, benzoic acid, or a combination thereof.

Also provided are C6 enriched retentates produced by any of the methods disclosed herein.

Also provided are C5 enriched filtrates produced by any of the methods disclosed herein.

In a sixth aspect, disclosed are systems for refining a sugar hydrolyzate, the systems comprising: (a) a lignocellulosic derived hydrolyzate comprising C5 sugars and C6 sugars produced by pretreating or hydrolyzing of a biomass comprising cellulosic, hemicellulosic, or lignocellulosic material; (b) a first nanofiltration membrane that produces a C6 enriched retentate and a C5 enriched filtrate when the sugar hydrolyzate is contacted with the first nanofiltration membrane; and (c) a water source that adds water to the sugar hydrolyzate when the sugar hydrolyzate is contacted with the first nanofiltration membrane.

The systems of the sixth aspect can further comprise an ultrafiltration membrane to remove color molecules and suspended solids from the sugar hydrolyzate. In some embodiments, the sugar hydrolyzate is contacted with the ultrafiltration membrane prior to the nanofiltration membrane.

The systems of the sixth aspect can further comprise a second nanofiltration membrane to remove one or more inhibitors from the sugar hydrolyzate. In some embodiments, the sugar hydrolyzate is contacted with the second nanofiltration membrane prior to the first nanofiltration membrane.

The systems of the sixth aspect can further comprise a reverse osmosis membrane to concentrate the sugars in the C6 enriched retentate or the C5 enriched filtrate.

In some embodiments of the sixth aspect, the C6 enriched retentate comprises a C6 sugar content that is at least about a 1.1 times higher than the sugar hydrolyzate, based on total sugar content. In some embodiments, the C6 enriched retentate comprises a C6 sugar content that is at least about a 1.5 times higher than the sugar hydrolyzate, based on total sugar content. In some embodiments, the C6 enriched retentate comprises a C6 sugar content that is at least about a 2 times higher than the sugar hydrolyzate, based on total sugar content.

In some embodiments of the sixth aspect, the C6 enriched retentate has a transparency that is at least about 2 fold higher than the sugar hydrolyzate when measured at 600 nm. In some embodiments, the C6 enriched retentate has a transparency that is at least about 5 fold higher than the sugar hydrolyzate when measured at 600 nm. In some embodiments, the C6 enriched retentate has a transparency that is at least about 10 fold higher than the sugar hydrolyzate when measured at 600 nm.

In some embodiments of the sixth aspect, the C6 enriched retentate has a transparency that is at least about 10% higher than the sugar hydrolyzate when measured at 600 nm. In some embodiments, the C6 enriched retentate has a transparency that is at least about 25% higher than the sugar hydrolyzate when measured at 600 nm. In some embodiments, the C6 enriched retentate has a transparency that is at least about 50% higher than the sugar hydrolyzate when measured at 600 nm.

In some embodiments of the sixth aspect, the C6 enriched retentate comprises an amount of one or more inhibitors that is, individually, at least about 10% lower than in the sugar hydrolyzate by weight. In some embodiments, the C6 enriched retentate comprises an amount of one or more inhibitors that is, individually, at least about 50% lower than in the sugar hydrolyzate by weight. In some embodiments, the C6 enriched retentate comprises an amount of one or more inhibitors that is, individually, at least about 75% lower than in the sugar hydrolyzate by weight. In some embodiments, the C6 enriched retentate comprises an amount of one or more inhibitors that is, individually, from 10% to about 100% lower than in the sugar hydrolyzate by weight. In some embodiments, the one or more inhibitors comprise furfural, hydroxymethylfurfural, acetic acid, formic acid, or a combination thereof.

In some embodiments of the sixth aspect, the first nanofiltration membrane is a NF99, NF99HF, NF-45, NF-90, NF-200, NF-400, SU-210, SU-220, SU-600, SU-610, NF9790, or NF 9940 membrane. In some embodiments, the first nanofiltration membrane is a NF9790 membrane. In some embodiments, the first nanofiltration membrane is a NF9940 membrane.

In some embodiments of the sixth aspect, the first nanofiltration membrane is a spiral wound nanofiltration membrane. In some embodiments, the first nanofiltration membrane is a tubular nanofiltration membrane. In some embodiments, the first nanofiltration membrane is a hollow fiber nanofiltration membrane.

In some embodiments of the sixth aspect, the first nanofiltration membrane has a pore size of about 1 nm to about 2 nm.

In some embodiments of the sixth aspect, the first nanofiltration membrane has a molecular weight cutoff of about 0.1 kDa to about 5 kDa.

In some embodiments of the sixth aspect, the first nanofiltration membrane has a MgSO₄ rejection of at least about 80%. In some embodiments, the first nanofiltration membrane has a MgSO₄ rejection of about 80% to about 99%. In some embodiments, wherein the first nanofiltration membrane has a MgSO₄ rejection of about 99%. In some embodiments, the first nanofiltration membrane has a MgSO₄ rejection of about 97%.

In some embodiments of the sixth aspect, the first nanofiltration membrane has a NaCl rejection of at least about 30%. In some embodiments, the first nanofiltration membrane has a NaCl rejection of about 30% to 99%. In some embodiments, the first nanofiltration membrane has a NaCl rejection of about 40%. In some embodiments, the first nanofiltration membrane has a NaCl rejection of about 90%.

In some embodiments of the sixth aspect, the second nanofiltration membrane is a NF99, NF99HF, NF-45, NF-90, NF-200, NF-400, SU-210, SU-220, SU-600, SU-610, NF9790, or NF 9940 membrane. In some embodiments, the second nanofiltration membrane is a NF9790 membrane. In some embodiments, the second nanofiltration membrane is a NF9940 membrane.

In some embodiments of the sixth aspect, the second nanofiltration membrane is a spiral wound nanofiltration membrane. In some embodiments, the second nanofiltration membrane is a tubular nanofiltration membrane. In some embodiments, the second nanofiltration membrane is a hollow fiber nanofiltration membrane.

In some embodiments of the sixth aspect, the second nanofiltration membrane has a pore size of about 1 nm to about 2 nm.

In some embodiments of the sixth aspect, the second nanofiltration membrane has a molecular weight cutoff of about 0.1 kDa to about 5 kDa.

In some embodiments of the sixth aspect, the second nanofiltration membrane has a MgSO₄ rejection of at least about 80%. In some embodiments, the second nanofiltration membrane has a MgSO₄ rejection of about 80% to about 99%. In some embodiments, the second nanofiltration membrane has a MgSO₄ rejection of about 99%. In some embodiments, the second nanofiltration membrane has a MgSO₄ rejection of about 97%.

In some embodiments of the sixth aspect, the second nanofiltration membrane has a NaCl rejection of at least about 30%. In some embodiments, the second nanofiltration membrane has a NaCl rejection of about 30% to 99%. In some embodiments, the second nanofiltration membrane has a NaCl rejection of about 40%. In some embodiments, the second nanofiltration membrane has a NaCl rejection of about 90%.

In some embodiments of the sixth aspect, the ultrafiltration membrane is an ES404 membrane.

In some embodiments of the sixth, the ultrafiltration membrane has a pore size of about 2 nm to about 100 nm.

In some embodiments of the sixth aspect, the ultrafiltration membrane has a molecular weight cutoff of from about 5 kDa to about 5000 kDa. In some embodiments, the ultrafiltration membrane has a molecular weight cutoff of about 4000 kDa.

In some embodiments of the sixth aspect, the first nanofiltration membrane is in a cross-flow configuration. In some embodiments, the first nanofiltration membrane is in a dead-end configuration.

In some embodiments of the sixth aspect, the ultrafiltration membrane is in a cross-flow configuration. In some embodiments, the ultrafiltration membrane is in a dead-end configuration.

In some embodiments of the sixth aspect, the second nanofiltration membrane is in a cross-flow configuration. In some embodiments, the second nanofiltration membrane is in a dead-end configuration.

In some embodiments of the sixth aspect, the sugar hydrolyzate is contacted with the first nanofiltration membrane or the second nanofiltration membrane at a pressure of about 10 psi to about 1000 psi.

In some embodiments of the sixth aspect, the sugar hydrolyzate is contacted with the first nanofiltration membrane or the second nanofiltration membrane at a pressure of about 100 psi to about 900 psi. In some embodiments, the sugar hydrolyzate is contacted with the first nanofiltration membrane or the second nanofiltration membrane at a pressure of about 250 psi to about 750 psi. In some embodiments, the sugar hydrolyzate is contacted with the first nanofiltration membrane or the second nanofiltration membrane at a pressure of about 500 psi to about 600 psi.

In some embodiments of the sixth aspect, the sugar hydrolyzate is at a temperature of about 20° C. to about 80° C.

In some embodiments of the sixth aspect, the sugar hydrolyzate is at a pH of from about 1 to about 14. In some embodiments, the sugar hydrolyzate is at a pH of from about 3 to about 11. In some embodiments, the sugar hydrolyzate is at a pH of from about 4 to about 9.

In some embodiments of the sixth aspect, the water is added in an amount of from about 0.1 to about 10 diafiltration volumes. In some embodiments, the water is added in an amount of from about 0.25 to about 6 diafiltration volumes. In some embodiments, the water is added in an amount of from about 0.1 to about 1 diafiltration volumes. In some embodiments, the water is added in an amount of from about 0.1 to about 0.5 diafiltration volumes.

In some embodiments of the sixth aspect, the water is added continuously.

In some embodiments of the sixth aspect, the water is added one or more times during contacting. In some embodiments, the water is added when a retentate volume reaches from 10% to about 75% of a starting volume of the sugar hydrolyzate. In some embodiments, the water is added when a retentate volume reaches from 15% to about 50% of a starting volume of the sugar hydrolyzate. In some embodiments, the water is added when a retentate volume reaches about 25% of a starting volume of the sugar hydrolyzate.

In some embodiments of the sixth aspect, the C6 sugars comprise glucose. In some embodiments, the C5 sugars comprise xylose, arabinose, or a combination thereof.

In some embodiments of the sixth aspect, the sugar hydrolyzate comprises from about 1% to about 90% sugars by weight. In some embodiments, the sugar hydrolyzate comprises from about 1% to about 50% sugars by weight. In some embodiments, the sugar hydrolyzate comprises from about 1% to about 35% sugars by weight. In some embodiments, the sugar hydrolyzate comprises from about 5% to about 50% sugars by weight.

In some embodiments of the sixth aspect, the sugar hydrolyzate comprises the C5 sugars and the C6 sugars in a 5:95% ratio to a 95:5% ratio by weight. In some embodiments, the sugar hydrolyzate comprises the C5 sugars and the C6 sugars in a 25:75% ratio to a 75:25% ratio by weight.

In some embodiments of the sixth aspect, pretreating or hydrolyzing the biomass comprises mechanical size reduction, hot water treatment, acid treatment, base treatment, steam explosion, acid-catalyzed steam explosion, ammonia fiber/freeze explosion, enzymatic hydrolysis, or a combination thereof.

In some embodiments of the sixth aspect, pretreating or hydrolyzing the biomass comprises mechanical size reduction, acid treatment and enzymatic hydrolysis.

In some embodiments of the sixth aspect, the sugar hydrolysate was produced by: (1) hydrating the biomass in an acidic medium; (2) mechanical size reduction of the biomass; (3) heating the biomass; and (4) enzymatically hydrolyzing the biomass.

In some embodiments of the sixth aspect, the sugar hydrolysate was produced by: (1) pretreating the biomass comprising lignocellulosic material with hot water or an acid to solubilize hemicellulose in the biomass, (2) substantially separating solubilized hemicellulose from remaining lignocellulosic solids, and (3) enzymatically hydrolyzing cellulose in the remaining lignocellulosic solids.

In some embodiments of the sixth aspect, the sugar hydrolysate was produced by: (a) pretreating a biomass comprising cellulosic, hemicellulosic, or lignocellulosic material to produce a pretreated biomass comprising solid particles, wherein at least 50% of the solid particles have a size of less than 1.5 mm, and optionally a yield of C5 monomers and/or dimers that is at least 50% of a theoretical maximum, wherein pretreating comprises: (i) hydration of the biomass in an aqueous medium to produce a hydrated biomass, (ii) mechanical size reduction of the hydrated biomass to produce the solid particles, and (iii) heating the hydrated biomass for a time sufficient to produce the pretreated biomass comprising the optional yield of C5 monosaccharides and/or disaccharides; and (b) hydrolyzing the pretreated biomass composition with one or more enzymes for a time sufficient to produce the sugar hydrolyzate. In some embodiments, the aqueous medium comprises and acid. In some embodiments, the acid is sulfuric acid, peroxyacetic acid, lactic acid, formic acid, acetic acid, citric acid, phosphoric acid, hydrochloric acid, sulfurous acid, chloroacetic acid, dichloroacetic acid, trichloroacetic acid, trifluoroacetic acid, oxalic acid, benzoic acid, or a combination thereof.

In some embodiments of the first, second, third, fourth, fifth or sixth aspects, the color molecules comprise complex mixtures of compounds comprising aromatic and furan rings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a membrane-based separation module.

FIG. 2 shows color tracking of permeate from ES404 membrane.

FIGS. 3A and 3B show color removal in the permeate solutions generated by NF9940 (FIG. 3A) and NF9790 membranes (FIG. 3B).

FIG. 4 illustrates diafiltration membrane module used with the NF9940 membrane.

FIG. 5 shows sugar concentrations during the NF9940 nanofiltration test without the use of diafiltration.

FIG. 6 shows inhibitor levels during the NF9940 membrane test without diafiltration.

### DETAILED DESCRIPTION OF THE INVENTION

As used in the specification and the appended claims, the singular forms “a,” “an” and “the” include plural referents unless the context clearly dictates otherwise. Thus, for example, reference to “a purified monomer” includes mixtures of two or more purified monomers. The term “comprising” as used herein is synonymous with “including,” “containing,” or “characterized by,” and is inclusive or open-ended and does not exclude additional, unrecited elements or method steps.

“About” means a referenced numeric indication plus or minus 10% of that referenced numeric indication. For example, the term about 4 would include a range of 3.6 to 4.4. All numbers expressing quantities of ingredients, reaction conditions, and so forth used in the specification are to be understood as being modified in all instances by the term “about.” Accordingly, unless indicated to the contrary, the numerical parameters set forth herein are approximations that can vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Wherever the phrase “for example,” “such as,” “including” and the like are used herein, the phrase “and without limitation” is understood to follow unless explicitly stated otherwise. Therefore, “for example ethanol production” means “for example and without limitation ethanol production.”

The term “or” can be used conjunctively or disjunctively.

### DEFINITIONS

Unless characterized otherwise, technical and scientific terms used herein have the same meaning as commonly understood by one of ordinary skill in the art. In the event that a term defined herein conflicts with a term incorporated by reference, this specification is controlling.

“Optional” or “optionally” means that the subsequently described event or circumstance may or may not occur, and that the description includes instances where said event or circumstance occurs and instances where it does not. For example, the phrase “the medium can optionally contain glucose” means that the medium may or may not contain glucose as an ingredient and that the description includes both media containing glucose and media not containing glucose.

“Fermentive end-product” and “fermentation end-product” are used interchangeably herein to include biofuels, chemicals, compounds suitable as liquid fuels, gaseous fuels, triacylglycerols, reagents, chemical feedstocks, chemical additives, processing aids, food additives, bioplastics and precursors to bioplastics, and other products. Examples of fermentive end-products include but are not limited to 1,4 diacids (succinic, fumaric and malic), 2,5 furan dicarboxylic acid, 3 hydroxy propionic acid, aspartic acid, glucaric acid, glutamic acid, itaconic acid, levulinic acid, 3-hydroxybutyrolactone, glycerol, sorbitol, xylitol/arabinitol, butanediol, butanol, methane, methanol, ethane, ethene, ethanol, n-propane, 1-propene, 1-propanol, propanal, acetone, propionate, n-butane, 1-butene, 1-butanol, butanal, butanoate, isobutanal, isobutanol, 2-methylbutanal, 2-methylbutanol, 3-methylbutanal, 3-methylbutanol, 2-butene, 2-butanol, 2-butanone, 2,3-butanediol, 3-hydroxy-2-butanone, 2,3-butanedione, ethylbenzene, ethenylbenzene, 2-phenylethanol, phenylacetaldehyde, 1-phenylbutane, 4-phenyl-1-butene, 4-phenyl-2-butene, 1-phenyl-2-butene, 1-phenyl-2-butanol, 4-phenyl-2-butanol, 1-phenyl-2-butanone, 4-phenyl-2-butanone, 1-phenyl-2,3-butandiol, 1-phenyl-3-hydroxy-2-butanone, 4-phenyl-3-hydroxy-2-butanone, 1-phenyl-2,3-butanedione, n-pentane, ethylphenol, ethenylphenol, 2-(4-hydroxyphenyl)ethanol, 4-hydroxyphenylacetaldehyde, 1-(4-hydroxyphenyl) butane, 4-(4-hydroxyphenyl)-1-butene, 4-(4-hydroxyphenyl)-2-butene, 1-(4-hydroxyphenyl)-1-butene, 1-(4-hydroxyphenyl)-2-butanol, 4-(4-hydroxyphenyl)-2-butanol, 1-(4-hydroxyphenyl)-2-butanone, 4-(4-hydroxyphenyl)-2-butanone, 1-(4-hydroxyphenyl)-2,3-butandiol, 1-(4-hydroxyphenyl)-3-hydroxy-2-butanone, 4-(4-hydroxyphenyl)-3-hydroxy-2-butanone, 1-(4-hydroxyphenyl)-2,3-butanonedione, indolylethane, indolylethene, 2-(indole-3-)ethanol, n-pentane, 1-pentene, 1-pentanol, pentanal, pentanoate, 2-pentene, 2-pentanol, 3-pentanol, 2-pentanone, 3-pentanone, 4-methylpentanal, 4-methylpentanol, 2,3-pentanediol, 2-hydroxy-3-pentanone, 3-hydroxy-2-pentanone, 2,3-pentanedione, 2-methylpentane, 4-methyl-1-pentene, 4-methyl-2-pentene, 4-methyl-3-pentene, 4-methyl-2-pentanol, 2-methyl-3-pentanol, 4-methyl-2-pentanone, 2-methyl-3-pentanone, 4-methyl-2,3-pentanediol, 4-methyl-2-hydroxy-3-pentanone, 4-methyl-3-hydroxy-2-pentanone, 4-methyl-2,3-pentanedione, 1-phenylpentane, 1-phenyl-1-pentene, 1-phenyl-2-pentene, 1-phenyl-3-pentene, 1-phenyl-2-pentanol, 1-phenyl-3-pentanol, 1-phenyl-2-pentanone, 1-phenyl-3-pentanone, 1-phenyl-2,3-pentanediol, 1-phenyl-2-hydroxy-3-pentanone, 1-phenyl-3-hydroxy-2-pentanone, 1-phenyl-2,3-pentanedione, 4-methyl-1-phenylpentane, 4-methyl-1-phenyl-1-pentene, 4-methyl-1-phenyl-2-pentene, 4-methyl-1-phenyl-3-pentene, 4-methyl-1-phenyl-3-pentanol, 4-methyl-1-phenyl-2-pentanol, 4-methyl-1-phenyl-3-pentanone, 4-methyl-1-phenyl-2-pentanone, 4-methyl-1-phenyl-2,3-pentanediol, 4-methyl-1-phenyl-2,3-pentanedione, 4-methyl-1-phenyl-3-hydroxy-2-pentanone, 4-methyl-1-phenyl-2-hydroxy-3-pentanone, 1-(4-hydroxyphenyl)pentane, 1-(4-hydroxyphenyl)-1-pentene, 1-(4-hydroxyphenyl)-2-pentene, 1-(4-hydroxyphenyl)-3-pentene, 1-(4-hydroxyphenyl)-2-pentanol, 1-(4-hydroxyphenyl)-3-pentanol, 1-(4-hydroxyphenyl)-2-pentanone, 1-(4-hydroxyphenyl)-3-pentanone, 1-(4-hydroxyphenyl)-2,3-pentanediol, 1-(4-hydroxyphenyl)-2-hydroxy-3-pentanone, 1-(4-hydroxyphenyl)-3-hydroxy-2-pentanone, 1-(4-hydroxyphenyl)-2,3-pentanedione, 4-methyl-1-(4-hydroxyphenyl)pentane, 4-methyl-1-(4-hydroxyphenyl)-2-pentene, 4-methyl-1-(4-hydroxyphenyl)-3-pentene, 4-methyl-1-(4-hydroxyphenyl)-1-pentene, 4-methyl-1-(4-hydroxyphenyl)-3-pentanol, 4-methyl-1-(4-hydroxyphenyl)-2-pentanol, 4-methyl-1-(4-hydroxyphenyl)-3-pentanone, 4-methyl-1-(4-hydroxyphenyl)-2-pentanone, 4-methyl-1-(4-hydroxyphenyl)-2,3-pentanediol, 4-methyl-1-(4-hydroxyphenyl)-2,3-pentanedione, 4-methyl-1-(4-hydroxyphenyl)-3-hydroxy-2-pentanone, 4-methyl-1-(4-hydroxyphenyl)-2-hydroxy-3-pentanone, 1-indole-3-pentane, 1-(indole-3)-1-pentene, 1-(indole-3)-2-pentene, 1-(indole-3)-3-pentene, 1-(indole-3)-2-pentanol, 1-(indole-3)-3-pentanol, 1-(indole-3)-2-pentanone, 1-(indole-3)-3-pentanone, 1-(indole-3)-2,3-pentanediol, 1-(indole-3)-2-hydroxy-3-pentanone, 1-(indole-3)-3-hydroxy-2-pentanone, 1-(indole-3)-2,3-pentanedione, 4-methyl-1-(indole-3-)pentane, 4-methyl-1-(indole-3)-2-pentene, 4-methyl-1-(indole-3)-3-pentene, 4-methyl-1-(indole-3)-1-pentene, 4-methyl-2-(indole-3)-3-pentanol, 4-methyl-1-(indole-3)-2-pentanol, 4-methyl-1-(indole-3)-3-pentanone, 4-methyl-1-(indole-3)-2-pentanone, 4-methyl-1-(indole-3)-2,3-pentanediol, 4-methyl-1-(indole-3)-2,3-pentanedione, 4-methyl-1-(indole-3)-3-hydroxy-2-pentanone, 4-methyl-1-(indole-3)-2-hydroxy-3-pentanone, n-hexane, 1-hexene, 1-hexanol, hexanal, hexanoate, 2-hexene, 3-hexene, 2-hexanol, 3-hexanol, 2-hexanone, 3-hexanone, 2,3-hexanediol, 2,3-hexanedione, 3,4-hexanediol, 3,4-hexanedione, 2-hydroxy-3-hexanone, 3-hydroxy-2-hexanone, 3-hydroxy-4-hexanone, 4-hydroxy-3-hexanone, 2-methylhexane, 3-methylhexane, 2-methyl-2-hexene, 2-methyl-3-hexene, 5-methyl-1-hexene, 5-methyl-2-hexene, 4-methyl-1-hexene, 4-methyl-2-hexene, 3-methyl-3-hexene, 3-methyl-2-hexene, 3-methyl-1-hexene, 2-methyl-3-hexanol, 5-methyl-2-hexanol, 5-methyl-3-hexanol, 2-methyl-3-hexanone, 5-methyl-2-hexanone, 5-methyl-3-hexanone, 2-methyl-3,4-hexanediol, 2-methyl-3,4-hexanedione, 5-methyl-2,3-hexanediol, 5-methyl-2,3-hexanedione, 4-methyl-2,3-hexanediol, 4-methyl-2,3-hexanedione, 2-methyl-3-hydroxy-4-hexanone, 2-methyl-4-hydroxy-3-hexanone, 5-methyl-2-hydroxy-3-hexanone, 5-methyl-3-hydroxy-2-hexanone, 4-methyl-2-hydroxy-3-hexanone, 4-methyl-3-hydroxy-2-hexanone, 2,5-dimethylhexane, 2,5-dimethyl-2-hexene, 2,5-dimethyl-3-hexene, 2,5-dimethyl-3-hexanol, 2,5-dimethyl-3-hexanone, 2,5-dimethyl-3,4-hexanediol, 2,5-dimethyl-3,4-hexanedione, 2,5-dimethyl-3-hydroxy-4-hexanone, 5-methyl-1-phenylhexane, 4-methyl-1-phenylhexane, 5-methyl-1-phenyl-1-hexene, 5-methyl-1-phenyl-2-hexene, 5-methyl-1-phenyl-3-hexene, 4-methyl-1-phenyl-1-hexene, 4-methyl-1-phenyl-2-hexene, 4-methyl-1-phenyl-3-hexene, 5-methyl-1-phenyl-2-hexanol, 5-methyl-1-phenyl-3-hexanol, 4-methyl-1-phenyl-2-hexanol, 4-methyl-1-phenyl-3-hexanol, 5-methyl-1-phenyl-2-hexanone, 5-methyl-1-phenyl-3-hexanone, 4-methyl-1-phenyl-2-hexanone, 4-methyl-1-phenyl-3-hexanone, 5-methyl-1-phenyl-2,3-hexanediol, 4-methyl-1-phenyl-2,3-hexanediol, 5-methyl-1-phenyl-3-hydroxy-2-hexanone, 5-methyl-1-phenyl-2-hydroxy-3-hexanone, 4-methyl-1-phenyl-3-hydroxy-2-hexanone, 4-methyl-1-phenyl-2-hydroxy-3-hexanone, 5-methyl-1-phenyl-2,3-hexanedione, 4-methyl-1-phenyl-2,3-hexanedione, 4-methyl-1-(4-hydroxyphenyl)hexane, 5-methyl-1-(4-hydroxyphenyl)-1-hexene, 5-methyl-1-(4-hydroxyphenyl)-2-hexene, 5-methyl-1-(4-hydroxyphenyl)-3-hexene, 4-methyl-1-(4-hydroxyphenyl)-1-hexene, 4-methyl-1-(4-hydroxyphenyl)-2-hexene, 4-methyl-1-(4-hydroxyphenyl)-3-hexene, 5-methyl-1-(4-hydroxyphenyl)-2-hexanol, 5-methyl-1-(4-hydroxyphenyl)-3-hexanol, 4-methyl-1-(4-hydroxyphenyl)-2-hexanol, 4-methyl-1-(4-hydroxyphenyl)-3-hexanol, 5-methyl-1-(4-hydroxyphenyl)-2-hexanone, 5-methyl-1-(4-hydroxyphenyl)-3-hexanone, 4-methyl-1-(4-hydroxyphenyl)-2-hexanone, 4-methyl-1-(4-hydroxyphenyl)-3-hexanone, 5-methyl-1-(4-hydroxyphenyl)-2,3-hexanediol, 4-methyl-1-(4-hydroxyphenyl)-2,3-hexanediol, 5-methyl-1-(4-hydroxyphenyl)-3-hydroxy-2-hexanone, 5-methyl-1-(4-hydroxyphenyl)-2-hydroxy-3-hexanone, 4-methyl-1-(4-hydroxyphenyl)-3-hydroxy-2-hexanone, 4-methyl-1-(4-hydroxyphenyl)-2-hydroxy-3-hexanone, 5-methyl-1-(4-hydroxyphenyl)-2,3-hexanedione, 4-methyl-1-(4-hydroxyphenyl)-2,3-hexanedione, 4-methyl-1-(indole-3-)hexane, 5-methyl-1-(indole-3)-1-hexene, 5-methyl-1-(indole-3)-2-hexene, 5-methyl-1-(indole-3)-3-hexene, 4-methyl-1-(indole-3)-1-hexene, 4-methyl-1-(indole-3)-2-hexene, 4-methyl-1-(indole-3)-3-hexene, 5-methyl-1-(indole-3)-2-hexanol, 5-methyl-1-(indole-3)-3-hexanol, 4-methyl-1-(indole-3)-2-hexanol, 4-methyl-1-(indole-3)-3-hexanol, 5-methyl-1-(indole-3)-2-hexanone, 5-methyl-1-(indole-3)-3-hexanone, 4-methyl-1-(indole-3)-2-hexanone, 4-methyl-1-(indole-3)-3-hexanone, 5-methyl-1-(indole-3)-2,3-hexanediol, 4-methyl-1-(indole-3)-2,3-hexanediol, 5-methyl-1-(indole-3)-3-hydroxy-2-hexanone, 5-methyl-1-(indole-3)-2-hydroxy-3-hexanone, 4-methyl-1-(indole-3)-3-hydroxy-2-hexanone, 4-methyl-1-(indole-3)-2-hydroxy-3-hexanone, 5-methyl-1-(indole-3)-2,3-hexanedione, 4-methyl-1-(indole-3)-2,3-hexanedione, n-heptane, 1-heptene, 1-heptanol, heptanal, heptanoate, 2-heptene, 3-heptene, 2-heptanol, 3-heptanol, 4-heptanol, 2-heptanone, 3-heptanone, 4-heptanone, 2,3-heptanediol, 2,3-heptanedione, 3,4-heptanediol, 3,4-heptanedione, 2-hydroxy-3-heptanone, 3-hydroxy-2-heptanone, 3-hydroxy-4-heptanone, 4-hydroxy-3-heptanone, 2-methylheptane, 3-methylheptane, 6-methyl-2-heptene, 6-methyl-3-heptene, 2-methyl-3-heptene, 2-methyl-2-heptene, 5-methyl-2-heptene, 5-methyl-3-heptene, 3-methyl-3-heptene, 2-methyl-3-heptanol, 2-methyl-4-heptanol, 6-methyl-3-heptanol, 5-methyl-3-heptanol, 3-methyl-4-heptanol, 2-methyl-3-heptanone, 2-methyl-4-heptanone, 6-methyl-3-heptanone, 5-methyl-3-heptanone, 3-methyl-4-heptanone, 2-methyl-3,4-heptanediol, 2-methyl-3,4-heptanedione, 6-methyl-3,4-heptanediol, 6-methyl-3,4-heptanedione, 5-methyl-3,4-heptanediol, 5-methyl-3,4-heptanedione, 2-methyl-3-hydroxy-4-heptanone, 2-methyl-4-hydroxy-3-heptanone, 6-methyl-3-hydroxy-4-heptanone, 6-methyl-4-hydroxy-3-heptanone, 5-methyl-3-hydroxy-4-heptanone, 5-methyl-4-hydroxy-3-heptanone, 2,6-dimethylheptane, 2,5-dimethylheptane, 2,6-dimethyl-2-heptene, 2,6-dimethyl-3-heptene, 2,5-dimethyl-2-heptene, 2,5-dimethyl-3-heptene, 3,6-dimethyl-3-heptene, 2,6-dimethyl-3-heptanol, 2,6-dimethyl-4-heptanol, 2,5-dimethyl-3-heptanol, 2,5-dimethyl-4-heptanol, 2,6-dimethyl-3,4-heptanediol, 2,6-dimethyl-3,4-heptanedione, 2,5-dimethyl-3,4-heptanediol, 2,5-dimethyl-3,4-heptanedione, 2,6-dimethyl-3-hydroxy-4-heptanone, 2,6-dimethyl-4-hydroxy-3-heptanone, 2,5-dimethyl-3-hydroxy-4-heptanone, 2,5-dimethyl-4-hydroxy-3-heptanone, n-octane, 1-octene, 2-octene, 1-octanol, octanal, octanoate, 3-octene, 4-octene, 4-octanol, 4-octanone, 4,5-octanediol, 4,5-octanedione, 4-hydroxy-5-octanone, 2-methyloctane, 2-methyl-3-octene, 2-methyl-4-octene, 7-methyl-3-octene, 3-methyl-3-octene, 3-methyl-4-octene, 6-methyl-3-octene, 2-methyl-4-octanol, 7-methyl-4-octanol, 3-methyl-4-octanol, 6-methyl-4-octanol, 2-methyl-4-octanone, 7-methyl-4-octanone, 3-methyl-4-octanone, 6-methyl-4-octanone, 2-methyl-4,5-octanediol, 2-methyl-4,5-octanedione, 3-methyl-4,5-octanediol, 3-methyl-4,5-octanedione, 2-methyl-4-hydroxy-5-octanone, 2-methyl-5-hydroxy-4-octanone, 3-methyl-4-hydroxy-5-octanone, 3-methyl-5-hydroxy-4-octanone, 2,7-dimethyloctane, 2,7-dimethyl-3-octene, 2,7-dimethyl-4-octene, 2,7-dimethyl-4-octanol, 2,7-dimethyl-4-octanone, 2,7-dimethyl-4,5-octanediol, 2,7-dimethyl-4,5-octanedione, 2,7-dimethyl-4-hydroxy-5-octanone, 2,6-dimethyloctane, 2,6-dimethyl-3-octene, 2,6-dimethyl-4-octene, 3,7-dimethyl-3-octene, 2,6-dimethyl-4-octanol, 3,7-dimethyl-4-octanol, 2,6-dimethyl-4-octanone, 3,7-dimethyl-4-octanone, 2,6-dimethyl-4,5-octanediol, 2,6-dimethyl-4,5-octanedione, 2,6-dimethyl-4-hydroxy-5-octanone, 2,6-dimethyl-5-hydroxy-4-octanone, 3,6-dimethyloctane, 3,6-dimethyl-3-octene, 3,6-dimethyl-4-octene, 3,6-dimethyl-4-octanol, 3,6-dimethyl-4-octanone, 3,6-dimethyl-4,5-octanediol, 3,6-dimethyl-4,5-octanedione, 3,6-dimethyl-4-hydroxy-5-octanone, n-nonane, 1-nonene, 1-nonanol, nonanal, nonanoate, 2-methylnonane, 2-methyl-4-nonene, 2-methyl-5-nonene, 8-methyl-4-nonene, 2-methyl-5-nonanol, 8-methyl-4-nonanol, 2-methyl-5-nonanone, 8-methyl-4-nonanone, 8-methyl-4,5-nonanediol, 8-methyl-4,5-nonanedione, 8-methyl-4-hydroxy-5-nonanone, 8-methyl-5-hydroxy-4-nonanone, 2,8-dimethylnonane, 2,8-dimethyl-3-nonene, 2,8-dimethyl-4-nonene, 2,8-dimethyl-5-nonene, 2,8-dimethyl-4-nonanol, 2,8-dimethyl-5-nonanol, 2,8-dimethyl-4-nonanone, 2,8-dimethyl-5-nonanone, 2,8-dimethyl-4,5-nonanediol, 2,8-dimethyl-4,5-nonanedione, 2,8-dimethyl-4-hydroxy-5-nonanone, 2,8-dimethyl-5-hydroxy-4-nonanone, 2,7-dimethylnonane, 3,8-dimethyl-3-nonene, 3,8-dimethyl-4-nonene, 3,8-dimethyl-5-nonene, 3,8-dimethyl-4-nonanol, 3,8-dimethyl-5-nonanol, 3,8-dimethyl-4-nonanone, 3,8-dimethyl-5-nonanone, 3,8-dimethyl-4,5-nonanediol, 3,8-dimethyl-4,5-nonanedione, 3,8-dimethyl-4-hydroxy-5-nonanone, 3,8-dimethyl-5-hydroxy-4-nonanone, n-decane, 1-decene, 1-decanol, decanoate, 2,9-dimethyldecane, 2,9-dimethyl-3-decene, 2,9-dimethyl-4-decene, 2,9-dimethyl-5-decanol, 2,9-dimethyl-5-decanone, 2,9-dimethyl-5,6-decanediol, 2,9-dimethyl-6-hydroxy-5-decanone, 2,9-dimethyl-5,6-decanedionen-undecane, 1-undecene, 1-undecanol, undecanal. undecanoate, n-dodecane, 1-dodecene, 1-dodecanol, dodecanal, dodecanoate, n-dodecane, 1-decadecene, n-tridecane, 1-tridecene, 1-tridecanol, tridecanal, tridecanoate, n-tetradecane, 1-tetradecene, 1-tetradecanol, tetradecanal, tetradecanoate, n-pentadecane, 1-pentadecene, 1-pentadecanol, pentadecanal, pentadecanoate, n-hexadecane, 1-hexadecene, 1-hexadecanol, hexadecanal, hexadecanoate, n-heptadecane, 1-heptadecene, 1-heptadecanol, heptadecanal, heptadecanoate, n-octadecane, 1-octadecene, 1-octadecanol, octadecanal, octadecanoate, n-nonadecane, 1-nonadecene, 1-nonadecanol, nonadecanal, nonadecanoate, eicosane, 1-eicosene, 1-eicosanol, eicosanal, eicosanoate, 3-hydroxy propanal, 1,3-propanediol, 4-hydroxybutanal, 1,4-butanediol, 3-hydroxy-2-butanone, 2,3-butandiol, 1,5-pentane diol, homocitrate, homoisocitorate, b-hydroxy adipate, glutarate, glutarsemialdehyde, glutaraldehyde, 2-hydroxy-1-cyclopentanone, 1,2-cyclopentanediol, cyclopentanone, cyclopentanol, (S)-2-acetolactate, (R)-2,3-Dihydroxy-isovalerate, 2-oxoisovalerate, isobutyryl-CoA, isobutyrate, isobutyraldehyde, 5-amino pentaldehyde, 1,10-diaminodecane, 1,10-diamino-5-decene, 1,10-diamino-5-hydroxydecane, 1,10-diamino-5-decanone, 1,10-diamino-5,6-decanediol, 1,10-diamino-6-hydroxy-5-decanone, phenylacetoaldehyde, 1,4-diphenylbutane, 1,4-diphenyl-1-butene, 1,4-diphenyl-2-butene, 1,4-diphenyl-2-butanol, 1,4-diphenyl-2-butanone, 1,4-diphenyl-2,3-butanediol, 1,4-diphenyl-3-hydroxy-2-butanone, 1-(4-hydeoxyphenyl)-4-phenylbutane, 1-(4-hydeoxyphenyl)-4-phenyl-1-butene, 1-(4-hydeoxyphenyl)-4-phenyl-2-butene, 1-(4-hydeoxyphenyl)-4-phenyl-2-butanol, 1-(4-hydeoxyphenyl)-4-phenyl-2-butanone, 1-(4-hydeoxyphenyl)-4-phenyl-2,3-butanediol, 1-(4-hydeoxyphenyl)-4-phenyl-3-hydroxy-2-butanone, 1-(indole-3)-4-phenylbutane, 1-(indole-3)-4-phenyl-1-butene, 1-(indole-3)-4-phenyl-2-butene, 1-(indole-3)-4-phenyl-2-butanol, 1-(indole-3)-4-phenyl-2-butanone, 1-(indole-3)-4-phenyl-2,3-butanediol, 1-(indole-3)-4-phenyl-3-hydroxy-2-butanone, 4-hydroxyphenylacetoaldehyde, 1,4-di(4-hydroxyphenyl)butane, 1,4-di(4-hydroxyphenyl)-1-butene, 1,4-di(4-hydroxyphenyl)-2-butene, 1,4-di(4-hydroxyphenyl)-2-butanol, 1,4-di(4-hydroxyphenyl)-2-butanone, 1,4-di(4-hydroxyphenyl)-2,3-butanediol, 1,4-di(4-hydroxyphenyl)-3-hydroxy-2-butanone, 1-(4-hydroxyphenyl)-4-(indole-3-) butane, 1-(4-hydroxyphenyl)-4-(indole-3)-1-butene, 1-di(4-hydroxyphenyl)-4-(indole-3)-2-butene, 1-(4-hydroxyphenyl)-4-(indole-3)-2-butanol, 1-(4-hydroxyphenyl)-4-(indole-3)-2-butanone, 1-(4-hydroxyphenyl)-4-(indole-3)-2,3-butanediol, 1-(4-hydroxyphenyl-4-(indole-3)-3-hydroxy-2-butanone, indole-3-acetoaldehyde, 1,4-di(indole-3-)butane, 1,4-di(indole-3)-1-butene, 1,4-di(indole-3)-2-butene, 1,4-di(indole-3)-2-butanol, 1,4-di(indole-3)-2-butanone, 1,4-di(indole-3)-2,3-butanediol, 1,4-di(indole-3)-3-hydroxy-2-butanone, succinate semialdehyde, hexane-1,8-dicarboxylic acid, 3-hexene-1,8-dicarboxylic acid, 3-hydroxy-hexane-1,8-dicarboxylic acid, 3-hexanone-1,8-dicarboxylic acid, 3,4-hexanediol-1,8-dicarboxylic acid, 4-hydroxy-3-hexanone-1,8-dicarboxylic acid, glycerol, fucoidan, iodine, chlorophyll, carotenoid, calcium, magnesium, iron, sodium, potassium, phosphate, lactic acid, acetic acid, formic acid, isoprenoids, and polyisoprenes, including rubber. Further, such products can include succinic acid, pyruvic acid, enzymes such as cellulases, polysaccharases, lipases, proteases, ligninases, and hemicellulases and may be present as a pure compound, a mixture, or an impure or diluted form.

Fermentation end-products can include polyols or sugar alcohols; for example, methanol, glycol, glycerol, erythritol, threitol, arabitol, xylitol, ribitol, mannitol, sorbitol, dulcitol, fucitol, iditol, inositol, volemitol, isomalt, maltitol, lactitol, and/or polyglycitol.

The term “pH modifier” as used herein has its ordinary meaning as known to those skilled in the art and can include any material that will tend to increase, decrease or hold steady the pH of the broth or medium. A pH modifier can be an acid, a base, a buffer, or a material that reacts with other materials present to serve to raise, lower, or hold steady the pH. In one embodiment, more than one pH modifier can be used, such as more than one acid, more than one base, one or more acid with one or more bases, one or more acids with one or more buffers, one or more bases with one or more buffers, or one or more acids with one or more bases with one or more buffers. In one embodiment, a buffer can be produced in the broth or medium or separately and used as an ingredient by at least partially reacting in acid or base with a base or an acid, respectively. When more than one pH modifiers are utilized, they can be added at the same time or at different times. In one embodiment, one or more acids and one or more bases are combined, resulting in a buffer. In one embodiment, media components, such as a carbon source or a nitrogen source serve as a pH modifier; suitable media components include those with high or low pH or those with buffering capacity. Exemplary media components include acid- or base-hydrolyzed plant polysaccharides having residual acid or base, ammonia fiber explosion (AFEX) treated plant material with residual ammonia, lactic acid, corn steep solids or liquor.

“Growth phase” is used herein to describe the type of cellular growth that occurs after the “Initiation phase” and before the “Stationary phase” and the “Death phase.” The growth phase is sometimes referred to as the exponential phase or log phase or logarithmic phase.

The term “plant polysaccharide” as used herein has its ordinary meaning as known to those skilled in the art and can comprise one or more polymers of sugars and sugar derivatives as well as derivatives of sugar polymers and/or other polymeric materials that occur in plant matter. Exemplary plant polysaccharides include lignin, cellulose, starch, pectin, and hemicellulose. Others are chitin, sulfonated polysaccharides such as alginic acid, agarose, carrageenan, porphyran, furcelleran and funoran. Generally, the polysaccharide can have two or more sugar units or derivatives of sugar units. The sugar units and/or derivatives of sugar units can repeat in a regular pattern, or otherwise. The sugar units can be hexose units or pentose units, or combinations of these. The derivatives of sugar units can be sugar alcohols, sugar acids, amino sugars, etc. The polysaccharides can be linear, branched, cross-linked, or a mixture thereof. One type or class of polysaccharide can be cross-linked to another type or class of polysaccharide.

The term “saccharification” as used herein has its ordinary meaning as known to those skilled in the art and can include conversion of plant polysaccharides to lower molecular weight species that can be utilized by the organism at hand. For some organisms, this would include conversion to monosaccharides, disaccharides, trisaccharides, and oligosaccharides of up to about seven monomer units, as well as similar sized chains of sugar derivatives and combinations of sugars and sugar derivatives.

The term “biomass” as used herein has its ordinary meaning as known to those skilled in the art and can include one or more biological materials that can be converted into a biofuel, chemical or other product. Biomass as used herein is synonymous with the term “feedstock” and includes corn syrup, molasses, silage, agricultural residues (corn stalks, grass, straw, grain hulls, bagasse, etc.), animal waste (manure from cattle, poultry, and hogs), Distillers Dried Solubles (DDS), Distillers Dried Grains (DDG), Condensed Distillers Solubles (CDS), Distillers Wet Grains (DWG), Distillers Dried Grains with Solubles (DDGS), woody materials (wood or bark, sawdust, timber slash, and mill scrap), municipal waste (waste paper, recycled toilet papers, yard clippings, etc.), and energy crops (poplars, willows, switchgrass, alfalfa, prairie bluestem, algae, including macroalgae, etc.). One exemplary source of biomass is plant matter. Plant matter can be, for example, woody plant matter, non-woody plant matter, cellulosic material, lignocellulosic material, hemicellulosic material, carbohydrates, pectin, starch, inulin, fructans, glucans, corn, sugar cane, grasses, switchgrass, sorghum, high biomass sorghum, bamboo, algae and material derived from these. Plants can be in their natural state or genetically modified, e.g., to increase the cellulosic or hemicellulosic portion of the cell wall, or to produce additional exogenous or endogenous enzymes to increase the separation of cell wall components. Plant matter can be further described by reference to the chemical species present, such as proteins, polysaccharides and oils. Polysaccharides include polymers of various monosaccharides and derivatives of monosaccharides including glucose, fructose, lactose, galacturonic acid, rhamnose, etc. Plant matter also includes agricultural waste byproducts or side streams such as pomace, corn steep liquor, corn steep solids, distillers grains, peels, pits, fermentation waste, straw, lumber, sewage, garbage and food leftovers. Peels can be citrus which include, but are not limited to, tangerine peel, grapefruit peel, orange peel, tangerine peel, lime peel and lemon peel. These materials can come from farms, forestry, industrial sources, households, etc. Another non-limiting example of biomass is animal matter, including, for example milk, meat, fat, animal processing waste, and animal waste. “Feedstock” is frequently used to refer to biomass being used for a process, such as those described herein.

“Broth” is used herein to refer to inoculated medium at any stage of growth, including the point immediately after inoculation and the period after any or all cellular activity has ceased and can include the material after post-fermentation processing. It includes the entire contents of the combination of soluble and insoluble matter, suspended matter, cells and medium, as appropriate.

The term “productivity” as used herein has its ordinary meaning as known to those skilled in the art and can include the mass of a material of interest produced in a given time in a given volume. Units can be, for example, grams per liter-hour, or some other combination of mass, volume, and time. In fermentation, productivity is frequently used to characterize how fast a product can be made within a given fermentation volume. The volume can be referenced to the total volume of the fermentation vessel, the working volume of the fermentation vessel, or the actual volume of broth being fermented. The context of the phrase will indicate the meaning intended to one of skill in the art. Productivity is different from “titer” in that productivity includes a time term, and titer is analogous to concentration. Titer and Productivity can generally be measured at any time during the fermentation, such as at the beginning, the end, or at some intermediate time, with titer relating the amount of a particular material present or produced at the point in time of interest and the productivity relating the amount of a particular material produced per liter in a given amount of time. The amount of time used in the productivity determination can be from the beginning of the fermentation or from some other time, and go to the end of the fermentation, such as when no additional material is produced or when harvest occurs, or some other time as indicated by the context of the use of the term. “Overall productivity” refers to the productivity determined by utilizing the final titer and the overall fermentation time.

“Titer” refers to the amount of a particular material present in a fermentation broth. It is similar to concentration and can refer to the amount of material made by the organism in the broth from all fermentation cycles, or the amount of material made in the current fermentation cycle or over a given period of time, or the amount of material present from whatever source, such as produced by the organism or added to the broth. Frequently, the titer of soluble species will be referenced to the liquid portion of the broth, with insolubles removed, and the titer of insoluble species will be referenced to the total amount of broth with insoluble species being present, however, the titer of soluble species can be referenced to the total broth volume and the titer of insoluble species can be referenced to the liquid portion, with the context indicating the which system is used with both reference systems intended in some cases. Frequently, the value determined referenced to one system will be the same or a sufficient approximation of the value referenced to the other.

“Concentration” when referring to material in the broth or in solution generally refers to the amount of a material present from all sources, whether made by the organism or added to the broth or solution. Concentration can refer to soluble species or insoluble species, and is referenced to either the liquid portion of the broth or the total volume of the broth, as for “titer.” When referring to a solution, such as “concentration of the sugar in solution”, the term indicates increasing one or more components of the solution through evaporation, filtering, extraction, etc., by removal or reduction of a liquid portion.

“Pretreatment” or “pretreated” is used herein to refer to any mechanical, chemical, thermal, biochemical process or combination of these processes whether in a combined step or performed sequentially, that achieves disruption or expansion of the biomass so as to render the biomass more susceptible to attack by enzymes and/or microbes, and can include the enzymatic hydrolysis of released carbohydrate polymers or oligomers to monomers. In one embodiment, pretreatment includes removal or disruption of lignin so as to make the cellulose and hemicellulose polymers in the plant biomass more available to cellulolytic enzymes and/or microbes, for example, by treatment with acid or base. In one embodiment, pretreatment includes disruption or expansion of cellulosic and/or hemicellulosic material. In another embodiment, it can refer to starch release and/or enzymatic hydrolysis to glucose. Steam explosion, and ammonia fiber expansion (or explosion) (AFEX) are well known thermal/chemical techniques. Hydrolysis, including methods that utilize acids, bases, and/or enzymes can be used. Other thermal, chemical, biochemical, enzymatic techniques can also be used.

“Sugar compounds” or “sugar streams” is used herein to indicate mostly monosaccharide sugars, dissolved, crystallized, evaporated, or partially dissolved, including but not limited to hexoses and pentoses; sugar alcohols; sugar acids; sugar amines; compounds containing two or more of these linked together directly or indirectly through covalent or ionic bonds; and mixtures thereof. Included within this description are disaccharides; trisaccharides; oligosaccharides; polysaccharides; and sugar chains, branched and/or linear, of any length. A sugar stream can consist of primarily or substantially C6 sugars, C5 sugars, or mixtures of both C6 and C5 sugars in varying ratios of said sugars. C6 sugars have a six-carbon molecular backbone and C5 sugars have a five-carbon molecular backbone.

A “sugar hydrolyzate” is a sugar stream that was produced in a hydrolysis reaction. Typically, a sugar hydrolyzate is produced from the pretreatment or hydrolysis of a biomass. The biomass can comprise cellulose, hemicellulose, or lignocellulose. The biomass can also comprise starch or other sugar polysaccharides or oligosaccharides. A “raw sugar hydrolyzate” is a sugar hydrolyzate that has undergone no or minimal post-hydrolysis processing (e.g., filtration, centrifugation, or pressing to remove unhydrolyzed solids) after the hydrolysis reaction. A “semi-refined sugar hydrolyzate” or “partially refined sugar hydrolyzate” is a sugar hydrolyzate that has undergone some post-hydrolysis processing, such as the removal of some color bodies or larger macromolecules (e.g., proteins, oligosaccharides, lignins, suspended solids). A “refined sugar hydrolyzate” is a sugar hydrolyzate that has undergone sufficient post-hydrolysis processing to remove some or all of one or more inhibitors (e.g., furfural, hydroxymethylfurfural, acetic acid, formic acid, etc.).

“C5-rich” or “C5-enriched” composition means that one or more steps have been taken to remove at least some of the C6 sugars originally in the composition. For example, a C5-rich composition can include no more than about 50% C6 sugars, nor more than about 40% C6 sugars, no more than about 30% C6 sugars, no more than about 20% C6 sugars, no more than about 10% C6 sugars, no more than about 5% C6 sugars, or it can include from about 2% to about 10% C6 sugars by weight. Likewise, a “C6-rich” or “C6-enriched” composition is one in which at least some of the originally-present C5 sugars have been removed. For example, a C6-rich composition can include no more than about 50% C5 sugars, nor more than about 40% C5 sugars, no more than about 30% C5 sugars, no more than about 20% C5 sugars, no more than about 10% C5 sugars, no more than about 5% C5 sugars, or it can include from about 2% to about 10% C5 sugars by weight.

A “liquid” composition may contain solids and a “solids” composition may contain liquids. A liquid composition refers to a composition in which the material is primarily liquid, and a solids composition is one in which the material is primarily solid.

The terms “non-cellulosic” and “sugar- or starch-based” are used interchangeably and have the same meaning. For example “non-cellulosic fermentation process” is used interchangeably and means the same thing as “sugar- and starch-based fermentation process.” Starch is a carbohydrate consisting of consisting of a large number of glucose units joined by glycosidic bonds. The glycosidic bonds are typically the easily hydrolysable alpha glycosidic bonds. This polysaccharide can be produced by all green plants as an energy store. There can be two types of starch molecules: the linear and helical amylose and the branched amylopectin, although amylase can also contain branches.

Pretreatment

In one embodiment, the feedstock (biomass) contains cellulosic, hemicellulosic, and/or lignocellulosic material. The feedstock can be derived from agricultural crops, crop residues, trees, woodchips, sawdust, paper, cardboard, grasses, algae, municipal waste and other sources.

Cellulose is a linear polymer of glucose where the glucose units are connected via β(1→4) linkages. Hemicellulose is a branched polymer of a number of sugar monomers including glucose, xylose, mannose, galactose, rhamnose and arabinose, and can have sugar acids such as mannuronic acid and galacturonic acid present as well. Lignin is a cross-linked, racemic macromolecule of mostly p-coumaryl alcohol, conferyl alcohol and sinapyl alcohol. These three polymers occur together in lignocellusic materials in plant biomass. The different characteristics of the three polymers can make hydrolysis of the combination difficult as each polymer tends to shield the others from enzymatic attack.

In one embodiment, methods are provided for the pretreatment of feedstock used in the fermentation and production of the biofuels and chemicals. The pretreatment steps can include mechanical, thermal, pressure, chemical, thermochemical, and/or biochemical tests pretreatment prior to being used in a bioprocess for the production of fuels and chemicals, but untreated biomass material can be used in the process as well. Mechanical processes can reduce the particle size of the biomass material so that it can be more conveniently handled in the bioprocess and can increase the surface area of the feedstock to facilitate contact with chemicals/biochemicals/biocatalysts. Mechanical processes can also separate one type of biomass material from another. The biomass material can also be subjected to thermal and/or chemical pretreatments to render plant polymers more accessible. Multiple steps of treatment can also be used.

Mechanical processes include, are not limited to, washing, soaking, milling, size reduction, screening, shearing, size classification and density classification processes. Chemical processes include, but are not limited to, bleaching, oxidation, reduction, acid treatment, base treatment, sulfite treatment, acid sulfite treatment, basic sulfite treatment, ammonia treatment, and hydrolysis. Thermal processes include, but are not limited to, sterilization, ammonia fiber expansion or explosion (“AFEX”), steam explosion, holding at elevated temperatures, pressurized or unpressurized, in the presence or absence of water, and freezing. Biochemical processes include, but are not limited to, treatment with enzymes, including enzymes produced by genetically-modified plants, and treatment with microorganisms. Various enzymes that can be utilized include cellulase, amylase, β-glucosidase, xylanase, gluconase, and other polysaccharases; lysozyme; laccase, and other lignin-modifying enzymes; lipoxygenase, peroxidase, and other oxidative enzymes; proteases; and lipases. One or more of the mechanical, chemical, thermal, thermochemical, and biochemical processes can be combined or used separately. Such combined processes can also include those used in the production of paper, cellulose products, microcrystalline cellulose, and cellulosics and can include biomass pulping, kraft pulping, acidic sulfite processing. The feedstock can be a side stream or waste stream from a facility that utilizes one or more of these processes on a biomass material, such as cellulosic, hemicellulosic or lignocellulosic material. Examples include paper plants, cellulosics plants, distillation plants, cotton processing plants, and microcrystalline cellulose plants. The feedstock can also include cellulose-containing or cellulosic containing waste materials. The feedstock can also be biomass materials, such as wood, grasses, corn, starch, or sugar, produced or harvested as an intended feedstock for production of ethanol or other products such as by biocatalysts.

In another embodiment, a method can utilize a pretreatment process disclosed in U.S. Patents and Patent Applications US20040152881, US20040171136, US20040168960, US20080121359, US20060069244, US20060188980, US20080176301, 5693296, 6262313, US20060024801, 5969189, 6043392, US20020038058, U.S. Pat. No. 5,865,898, U.S. Pat. No. 5,865,898, U.S. Pat. Nos. 6,478,965, 5,986,133, or US20080280338, each of which is incorporated by reference herein in its entirety.

In another embodiment, the AFEX process is be used for pretreatment of biomass. In a preferred embodiment, the AFEX process is used in the preparation of cellulosic, hemicellulosic or lignocellulosic materials for fermentation to ethanol or other products. The process generally includes combining the feedstock with ammonia, heating under pressure, and suddenly releasing the pressure. Water can be present in various amounts. The AFEX process has been the subject of numerous patents and publications.

In another embodiment, the pretreatment of biomass comprises the addition of calcium hydroxide to a biomass to render the biomass susceptible to degradation. Pretreatment comprises the addition of calcium hydroxide and water to the biomass to form a mixture, and maintaining the mixture at a relatively high temperature. Alternatively, an oxidizing agent, selected from the group consisting of oxygen and oxygen-containing gasses, can be added under pressure to the mixture. Examples of carbon hydroxide treatments are disclosed in U.S. Pat. No. 5,865,898 to Holtzapple and S. Kim and M. T. Holzapple, Bioresource Technology, 96, (2005) 1994, incorporated by reference herein in its entirety.

In one embodiment, pretreatment of biomass comprises dilute acid hydrolysis. Example of dilute acid hydrolysis treatment are disclosed in T. A. Lloyd and C. E Wyman, Bioresource Technology, (2005) 96, 1967), incorporated by reference herein in its entirety.

In another embodiment, pretreatment of biomass comprises pH controlled liquid hot water treatment. Examples of pH controlled liquid hot water treatments are disclosed in N. Mosier et al., Bioresource Technology, (2005) 96, 1986, incorporated by reference herein in its entirety.

In one embodiment, pretreatment of biomass comprises aqueous ammonia recycle process (ARP). Examples of aqueous ammonia recycle process are described in T. H. Kim and Y. Y. Lee, Bioresource Technology, (2005) 96, 2007, incorporated by reference herein in its entirety.

In one embodiment, the above mentioned methods have two steps: a pretreatment step that leads to a wash stream, and an enzymatic hydrolysis step of pretreated-biomass that produces a hydrolysate stream. In the above methods, the pH at which the pretreatment step is carried out includes acid hydrolysis, hot water pretreatment, steam explosion or alkaline reagent based methods (AFEX, ARP, and lime pretreatments). Dilute acid and hot water treatment methods solubilize mostly hemicellulose, whereas methods employing alkaline reagents remove most lignin during the pretreatment step. As a result, the wash stream from the pretreatment step in the former methods contains mostly hemicellulose-based sugars, whereas this stream has mostly lignin for the high-pH methods. The subsequent enzymatic hydrolysis of the residual biomass leads to mixed sugars (C5 and C6) in the alkali based pretreatment methods, while glucose is the major product in the hydrolyzate from the low and neutral pH methods. In one embodiment, the treated material is additionally treated with catalase or another similar chemical, chelating agents, surfactants, and other compounds to remove impurities or toxic chemicals or further release polysaccharides.

In one embodiment, pretreatment of biomass comprises ionic liquid (IL) pretreatment. Biomass can be pretreated by incubation with an ionic liquid, followed by IL extraction with a wash solvent such as alcohol or water. The treated biomass can then be separated from the ionic liquid/wash-solvent solution by centrifugation or filtration, and sent to the saccharification reactor or vessel. Examples of ionic liquid pretreatment are disclosed in US publication No. 2008/0227162, incorporated herein by reference in its entirety.

In another embodiment, a method can utilize a pretreatment process disclosed in U.S. Pat. No. 4,600,590 to Dale, U.S. Pat. No. 4,644,060 to Chou, U.S. Pat. No. 5,037,663 to Dale. U.S. Pat. No. 5,171,592 to Holtzapple, et al., et al., U.S. Pat. No. 5,939,544 to Karstens, et al., U.S. Pat. No. 5,473,061 to Bredereck, et al., U.S. Pat. No. 6,416,621 to Karstens, U.S. Pat. No. 6,106,888 to Dale, et al., U.S. Pat. No. 6,176,176 to Dale, et al., PCT publication WO2008/020901 to Dale, et al., Felix, A., et al., Anim. Prod. 51, 47-61 (1990), Wais, A. C., Jr., et al., Journal of Animal Science, 35, No. 1,109-112 (1972), which are incorporated herein by reference in their entireties.

Alteration of the pH of a pretreated feedstock can be accomplished by washing the feedstock (e.g., with water) one or more times to remove an alkaline or acidic substance, or other substance used or produced during pretreatment. Washing can comprise exposing the pretreated feedstock to an equal volume of water 2, 3, 4, 5, 6, 7, 8, 9, 10, 11, 12, 13, 14, 15, 16, 17, 18, 19, 20, 21, 22, 23, 24, 25 or more times. In another embodiment, a pH modifier can be added. For example, an acid, a buffer, or a material that reacts with other materials present can be added to modulate the pH of the feedstock. In one embodiment, more than one pH modifier can be used, such as one or more bases, one or more bases with one or more buffers, one or more acids, one or more acids with one or more buffers, or one or more buffers. When more than one pH modifiers are utilized, they can be added at the same time or at different times. Other non-limiting exemplary methods for neutralizing feedstocks treated with alkaline substances have been described, for example in U.S. Pat. Nos. 4,048,341; 4,182,780; and 5,693,296.

In one embodiment, one or more acids can be combined, resulting in a buffer. Suitable acids and buffers that can be used as pH modifiers include any liquid or gaseous acid that is compatible with the microorganism. Non-limiting examples include peroxyacetic acid, sulfuric acid, lactic acid, citric acid, phosphoric acid, and hydrochloric acid. In some instances, the pH can be lowered to neutral pH or acidic pH, for example a pH of 7.0, 6.5, 6.0, 5.5, 5.0, 4.5, 4.0, or lower. In some embodiments, the pH is lowered and/or maintained within a range of about pH 4.5 to about 7.1, or about 4.5 to about 6.9, or about pH 5.0 to about 6.3, or about pH 5.5 to about 6.3, or about pH 6.0 to about 6.5, or about pH 5.5 to about 6.9 or about pH 6.2 to about 6.7.

In another embodiment, biomass can be pre-treated at an elevated temperature and/or pressure. In one embodiment biomass is pre treated at a temperature range of 20° C. to 400° C. In another embodiment biomass is pretreated at a temperature of about 20° C., 25° C., 30° C., 35° C., 40° C., 45° C., 50° C., 55° C., 60° C., 65° C., 80° C., 90° C., 100° C., 120° C., 150° C., 200° C., 250° C., 300° C., 350° C., 400° C. or higher. In another embodiment, elevated temperatures are provided by the use of steam, hot water, or hot gases. In one embodiment steam can be injected into a biomass containing vessel. In another embodiment the steam, hot water, or hot gas can be injected into a vessel jacket such that it heats, but does not directly contact the biomass.

In another embodiment, a biomass can be treated at an elevated pressure. In one embodiment biomass is pre treated at a pressure range of about 1 psi to about 30 psi. In another embodiment biomass is pre treated at a pressure or about 1 psi, 2 psi, 3 psi, 4 psi, 5 psi, 6 psi, 7 psi, 8 psi, 9 psi, 10 psi, 12 psi, 15 psi, 18 psi, 20 psi, 22 psi, 24 psi, 26 psi, 28 psi, 30 psi or more. In some embodiments, biomass can be treated with elevated pressures by the injection of steam into a biomass containing vessel. In one embodiment, the biomass can be treated to vacuum conditions prior or subsequent to alkaline or acid treatment or any other treatment methods provided herein.

In one embodiment alkaline or acid pretreated biomass is washed (e.g. with water (hot or cold) or other solvent such as alcohol (e.g. ethanol)), pH neutralized with an acid, base, or buffering agent (e.g. phosphate, citrate, borate, or carbonate salt) or dried prior to fermentation. In one embodiment, the drying step can be performed under vacuum to increase the rate of evaporation of water or other solvents. Alternatively, or additionally, the drying step can be performed at elevated temperatures such as about 20° C., 25° C., 30° C., 35° C., 40° C., 45° C., 50° C., 55° C., 60° C., 65° C., 80° C., 90° C., 100° C., 120° C., 150° C., 200° C., 250° C., 300° C. or more.

In one embodiment of the present invention, the pretreatment step includes a step of solids recovery. The solids recovery step can be during or after pretreatment (e.g., acid or alkali pretreatment), or before the drying step. In one embodiment, the solids recovery step provided by the methods of the present invention includes the use of a sieve, filter, screen, or a membrane for separating the liquid and solids fractions. In one embodiment a suitable sieve pore diameter size ranges from about 0.001 microns to 8 mm, such as about 0.005 microns to 3 mm or about 0.01 microns to 1 mm. In one embodiment a sieve pore size has a pore diameter of about 0.01 microns, 0.02 microns, 0.05 microns, 0.1 microns, 0.5 microns, 1 micron, 2 microns, 4 microns, 5 microns, 10 microns, 20 microns, 25 microns, 50 microns, 75 microns, 100 microns, 125 microns, 150 microns, 200 microns, 250 microns, 300 microns, 400 microns, 500 microns, 750 microns, 1 mm or more. In one embodiment, biomass (e.g. corn stover) is processed or pretreated prior to fermentation. In one embodiment a method of pre-treatment includes but is not limited to, biomass particle size reduction, such as for example shredding, milling, chipping, crushing, grinding, or pulverizing. In one embodiment, biomass particle size reduction can include size separation methods such as sieving, or other suitable methods known in the art to separate materials based on size. In one embodiment size separation can provide for enhanced yields. In one embodiment, separation of finely shredded biomass (e.g. particles smaller than about 8 mm in diameter, such as, 8, 7.9, 7.7, 7.5, 7.3, 7, 6.9, 6.7, 6.5, 6.3, 6, 5.9, 5.7, 5.5, 5.3, 5, 4.9, 4.7, 4.5, 4.3, 4, 3.9, 3.7, 3.5, 3.3, 3, 2.9, 2.7, 2.5, 2.3, 2, 1.9, 1.7, 1.5, 1.3, 1, 0.9, 0.8, 0.7, 0.6, 0.5, 0.4, 0.3, 0.2, or 0.1 mm) from larger particles allows the recycling of the larger particles back into the size reduction process, thereby increasing the final yield of processed biomass. In one embodiment, a fermentative mixture is provided which comprises a pretreated lignocellulosic feedstock comprising less than about 50% of a lignin component present in the feedstock prior to pretreatment and comprising more than about 60% of a hemicellulose component present in the feedstock prior to pretreatment; and a microorganism capable of fermenting a five-carbon sugar, such as xylose, arabinose or a combination thereof, and a six-carbon sugar, such as glucose, galactose, mannose or a combination thereof. In some instances, pretreatment of the lignocellulosic feedstock comprises adding an alkaline substance which raises the pH to an alkaline level, for example NaOH. In one embodiment, NaOH is added at a concentration of about 0.5% to about 2% by weight of the feedstock. In one embodiment, pretreatment also comprises addition of a chelating agent.

Hydrolysis

In one embodiment, the biomass hydrolyzing unit provides useful advantages for the conversion of biomass to biofuels and chemical products. One advantage of this unit is its ability to produce monomeric sugars from multiple types of biomass, including mixtures of different biomass materials, and is capable of hydrolyzing polysaccharides and higher molecular weight saccharides to lower molecular weight saccharides. In one embodiment, the hydrolyzing unit utilizes a pretreatment process and a hydrolytic enzyme which facilitates the production of a sugar stream containing a concentration of a monomeric sugar or several monomeric sugars derived from cellulosic and/or hemicellulosic polymers. Examples of biomass material that can be pretreated and hydrolyzed to manufacture sugar monomers include, but are not limited to, cellulosic, hemicellulosic, lignocellulosic materials; pectins; starches; wood; paper; agricultural products; forest waste; tree waste; tree bark; leaves; grasses; sawgrass; woody plant matter; non-woody plant matter; carbohydrates; starch; inulin; fructans; glucans; corn; sugar cane; sorghum, other grasses; bamboo, algae, and material derived from these materials. This ability to use a very wide range of pretreatment methods and hydrolytic enzymes gives distinct advantages in biomass fermentations. Various pretreatment conditions and enzyme hydrolysis can enhance the extraction of sugars from biomass, resulting in higher yields, higher productivity, greater product selectivity, and/or greater conversion efficiency.

In one embodiment, the enzyme treatment is used to hydrolyze various higher saccharides (higher molecular weight) present in biomass to lower saccharides (lower molecular weight), such as in preparation for fermentation by biocatalysts such as yeasts to produce ethanol, hydrogen, or other chemicals such as organic acids including succinic acid, formic acid, acetic acid, and lactic acid. These enzymes and/or the hydrolysate can be used in fermentations to produce various products including fuels, and other chemicals.

In one example, the process for converting biomass material into ethanol includes pretreating the biomass material (e.g., “feedstock”), hydrolyzing the pretreated biomass to convert polysaccharides to oligosaccharides, further hydrolyzing the oligosaccharides to monosaccharides, and converting the monosaccharides to biofuels and chemical products. Enzymes such as cellulases, polysaccharases, lipases, proteases, ligninases, and hemicellulases, help produce the monosaccharides can be used in the biosynthesis of fermentation end-products. Biomass material that can be utilized includes woody plant matter, non-woody plant matter, cellulosic material, lignocellulosic material, hemicellulosic material, carbohydrates, pectin, starch, inulin, fructans, glucans, corn, algae, sugarcane, other grasses, switchgrass, bagasse, wheat straw, barley straw, rice straw, corncobs, bamboo, citrus peels, sorghum, high biomass sorghum, seed hulls, and material derived from these. The final product can then be separated and/or purified, as indicated by the properties for the desired final product. In some instances, compounds related to sugars such as sugar alcohols or sugar acids can be utilized as well.

Chemicals used in the methods of the present invention are readily available and can be purchased from a commercial supplier, such as Sigma-Aldrich. Additionally, commercial enzyme cocktails (e.g. Accellerase™ 1000, CelluSeb-TL, CelluSeb-TS, Cellic™, CTec, STARGEN™, Maxalig™, Spezyme®, Distillase®, G-Zyme®, Fermenzyme®, Fermgen™, GC 212, or Optimash™) or any other commercial enzyme cocktail can be purchased from vendors such as Specialty Enzymes & Biochemicals Co., Genencor, or Novozymes. Alternatively, enzyme cocktails can be prepared by growing one or more organisms such as for example a fungi (e.g. a Trichoderma, a Saccharomyces, a Pichia, a White Rot Fungus etc.), a bacteria (e.g. a Clostridium, or a coliform bacterium, a Zymomonas bacterium, Sacharophagus degradans etc.) in a suitable medium and harvesting enzymes produced therefrom. In some embodiments, the harvesting can include one or more steps of purification of enzymes.

In one embodiment, treatment of biomass comprises enzyme hydrolysis. In one embodiment a biomass is treated with an enzyme or a mixture of enzymes, e.g., endonucleases, exonucleases, cellobiohydrolases, cellulase, beta-glucosidases, glycoside hydrolases, glycosyltransferases, lyases, esterases and proteins containing carbohydrate-binding modules. In one embodiment, the enzyme or mixture of enzymes is one or more individual enzymes with distinct activities. In another embodiment, the enzyme or mixture of enzymes can be enzyme domains with a particular catalytic activity. For example, an enzyme with multiple activities can have multiple enzyme domains, including for example glycoside hydrolases, glycosyltransferases, lyases and/or esterases catalytic domains.

In one embodiment, enzymes that degrade polysaccharides are used for the hydrolysis of biomass and can include enzymes that degrade cellulose, namely, cellulases. Examples of some cellulases include endocellulases and exo-cellulases that hydrolyze beta-1,4-glucosidic bonds.

In one embodiment, enzymes that degrade polysaccharides are used for the hydrolysis of biomass and can include enzymes that have the ability to degrade hemicellulose, namely, hemicellulases. Hemicellulose can be a major component of plant biomass and can contain a mixture of pentoses and hexoses, for example, D-xylopyranose, L-arabinofuranose, D-mannopyranose, D-glucopyranose, D-galactopyranose, D-glucopyranosyluronic acid and other sugars. In one embodiment, enzymes that degrade polysaccharides are used for the hydrolysis of biomass and can include enzymes that have the ability to degrade pectin, namely, pectinases. In plant cell walls, the cross-linked cellulose network can be embedded in a matrix of pectins that can be covalently cross-linked to xyloglucans and certain structural proteins. Pectin can comprise homogalacturonan (HG) or rhamnogalacturonan (RH).

In one embodiment, hydrolysis of biomass includes enzymes that can hydrolyze starch. Enzymes that hydrolyze starch include alpha-amylase, glucoamylase, beta-amylase, exo-alpha-1,4-glucanase, and pullulanase.

In one embodiment, hydrolysis of biomass comprises hydrolases that can include enzymes that hydrolyze chitin. In another embodiment, hydrolases can include enzymes that hydrolyze lichen, namely, lichenase.

In one embodiment, after pretreatment and/or hydrolysis by any of the above methods the feedstock contains cellulose, hemicellulose, soluble oligomers, simple sugars, lignin, volatiles and ash. The parameters of the hydrolysis can be changed to vary the concentration of the components of the pretreated feedstock. For example, in one embodiment a hydrolysis is chosen so that the concentration of soluble C5 saccharides is high and the concentration of lignin is low after hydrolysis. Examples of parameters of the hydrolysis include temperature, pressure, time, concentration, composition and pH.

In one embodiment, the parameters of the pretreatment and hydrolysis are changed to vary the concentration of the components of the pretreated feedstock such that concentration of the components in the pretreated and hydrolyzed feedstock is optimal for fermentation with a microbe such as a yeast or bacterium microbe.

In one embodiment, the parameters of the pretreatment are changed to encourage the release of the components of a genetically modified feedstock such as enzymes stored within a vacuole to increase or complement the enzymes synthesized by biocatalyst to produce optimal release of the fermentable components during hydrolysis and fermentation.

In one embodiment, the parameters of the pretreatment and hydrolysis are changed such that concentration of accessible cellulose in the pretreated feedstock is 1%, 5%, 10%, 12%, 13%, 14%, 15%, 16%, 17%, 19%, 20%, 30%, 40% or 50%. In one embodiment, the parameters of the pretreatment are changed such that concentration of accessible cellulose in the pretreated feedstock is 5% to 30%. In one embodiment, the parameters of the pretreatment are changed such that concentration of accessible cellulose in the pretreated feedstock is 10% to 20%.

In one embodiment, the parameters of the pretreatment are changed such that concentration of hemicellulose in the pretreated feedstock is 1%, 5%, 10%, 12%, 13%, 14%, 15%, 16%, 17%, 19%, 20%, 21%, 22%, 23%, 24%, 25%, 26%, 27%, 28%, 29%, 30%, 40% or 50%. In one embodiment, the parameters of the pretreatment are changed such that concentration of hemicellulose in the pretreated feedstock is 5% to 40%. In one embodiment, the parameters of the pretreatment are changed such that concentration of hemicellulose in the pretreated feedstock is 10% to 30%.

In one embodiment, the parameters of the pretreatment and hydrolysis are changed such that concentration of soluble oligomers in the pretreated feedstock is 1%, 10%, 15%, 20%, 25%, 30%, 35%, 40%, 45%, 50%, 55%, 60%, 65%, 70%, 75%, 80%, 85%, 90%, 95%, or 99%.

Examples of soluble oligomers include, but are not limited to, cellobiose and xylobiose. In one embodiment, the parameters of the pretreatment are changed such that concentration of soluble oligomers in the pretreated feedstock is 30% to 90%. In one embodiment, the parameters of the pretreatment and/or hydrolysis are changed such that concentration of soluble oligomers in the pretreated feedstock is 45% to 80%.

In one embodiment, the parameters of the pretreatment and hydrolysis are changed such that concentration of simple sugars in the pretreated feedstock is 1%, 5%, 10%, 12%, 13%, 14%, 15%, 16%, 17%, 19%, 20%, 30%, 40% or 50%. In one embodiment, the parameters of the pretreatment and hydrolysis are changed such that concentration of simple sugars in the pretreated feedstock is 0% to 20%. In one embodiment, the parameters of the pretreatment and hydrolysis are changed such that concentration of simple sugars in the pretreated feedstock is 0% to 5%. Examples of simple sugars include, but are not limited to, C5 and C6 monomers and dimers.

In one embodiment, the parameters of the pretreatment are changed such that concentration of lignin in the pretreated and/or hydrolyzed feedstock is 1%, 5%, 10%, 12%, 13%, 14%, 15%, 16%, 17%, 19%, 20%, 30%, 40% or 50%. In one embodiment, the parameters of the pretreatment and/or hydrolysis are changed such that concentration of lignin in the pretreated feedstock is 0% to 20%. In one embodiment, the parameters of the pretreatment and/or hydrolysis are changed such that concentration of lignin in the pretreated feedstock is 0% to 5%. In one embodiment, the parameters of the pretreatment and hydrolysis are changed such that concentration of lignin in the pretreated and/or hydrolyzed feedstock is less than 1% to 2%. In one embodiment, the parameters of the pretreatment and/or hydrolysis are changed such that the concentration of phenolics is minimized.

In one embodiment, the parameters of the pretreatment and/or hydrolysis are changed such that concentration of furfural and low molecular weight lignin in the pretreated and/or hydrolyzed feedstock is less than 10%, 9%, 8%, 7%, 6%, 5%, 4%, 3%, 2%, or 1%. In one embodiment, the parameters of the pretreatment and/or hydrolysis are changed such that concentration of furfural and low molecular weight lignin in the pretreated and/or hydrolyzed feedstock is less than 1% to 2%.

In one embodiment, the parameters of the pretreatment and/or hydrolysis are changed such that the concentration of simple sugars is at least 75% to 85%, and the concentration of lignin is 0% to 5% and the concentration of furfural and low molecular weight lignin in the pretreated feedstock is less than 1% to 2%.

In one embodiment, the parameters of the pretreatment and/or hydrolysis are changed to obtain a high concentration of hemicellulose and a low concentration of lignin. In one embodiment, the parameters of the pretreatment and/or hydrolysis are changed to obtain a high concentration of hemicellulose and a low concentration of lignin such that concentration of the components in the pretreated stock is optimal for fermentation with a microbe such as biocatalyst.

In one embodiment, more than one of these steps can occur at any given time. For example, hydrolysis of the pretreated feedstock and hydrolysis of the oligosaccharides can occur simultaneously, and one or more of these can occur simultaneously to the conversion of monosaccharides to a fuel or chemical.

In another embodiment, an enzyme can directly convert the polysaccharide to monosaccharides. In some instances, an enzyme can hydrolyze the polysaccharide to oligosaccharides and the enzyme or another enzyme can hydrolyze the oligosaccharides to monosaccharides.

In another embodiment, the enzymes can be added to the fermentation or they can be produced by microorganisms present in the fermentation. In one embodiment, the microorganism present in the fermentation produces some enzymes. In another embodiment, enzymes are produced separately and added to the fermentation.

For the overall conversion of pretreated biomass to final product to occur at high rates, it is generally necessary for each of the necessary enzymes for each conversion step to be present with sufficiently high activity. If one of these enzymes is missing or is present in insufficient quantities, the production rate of an end product will be reduced. The production rate can also be reduced if the microorganisms responsible for the conversion of monosaccharides to product only slowly take up monosaccharides and/or have only limited capability for translocation of the monosaccharides and intermediates produced during the conversion to end product. Additions of fractions obtained from pretreatment and/or pretreatment and hydrolysis can increase initial or overall growth rates. In another embodiment, oligomers are taken up slowly by a biocatalyst, necessitating an almost complete conversion of polysaccharides and oligomers to monomeric sugars.

In another embodiment, the enzymes of the method are produced by a biocatalyst, including a range of hydrolytic enzymes suitable for the biomass materials used in the fermentation methods. In one embodiment, a biocatalyst is grown under conditions appropriate to induce and/or promote production of the enzymes needed for the saccharification of the polysaccharide present. The production of these enzymes can occur in a separate vessel, such as a seed fermentation vessel or other fermentation vessel, or in the production fermentation vessel where ethanol production occurs. When the enzymes are produced in a separate vessel, they can, for example, be transferred to the production fermentation vessel along with the cells, or as a relatively cell free solution liquid containing the intercellular medium with the enzymes. When the enzymes are produced in a separate vessel, they can also be dried and/or purified prior to adding them to the hydrolysis or the production fermentation vessel. The conditions appropriate for production of the enzymes are frequently managed by growing the cells in a medium that includes the biomass that the cells will be expected to hydrolyze in subsequent fermentation steps. Additional medium components, such as salt supplements, growth factors, and cofactors including, but not limited to phytate, amino acids, and peptides can also assist in the production of the enzymes utilized by the microorganism in the production of the desired products.

Clarification and Refinement

During pre-treatment, the severity of operating conditions (such as pH, temperature, and time) may cause formation of components that are inhibitory to fermentation, such as, for example, the formation of colored components and complex mixtures of phenolics and furan derivatives, including aromatic compounds that contribute as ‘colored bodies’. For example, under some conditions, the dehydration of sugars (such as xylose or arabinose) may cause the formation of furfural. Acetic acid may also be formed, for example, when acetate is released during the break down of hemicellulose in pre-treatment. The levels of acetic acid can become as high as 4000 ppm (0.4% w/v). Acetic acid can inhibit yeast metabolism. Also, acetic acid can inhibit xylose uptake and metabolism in the recombinant yeast. Reducing the acetic acid levels to about 2000 ppm or less can improve the fermentability of pentose containing sugar syrups. Sulfuric acid, which may be added to prepared biomass to facilitate pre-treatment, if not removed or neutralized, may also be inhibitory to fermentation. According to an exemplary embodiment, by adjusting pre-treatment conditions (such as pH, temperature, and time), the formation of inhibitors can be reduced or managed; according to other exemplary embodiments, components of the pre-treated biomass may be given further treatment to remove or reduce the level of inhibitors (or other undesirable matter).

Treatment of the C5 and C6 stream (liquid component or hydrolyzate) of the pretreated or hydrolyzed biomass can be performed in an effort to remove components that are inhibitory to efficient fermentation (e.g. furfural, hydroxymethylfurfural (HMF), and acetic acid), volatiles, and residual lignin (or other matter) that may not be fermentable from the C5/C6 sugar component so that the sugars (e.g. xylose, arabinose, as well as other sugars such as glucose) are available for fermentation. Depending on the pretreatment reactions/conditions used, several furan derivatives and mixtures of phenolic compounds can be formed during the pre-treatment of lignocellulosic biomass. Many of the furan derivatives and mixtures of phenolic compounds can be derived from lignin. Color compounds (color bodies or color molecules) found in lignocellulose derived hyrdolysate can be complex mixtures of various compounds comprising aromatic and furan rings. For example, complex mixtures of dark phenolic compounds comprising one furan derivate, 5-HMF, and two phenolic compounds, trans-cinnamic acid and 3,5-dimethoxy-4-hydroxy-cinnamic acid, can be formed from acid catalyzed reactions performed on lignocellulose biomass. These complex mixtures of dark phenolic compounds can be color molecules or color bodies. Other phenolic compounds formed, including syringaldeyhde, vanillin, trans-4-hydroxy-3-methoxy, and 4-hydroxy cinnamic acids can also act as inhibitors of microbial growth and fermentation inhibitors. Other compounds that can be noticed for color and toxicity in lignocellulose derived hyrdolysate can be 2-furaldehyde, benzyl alcohol and acetophenone. Because the above mentioned compounds (e.g., furan derivatives and mixtures of phenolic compounds, 2-furaldehyde, benzyl alcohol and acetophenone, syringaldeyhde, vanillin, trans-4-hydroxy-3-methoxy, and 4-hydroxy cinnamic acids) can be complex and can be difficult to characterize, they can be labeled as “color contributing molecules or color bodies”. In bioleaching processes, laccase′ and poly phenol and poly oxi manganese enzymes can be used to decolorize or reduce the intensity of color in a woody pulp hydrolysate.

Fermentation inhibitors can also be mitigated using ion exchange resins, over-liming, or by a large yeast inoculation of the fermentation step. There has been a substantial amount of research performed related to the use of over-liming as a way to reduce the toxic effects of the fermentation inhibitors produced as a result of dilute acid pretreatment of lignocellulosic biomass. Some major drawbacks of the over-liming process with Ca(OH) can include a loss of fermentable sugars, degradation due to hydroxide-catalyzed degradation reactions, and possible downstream effects in distillation. These downstream effects can include precipitated calcium salts that can contaminate distillation columns, evaporators and heat exchangers, and the possibility of lactic acid bacterial contamination of the over-limed pentose liquor. This form of bacterial contamination can be particularly important since calcium lactate is inhibitory to the fermenting yeast. Thus, clarification and refinement of sugar streams can be an integral part and major cost factor in the chemical industry, especially for their role in selective removal and sequestering toxic inhibitors.

Filtration

Membrane filtration can be used to clarify and refine sugar hydrolyzates produced by pretreating or hydrolyzing biomass comprising cellulose, hemicellulose, or lignocellulose. Membrane filtration, depending upon type of filter membrane, can be used to: remove color bodies/molecules and larger macromolecules (e.g., proteins, oligosaccharides, lignins, etc.), remove inhibitors (e.g., furfural, hydroxymethylfurfural, acetic acid, formic acid, small phenolic molecules, etc.); concentrate sugars; remove salts; recover water; and/or separate C6 sugars from C5 sugars. Depending on the feedstock and its composition as well as pretreatment conditions used, several mixtures of phenolic compounds can be formed during pre-treatment of biomass that can be referred to as color molecules or color bodies. In some cases, the biomass is lignocellulosic biomass. Many of the mixtures can be derived from the breakdown of lignin. Color compounds (color bodies or color molecules) typically noticed in lignocellulose derived hyrdolysates can be complex mixtures of various aromatic and furan rings. The mixtures may comprise, HMF, trans-cinnamic acid and 3,5-dimethoxy-4-hydroxy-cinnamic acid, which can be complex mixtures of dark phenolic compounds derived on acid catalyzed reaction and can contribute to color. Other phenolic compounds, including syringaldeyhde, vanillin, trans-4-hydroxy-3-methoxy, and 4-hydroxy cinnamic acids can also act as inhibitors of microbial growth and fermentation. Other compounds that can be noticed for color and toxicity can be 2-furaldehyde, benzyl alcohol and acetophenone. Selective removal or reduction in the amount of these small phenolic molecules including other inhibitors (e.g., furfural, hydroxymethylfurfural, acetic acid, formic acid, etc.) can be essential. Filtration of a sugar hydrolyzate with an ultrafiltration membrane as provided herein can remove small phenolic and/or furan inhibitors in addition to color molecules (e.g., complex aromatic color molecules) and suspended solids. A retentate generated by filtration of a sugar hydrolyzate with an ultrafiltration membrane can comprise small phenolic and/or furan inhibitors in addition to color molecules (e.g., complex aromatic color molecules) and suspended solids. Filtration of a sugar hydrolyzate with a microfiltration membrane as provided herein can remove small phenolic and/or furan inhibitors in addition to color molecules (e.g., complex aromatic color molecules) and suspended solids. A retentate generated by filtration of a sugar hydrolyzate with a microfiltration membrane can comprise small phenolic and/or furan inhibitors in addition to color molecules (e.g., complex aromatic color molecules) and suspended solids.

Filter membranes can be divided into four classes according to pore size: classic filters, which typically have pore sizes greater than 10 μm; microfiltration filters, which typically have pore sizes greater that about 0.1 μm and molecular weight cutoffs of greater than about 5000 kDa; ultrafiltration filters, which typically have pore sizes ranging from about 2 nm to 100 nm and molecular weight cutoffs of from about 5 kDa to about 5000 kDa; nanofiltration membranes, which typically have pore sizes of from about 1-2 nm and molecular weight cutoffs of about 0.1-5 kDa; and reverse osmosis membranes, which have pore sizes less than 1 nm in size and molecular weight cutoffs of less than about 100 Da.

Nanofiltration is a pressure-driven membrane filtration process, falling between reverse osmosis and ultrafiltration. Nanofiltration retains large and organic molecules between 100 and 1000 molecular weight, typically with a molar mass greater than 300 g/mol. Nanofiltration membranes can be composite membranes made by interfacial polymerization. Polyether sulfone membranes, sulfonated polyether sulfone membranes, polyester membranes, polysulfone membranes, aromatic polyamide membranes, polyvinyl alcohol membranes and polypiperazine membranes are examples of widely used nanofiltration membranes. Inorganic and ceramic membranes can also be used for nanofiltration.

Nanofiltration membranes have been defined by their ability to reject only ions which have a negative charge over one, such as sulphate or phosphate, while passing single-charged ions. The rejection of uncharged, dissolved materials and also of positively charged ions in the solution relate mostly to the size and shape of the molecule in question. Salts with monovalent anions, e.g., chlorides pass through the membrane, whereas salts with polyvalent anions, sulfates or phosphates, are retained. In water purification, nanofiltration is used to process surface waters to remove organics such as humic and fulvic acids.

Nanofiltration has been used for separating monosaccharides, such as glucose and mannose from disaccharides and higher saccharides. The starting mixture including monosaccharides, disaccharides and higher saccharides can be a starch hydrolysate, for example.

U.S. Pat. No. 5,869,297 discloses a nanofiltration process for making dextrose wherein disaccharides and trisaccharides are separated. WO 99/28490 discloses a method for enzymatic reaction of saccharides and for nanofiltration of the enzymatically treated saccharide solution to separate monosaccharides from disaccharides, trisaccharides and higher saccharides.

U.S. Pat. No. 6,126,754 describes a process wherein a starch hydrolysate with a high dextrose content is subjected to enzymatic treatment to obtain a raw saccharified hydrolysate and then nanofiltered to collect, as the nanofiltration permeate, the desired starch hydrolysate with a high dextrose content.

Ultrafiltration can be used to separate compounds having a large molar mass, such as lignosulphonates present in a sulphite spent liquor, from compounds having a small molar mass, such as xylose, whereby compounds having a large molar mass (lignosulphonates) are separated into the retentate and compounds having a small molar mass (xylose) are enriched into the permeate. Further enriching of xylose from other chemicals, such as salts is possible, for example, with chromatographic methods using ion exclusion.

Diafiltration is a process that normally uses ultrafiltration membranes to partially or completely remove, replace, or lower the concentration of salts or solvents from solutions containing sugars, proteins, peptides, nucleic acids, and other biomolecules. Small molecules (e.g., molecules at or below the molecular weight cutoff of the membrane) are separated from a solution while larger molecules are retained in the retentate.

Diafiltration involves adding liquid (e.g., water or a buffered solution) to the solution being filtered. A “diafiltration volume” is equal to the initial volume in which the molecule of interest is suspended. A molecule that is 100% permeable through the filter membrane are generally so easily washed through the membrane that for a fully permeated species about 3 to 4 diafiltrate volumes of additional liquid (e.g., water) can eliminate 95% of the microsolute.

Diafiltration processes can be continuous, wherein the additional liquid is added to the retentate in order to maintain a constant volume over time. Diafiltration processes can also be discontinuous, wherein additional liquid is added before filtration (“discontinuous diafiltration-sequential reduction”) or during the filtration process after the retentate is reduced by a specified volume (“discontinuous diafiltration-volume reduction” or “fill and draw”). Discontinuous diafiltration techniques can involve multiple rounds of liquid addition.

A membrane is typically selected based on its rejection characteristics for the sample to be filtered. As a general rule, the molecular weight cut-off of the membrane should be ⅓rd to ⅙th the molecular weight of the target molecule to be retained. This is to assure as complete a retention as possible. The closer the molecular cut-off weight is to that of the sample, the greater the risk for some small product loss during filtration. The risk increases if diafiltration will also be used since the relative loss depends on the total volume of filtrate that will be generated.

Membrane flux rate (filtrate flow rate per unit area of membrane) is related to pore size. The smaller the pores, the lower the flux rate for the same applied pressure. Therefore, when selecting a membrane for concentration/diafiltration, there can be a tradeoff between product recovery and filtration time. In many biological applications, recovery outweighs the time consideration. The process time can be reduced by increasing the amount of membrane area used.

A sample is placed in a device containing a suitable filtration membrane that will retain the large molecules. Pressure is applied until half the volume has passed through the membrane. The large molecules are retained in half the original volume (concentrate), which also contains half of the salt molecules. The filtrate contains the other half of the salt molecules but none of the large molecules. Therefore, the large molecules are concentrated as liquid and salt are removed. The salt molecule to volume ratio in the concentrate remains constant so the ionic strength of the concentrated solution remains relatively constant.

The ionic strength of the concentrate (retentate) solution can subsequently be reduced by “washing” the remaining salt out with water, a process called diafiltration. This is essentially a dilution process and is performed in conjunction with a concentration process. Water is added while filtrate is removed. If the washing solution is another buffer instead of water, the new buffer salt will replace the initial salt in the sample. For simplicity, the above and subsequent examples use a direct flow filtration device such as a centrifugal concentrator. The same principles apply to cross flow filtration devices such as cassettes and hollow fibers where the retentate is recirculated.

Conventional techniques used for salt removal or buffer exchange such as membrane dialysis and column-based gel filtration can be effective but have limitations. Dialysis procedures can take up to several days, require large volumes of water for equilibration and risk product loss through manual manipulation of the dialysis bags. Gel filtration results in a dilution of the sample and often requires an additional ultrafiltration step to concentrate it back. Adding steps to a process can risk sample loss or possible contamination. With diafiltration, salt or solvent removal as well as buffer exchange can be performed quickly and conveniently. Another big advantage of diafiltration is that the sample is concentrated on the same system, minimizing the risk of sample loss or contamination.

There are several ways to perform diafiltration. While the end result may be the same, the time and volume required to complete the process may vary considerably. It is important to understand the differences in the methods used and when to choose one over the other.

The technique of continuous diafiltration (also referred to as constant volume diafiltration) involves washing out the original buffer salts (or other low molecular weight species) in the retentate (sample) by adding water or a new buffer to the retentate at the same rate as filtrate is being generated. As a result, the retentate volume and product concentration does not change during the diafiltration process. If water is used for diafiltering, the salts will be washed out and the conductivity lowered. If a buffer is used for diafiltering, the new buffer salt concentration will increase at a rate inversely proportional to that of the species being removed. The amount of salt removed is related to the filtrate volume generated, relative to the retentate volume. The filtrate volume generated is usually referred to in terms of “diafiltration volumes.” For continuous diafiltration, liquid is added at the same rate as filtrate is generated. Using continuous diafiltration, greater than 99.5% of a 100% permeable solute can be removed by washing through 6 retentate volumes with the buffer of choice.

Molecules that are larger than salts and solvents, but which are still smaller than the pores in the membrane, can also be washed out. The permeability of these molecules, however, may be less than 100%. In such cases, it will take more liquid, i.e. more DV's, to completely wash a partially permeable molecule through the membrane, compared to a 100% permeable molecule. Typically, the larger the molecule, the lower the permeability and the greater the wash volume required. The permeability of a molecule through a specific membrane can be determined by measuring the concentration of the molecule in the filtrate compared to the concentration in the retentate under specified conditions. Permeability will be affected by such factors as transmembrane pressure, crossflow rate, retentate concentration, pH, and ionic strength, and gel layer formation (concentration polarization). Therefore, the permeability may change during the process.

Xylose has been typically recovered by crystallization, e.g., from xylose-containing solutions of various origin and purity. Before crystallization, for example, it is as a rule necessary to purify the xylose-containing solution obtained as a result of the hydrolysis of cellulosic material to a required degree of purity by various methods, such as filtration to remove mechanical impurities, ultrafiltration, ion-exchange, decolouring, ion exclusion or chromatography or combinations thereof.

Separation of xylose from such cooking liquors is described, for example, in U.S. Pat. No. 4,631,129. In this process, sulphite spent liquor is subjected to two-step chromatographic separation to form substantially purified fractions of sugars (e.g., xylose) and lignosulphonates. The first chromatographic fractionation is carried out using a resin in a divalent metal salt form, typically in a calcium salt form, and the second chromatographic fractionation is carried out using a resin in a monovalent salt form, such as a sodium salt form.

U.S. Pat. Nos. 5,637,225 and 5,730,877 disclose methods for the fractionation of sulphite cooking liquor by a chromatographic means. The material in the sectional packing material beds is typically a strongly acidic cation exchange resin in Ca2+ form.

WO 96/27028 discloses a method for the recovery of xylose by crystallization and/or precipitation from solutions having a comparatively low xylose purity, typically 30 to 60% by weight of xylose on dissolved dry solids. The xylose solution to be treated may be, for example, a concentrate chromatographically obtained from a sulphite pulping liquor.

Described herein are systems and methods for color removal and/or potential inhibitor mitigation using a combination of ultrafiltration and nanofiltration membranes with the use of diafiltration in order to increase cofermentability of the combined hexose and pentose liquor without the common drawbacks of over-liming for detoxifying lignocellulosic hydrolysates. Further disclosed are methods of separating monosaccharides such as xylose and glucose by the application of diafiltration with other filtration methods.

The disclosed methods relate to improving fermentation of C5 and C6 sugars derived from hydrolysate of biomass comprising cellulose, hemicellulose, or lignocellulose (e.g., wood and other biomass) through operation of one or more nanofiltering systems. Thereby, such methods enable refinement of the lignocellulose hydrolysate derived from pretreatment of biomass and allow further improvement of fermentation though the mitigation of fermentation inhibitors and other interfering molecules in the liquid portion of a lignocellulosic hydrolysate (also referred to as a sugar hydrolysate). According to some aspects, removing and separating different organic acids and sugars comprises using at least one nanofilter, and can include an optional first ultrafiltration stage followed by a one or more nanofiltration stages. This can be achieved by a combination of prefilteration, clarification and configuration to remove suspended particle size greater than 25 and 50 microns, reduction of color bodies using specified pore size membrane filters for nanofiltration and diafiltration. Aspects provide for decreasing fermentation inhibitors resulting from lignocellulose hydrolysates. Various aspects also provide an improvement in the separation of selective small molecules, such as furfural acetic acid and eliminating aromatic phenolic compounds and suspended solids. The disclosed systems and methods also provide an effective method of improving and enriching the ratios of C5 and C6 within the sugar mixture.

Accordingly, in a first aspect, disclosed herein are methods of refining a sugar hydrolyzate comprising C5 sugars and C6 sugars produced by pretreating or hydrolyzing of a biomass comprising cellulosic, hemicellulosic, or lignocellulosic material, the methods comprising: contacting the sugar hydrolyzate with a first nanofiltration membrane to produce a C6 enriched retentate and a C5 enriched filtrate, wherein the contacting is diafiltration wherein water is added to the sugar hydrolyzate during the contacting.

The methods of the first aspect can further comprise contacting the sugar hydrolyzate with an ultrafiltration membrane to remove color molecules and suspended solids. In some embodiments, the sugar hydrolyzate is contacted with the ultrafiltration membrane prior to the nanofiltration membrane.

The methods of the first aspect can further comprise contacting the sugar hydrolyzate with a second nanofiltration membrane to remove one or more inhibitors. In some embodiments, the one or more inhibitors are removed prior to producing the C6 enriched retentate and the C5 enriched retentate. In some embodiments, the one or more inhibitors are removed after removal of color molecules and suspended solids with an ultrafiltration membrane. In some embodiments, the one or more inhibitors are removed after removal of color molecules and suspended solids with an ultrafiltration membrane and prior to producing the C6 enriched retentate and the C5 enriched retentate with the first nanofiltration membrane.

The methods of the first aspect can further comprise contacting the C6 enriched retentate and/or the C5 enriched retentate with a reverse osmosis membrane to concentrate the sugars and/or recover water.

In some embodiments of the first aspect, the C6 enriched retentate comprises a C6 sugar content that is at least about a 1.1 times higher than the sugar hydrolyzate, based on total sugar content. For example, the C6 enriched retentate can comprise a C6 sugar content that is at least about: 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 3.5, 4, 4.5, 5, 6, 7, 8, 9, or 10 times higher that the sugar hydrolyzate based on total sugar content. In some embodiments, the C6 enriched retentate comprises a C6 sugar content that is at least about a 1.5 times higher than the sugar hydrolyzate, based on total sugar content. In some embodiments, the C6 enriched retentate comprises a C6 sugar content that is at least about a 2 times higher than the sugar hydrolyzate, based on total sugar content.

In some embodiments of the first aspect, the C5 enriched filtrate comprises a C5 sugar content that is at least about a 1.1 times higher than the sugar hydrolyzate, based on total sugar content. For example, the C5 enriched filtrate can comprise a C5 sugar content that is at least about: 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 3.5, 4, 4.5, 5, 6, 7, 8, 9, or 10 times higher that the sugar hydrolyzate based on total sugar content. In some embodiments, the C5 enriched filtrate comprises a C5 sugar content that is at least about a 1.5 times higher than the sugar hydrolyzate, based on total sugar content. In some embodiments, the C5 enriched filtrate comprises a C5 sugar content that is at least about a 2 times higher than the sugar hydrolyzate, based on total sugar content.

In some embodiments of the first aspect, the C6 enriched retentate has a transparency that is at least about 2 fold higher than the sugar hydrolyzate when measured at 600 nm. For example, the C6 enriched retentate can have a transparency that is at least: 2, 3, 4, 5, 6, 7, 8, 9, 10, 11, 12, 13, 14, 15, 16, 17, 18, 19, 20, 25, 30, 35, 40, 45, or 50 fold higher than the sugar hydrolyzate when measured at 600 nm. In some embodiments, the C6 enriched retentate has a transparency that is at least about 5 fold higher than the sugar hydrolyzate when measured at 600 nm. In some embodiments, the C6 enriched retentate has a transparency that is at least about 10 fold higher than the sugar hydrolyzate when measured at 600 nm.

In some embodiments of the first aspect, the C6 enriched retentate has a transparency that is at least about 10% higher than the sugar hydrolyzate when measured at 600 nm. For example, the C6 enriched retentate can have a transparency that is at least about: 10%, 15%, 20%, 25%, 30%, 35%, 40%, 45%, 50%, 60%, 70%, 80%, 90%, or 95% higher than the sugar hydrolyzate. If the sugar hydrolyzate has a transparency of 2% and the C6 enriched retentate has a transparency of 12%, that would be a 10% increase in transparency. Transparency can also be termed % transmittance. In some embodiments, the C6 enriched retentate has a transparency that is at least about 25% higher than the sugar hydrolyzate when measured at 600 nm. In some embodiments, the C6 enriched retentate has a transparency that is at least about 50% higher than the sugar hydrolyzate when measured at 600 nm.

In some embodiments of the first aspect, the C6 enriched retentate comprises an amount of one or more inhibitors that is, individually, at least about 10% lower than in the sugar hydrolyzate by weight. For example, the C6 enriched retentate can comprise an amount of one or more inhibitors that is, individually, at least about: 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99%, or 100% low that in the sugar hydrolysate by weight. In some embodiments, the C6 enriched retentate comprises an amount of one or more inhibitors that is, individually, at least about 50% lower than in the sugar hydrolyzate by weight. In some embodiments, the C6 enriched retentate comprises an amount of one or more inhibitors that is, individually, at least about 75% lower than in the sugar hydrolyzate by weight. In some embodiments, the C6 enriched retentate comprises an amount of one or more inhibitors that is, individually, from 10% to about 100% lower than in the sugar hydrolyzate by weight. In some embodiments, the one or more inhibitors comprise furfural, hydroxymethylfurfural, acetic acid, formic acid, or a combination thereof.

In some embodiments of the first aspect, the first nanofiltration membrane is a NF99, NF99HF, NF-45, NF-90, NF-200, NF-400, SU-210, SU-220, SU-600, SU-610, NF9790, or NF 9940 membrane. In some embodiments, the first nanofiltration membrane is a NF9790 membrane. In some embodiments, the first nanofiltration membrane is a NF9940 membrane.

In some embodiments of the first aspect, the first nanofiltration membrane is a spiral wound nanofiltration membrane. In some embodiments, the first nanofiltration membrane is a tubular nanofiltration membrane. In some embodiments, the first nanofiltration membrane is a hollow fiber nanofiltration membrane.

In some embodiments of the first aspect, the first nanofiltration membrane has a pore size of about 1 nm to about 2 nm. For example, the first nanofiltration membrane can have a pore size of about: 1 nm, 1.1 nm, 1.2 nm, 1.3 nm, 1.4 nm, 1.5 nm, 1.6 nm, 1.7 nm, 1.8 nm, 1.9 nm, or 2 nm.

In some embodiments, the first nanofiltration membrane has a molecular weight cutoff of about 0.1 kDa to about 5 kDa. For example, the first nanofiltration membrane can have a molecular weight cutoff of about: 0.1-5 kDa, 0.1-4 kDa, 0.1-3 kDa, 0.1-2 kDa, 0.1-1 kDa, 0.1-0.5 kDa, 0.1-0.25 kDa, 0.25-5 kDa, 0.25-4 kDa, 0.25-3 kDa, 0.25-2 kDa, 0.25-1 kDa, 0.25-0.5 kDa, 0.5-5 kDa, 0.5-4 kDa, 0.5-3 kDa, 0.5-2 kDa, 0.5-1 kDa, 1-5 kDa, 1-4 kDa, 1-3 kDa, 1-2 kDa, 2-5 kDa, 2-4 kDa, 2-3 kDa, 3-5 kDa, 3-4 kDa, 4-5 kDa, 0.1 kDa, 0.15 kDa, 0.2 kDa, 0.25 kDa, 0.3 kDa, 0.35 kDa, 0.4 kDa, 0.45 kDa, 0.5 kDa, 0.6 kDa, 0.7 kDa, 0.8 kDa, 0.9 kDa, 1 kDa, 1.1 kDa, 1.2 kDa, 1.3 kDa, 1.4 kDa, 1.5 kDa, 1.6 kDa, 1.7 kDa, 1.8 kDa, 1.9 kDa, 2 kDa, 2.25 kDa, 2.5 kDa, 2.75 kDa, 3 kDa, 3.25 kDa, 3.5 kDa, 3.75 kDa, 4 kDa, 4.25 kDa, 4.5 kDa, 4.75 kDa, or 5 kDa.

In some embodiments of the first aspect, the first nanofiltration membrane has a MgSO₄ rejection of at least about 80%. For example, the first nanofiltration membrane can have a MgSO₄ rejection of at least about 80%, 81%, 82%, 83%, 84%, 85%, 86%, 97%, 88%, 89%, 90%, 91%, 92%, 93%, 94%, 95%, 96%, 97%, 98%, or 99%. In some embodiments, the first nanofiltration membrane has a MgSO₄ rejection of about 80% to about 99%. For example, the first nanofiltration membrane can have a MgSO₄ rejection of about: 80-99%, 80-97%, 80-95%, 80-90%, 80-85%, 85-99%, 85-97%, 85-95%, 85-90%, 90-99%, 90-97%, 90-95%, 95-99%, 95-97%, 97-99%, 80%, 81%, 82%, 83%, 84%, 85%, 86%, 87%, 88%, 89%, 90%, 91%, 92%, 93%, 94%, 95%, 96%, 97%, 98%, or 99%. In some embodiments, the first nanofiltration membrane has a MgSO₄ rejection of about 99%. In some embodiments, the first nanofiltration membrane has a MgSO₄ rejection of about 97%.

In some embodiments of the first aspect, the first nanofiltration membrane has a NaCl rejection of at least about 30%. For example, the first nanofiltration membrane can have a NaCl rejection of at least about: 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the first nanofiltration membrane has a NaCl rejection of about 30% to 99%. For example, the first nanofiltration membrane can have a NaCl rejection of about: 30-99%, 30-95%, 30-90%, 30-80%, 30-70%, 30-60%, 30-50%, 30-40%, 40-99%, 40-95%, 40-90%, 40-80%, 40-70%, 40-60%, 40-50%, 50-99%, 50-95%, 50-90%, 50-80%, 50-70%, 50-60%, 60-99%, 60-95%, 60-90%, 60-80%, 60-70%, 70-99%, 70-95%, 70-90%, 70-80%, 80-99%, 80-95%, 80-90%, 90-99%, 90-95%, 95-99%, 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the first nanofiltration membrane has a NaCl rejection of about 40%. In some embodiments, the first nanofiltration membrane has a NaCl rejection of about 90%.

In some embodiments of the first aspect, the second nanofiltration membrane is a NF99, NF99HF, NF-45, NF-90, NF-200, NF-400, SU-210, SU-220, SU-600, SU-610, NF9790, or NF 9940 membrane. In some embodiments, the second nanofiltration membrane is a NF9790 membrane. In some embodiments, the second nanofiltration membrane is a NF9940 membrane.

In some embodiments of the first aspect, the second nanofiltration membrane is a spiral wound nanofiltration membrane. In some embodiments, the second nanofiltration membrane is a tubular nanofiltration membrane. In some embodiments, the second nanofiltration membrane is a hollow fiber nanofiltration membrane.

In some embodiments of the first aspect, the second nanofiltration membrane has a pore size of about 1 nm to about 2 nm. For example, the second nanofiltration membrane can have a pore size of about: 1 nm, 1.1 nm, 1.2 nm, 1.3 nm, 1.4 nm, 1.5 nm, 1.6 nm, 1.7 nm, 1.8 nm, 1.9 nm, or 2 nm.

In some embodiments of the first aspect, the second nanofiltration membrane has a molecular weight cutoff of about 0.1 kDa to about 5 kDa. For example, the second nanofiltration membrane can have a molecular weight cutoff of about: 0.1-5 kDa, 0.1-4 kDa, 0.1-3 kDa, 0.1-2 kDa, 0.1-1 kDa, 0.1-0.5 kDa, 0.1-0.25 kDa, 0.25-5 kDa, 0.25-4 kDa, 0.25-3 kDa, 0.25-2 kDa, 0.25-1 kDa, 0.25-0.5 kDa, 0.5-5 kDa, 0.5-4 kDa, 0.5-3 kDa, 0.5-2 kDa, 0.5-1 kDa, 1-5 kDa, 1-4 kDa, 1-3 kDa, 1-2 kDa, 2-5 kDa, 2-4 kDa, 2-3 kDa, 3-5 kDa, 3-4 kDa, 4-5 kDa, 0.1 kDa, 0.15 kDa, 0.2 kDa, 0.25 kDa, 0.3 kDa, 0.35 kDa, 0.4 kDa, 0.45 kDa, 0.5 kDa, 0.6 kDa, 0.7 kDa, 0.8 kDa, 0.9 kDa, 1 kDa, 1.1 kDa, 1.2 kDa, 1.3 kDa, 1.4 kDa, 1.5 kDa, 1.6 kDa, 1.7 kDa, 1.8 kDa, 1.9 kDa, 2 kDa, 2.25 kDa, 2.5 kDa, 2.75 kDa, 3 kDa, 3.25 kDa, 3.5 kDa, 3.75 kDa, 4 kDa, 4.25 kDa, 4.5 kDa, 4.75 kDa, or 5 kDa.

In some embodiments, the second nanofiltration membrane has a MgSO₄ rejection of at least about 80%. For example, the second nanofiltration membrane can have a MgSO₄ rejection of at least about 80%, 81%, 82%, 83%, 84%, 85%, 86%, 97%, 88%, 89%, 90%, 91%, 92%, 93%, 94%, 95%, 96%, 97%, 98%, or 99%. In some embodiments, the second nanofiltration membrane has a MgSO₄ rejection of about 80% to about 99%. For example, the second nanofiltration membrane can have a MgSO₄ rejection of about: 80-99%, 80-97%, 80-95%, 80-90%, 80-85%, 85-99%, 85-97%, 85-95%, 85-90%, 90-99%, 90-97%, 90-95%, 95-99%, 95-97%, 97-99%, 80%, 81%, 82%, 83%, 84%, 85%, 86%, 87%, 88%, 89%, 90%, 91%, 92%, 93%, 94%, 95%, 96%, 97%, 98%, or 99%. In some embodiments, the second nanofiltration membrane has a MgSO₄ rejection of about 99%. In some embodiments, the second nanofiltration membrane has a MgSO₄ rejection of about 97%.

In some embodiments of the first aspect, the second nanofiltration membrane has a NaCl rejection of at least about 30%. For example, the second nanofiltration membrane can have a NaCl rejection of at least about: 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the second nanofiltration membrane has a NaCl rejection of about 30% to 99%. For example, the second nanofiltration membrane can have a NaCl rejection of about: 30-99%, 30-95%, 30-90%, 30-80%, 30-70%, 30-60%, 30-50%, 30-40%, 40-99%, 40-95%, 40-90%, 40-80%, 40-70%, 40-60%, 40-50%, 50-99%, 50-95%, 50-90%, 50-80%, 50-70%, 50-60%, 60-99%, 60-95%, 60-90%, 60-80%, 60-70%, 70-99%, 70-95%, 70-90%, 70-80%, 80-99%, 80-95%, 80-90%, 90-99%, 90-95%, 95-99%, 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the second nanofiltration membrane has a NaCl rejection of about 40%. In some embodiments, the second nanofiltration membrane has a NaCl rejection of about 90%.

In some embodiments of the first aspect, the ultrafiltration membrane is an ES404 membrane.

In some embodiments of the first aspect, the ultrafiltration membrane has a pore size of about 2 nm to about 100 nm. For example, the ultrafiltration membrane can have a pore size of about: 2-100 nm, 2-75 nm, 2-50 nm, 2-25 nm, 2-10 nm, 2-5 nm, 5-100 nm, 5-75 nm, 5-50 nm, 5-25 nm, 5-10 nm, 10-100 nm, 10-75 nm, 10-50 nm, 10-25 nm, 25-100 nm, 25-75 nm, 25-50 nm, 50-100 nm, 50-75 nm, 75-100 nm, 2 nm, 3 nm, 4 nm, 5 nm, 6 nm, 7 nm, 8 nm, 9 nm, 10 nm, 12.5 nm, 15 nm, 17.5 nm, 20 nm, 22.5 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, or 100 nm.

In some embodiments of the first aspect, the ultrafiltration membrane has a molecular weight cutoff of from about 5 kDa to about 5000 kDa. For example, the ultrafiltration membrane can have a molecular weight cutoff of about: 5-5000 kDa, 5-4000 kDa, 5-3000 kDa, 5-2000 kDa, 5-1000 kDa, 5-500 kDa, 5-250 kDa, 5-100 kDa, 5-50 kDa, 5-25 kDa, 5-10 kDa, 10-5000 kDa, 10-4000 kDa, 10-3000 kDa, 10-2000 kDa, 10-1000 kDa, 10-500 kDa, 10-250 kDa, 10-100 kDa, 10-50 kDa, 10-25 kDa, 25-5000 kDa, 25-4000 kDa, 25-3000 kDa, 25-2000 kDa, 25-1000 kDa, 25-500 kDa, 25-250 kDa, 25-100 kDa, 25-50 kDa, 50-5000 kDa, 50-4000 kDa, 50-3000 kDa, 50-2000 kDa, 50-1000 kDa, 50-500 kDa, 50-250 kDa, 50-100 kDa, 100-5000 kDa, 100-4000 kDa, 100-3000 kDa, 100-2000 kDa, 100-1000 kDa, 100-500 kDa, 100-250 kDa, 250-5000 kDa, 250-4000 kDa, 250-3000 kDa, 250-2000 kDa, 250-1000 kDa, 250-500 kDa, 500-5000 kDa, 500-4000 kDa, 500-3000 kDa, 500-2000 kDa, 500-1000 kDa, 1000-5000 kDa, 1000-4000 kDa, 1000-3000 kDa, 1000-2000 kDa, 2000-5000 kDa, 2000-4000 kDa, 2000-3000 kDa, 3000-5000 kDa, 3000-4000 kDa, 4000-5000 kDa, 5 kDa, 6 kDa, 7 kDa, 8 kDa, 9 kDa, 10 kDa, 11 kDa, 12 kDa, 13 kDa, 14 kDa, 15 kDa, 17.5 kDa, 20 kDa, 22.5 kDa, 25 kDa, 30 kDa, 35 kDa, 40 kDa, 45 kDa, 50 kDa, 60 kDa, 70 kDa, 80 kDa, 90 kDa, 100 kDa, 125 kDa, 150 kDa, 175 kDa, 200 kDa, 225 kDa, 250 kDa, 275 kDa, 300 kDa, 325 kDa, 350 kDa, 375 kDa, 400 kDa, 425 kDa, 450 kDa, 475 kDa, 500 kDa, 600 kDa, 700 kDa, 800 kDa, 900 kDa, 1000 kDa, 1250 kDa, 1500 kDa, 1750 kDa, 2000 kDa, 2250 kDa, 2500 kDa, 2750 kDa, 3000 kDa, 3250 kDa, 3500 kDa, 3750 kDa, 4000 kDa, 4250 kDa, 4500 kDa, 4750 kDa, or 5000 kDa. In some embodiments, the ultrafiltration membrane has a molecular weight cutoff of about 4000 kDa.

In some embodiments of the first aspect, contacting the sugar hydrolysate and the first nanofiltration membrane is performed in a cross-flow configuration. In some embodiments, contacting the sugar hydrolysate and the first nanofiltration membrane is performed in a dead-end configuration.

In some embodiments of the first aspect, contacting the sugar hydrolysate and the ultrafiltration membrane is performed in a cross-flow configuration. In some embodiments, contacting the sugar hydrolysate and the ultrafiltration membrane is performed in a dead-end configuration.

In some embodiments of the first aspect, contacting the sugar hydrolysate and the second nanofiltration membrane is performed in a cross-flow configuration. In some embodiments, contacting the sugar hydrolysate and the second nanofiltration membrane is performed in a dead-end configuration.

In some embodiments of the first aspect, contacting the sugar hydrolyzate with the first nanofiltration membrane, the second nanofiltration membrane, or the ultrafiltration membrane is performed at a pressure of about 10 psi to about 1000 psi. For example, contacting the sugar hydrolyzate with the first nanofiltration membrane, the second nanofiltration membrane, or the ultrafiltration membrane can be performed at a pressure of about: 10-1000 psi, 10-750 psi, 10-600 psi, 10-500 psi, 10-400 psi, 10-250 psi, 10-100 psi, 10-50 psi, 50-1000 psi, 50-750 psi, 50-600 psi, 50-500 psi, 50-400 psi, 50-250 psi, 50-100 psi, 100-1000 psi, 100-750 psi, 100-600 psi, 100-500 psi, 100-400 psi, 100-250 psi, 250-1000 psi, 250-750 psi, 250-600 psi, 250-500 psi, 250-400 psi, 400-1000 psi, 400-750 psi, 400-600 psi, 400-500 psi, 500-1000 psi, 500-750 psi, 500-600 psi, 600-1000 psi, 600-750 psi, 750-1000 psi, 10 psi, 20 psi, 30 psi, 40 psi, 50 psi, 60 psi, 70 psi, 80 psi, 90 psi, 100 psi, 125 psi, 150 psi, 175 psi, 200 psi, 225 psi, 250 psi, 275 psi, 300 psi, 325 psi, 350 psi, 375 psi, 400 psi, 425 psi, 450 psi, 475 psi, 500 psi, 525 psi, 550 psi, 575 psi, 600 psi, 625 psi, 650 psi, 675 psi, 700 psi, 750 psi, 800 psi, 850 psi, 900 psi, 950 psi, or 1000 psi. In some embodiments, contacting the sugar hydrolyzate with the first nanofiltration membrane, the second nanofiltration membrane, or the ultrafiltration membrane is performed at a pressure of about 100 psi to about 900 psi. In some embodiments, contacting the sugar hydrolyzate with the first nanofiltration membrane, the second nanofiltration membrane, or the ultrafiltration membrane is performed at a pressure of about 250 psi to about 750 psi. In some embodiments, contacting the sugar hydrolyzate with the first nanofiltration membrane, the second nanofiltration membrane, or the ultrafiltration membrane is performed at a pressure of about 500 psi to about 600 psi.

In some embodiments of the first aspect, the sugar hydrolyzate is at a temperature of about 20° C. to about 80° C. For example, the sugar hydrolyzate can be at a temperature of about: 20-80° C., 20-70° C., 20-60° C., 20-50° C., 20-40° C., 20-30° C., 30-80° C., 30-70° C., 30-60° C., 30-50° C., 30-40° C., 40-80° C., 40-70° C., 40-60° C., 40-50° C., 50-80° C., 50-70° C., 50-60° C., 60-80° C., 60-70° C., 70-80° C., 20° C., 25° C., 30° C., 35° C., 40° C., 45° C., 50° C., 55° C., 60° C., 65° C., 70° C., 75° C., or 80° C.

In some embodiments of the first aspect, the sugar hydrolyzate is at a pH of from about 1 to about 14. For example, the sugar hydrolyzate can have a pH of about: 1-14, 1-11, 1-9, 1-7, 1-6, 1-4, 1-2, 2-14, 2-11, 2-9, 2-7, 2-6, 2-4, 4-14, 4-11, 4-9, 4-7, 4-6, 6-14, 6-11, 6-9, 6-7, 7-14, 7-11, 7-9, 9-14, 9-11, 11-14, 1, 2, 3, 4, 5, 6, 7, 8, 9, 10, 11, 12, 13, or 14. In some embodiments, the sugar hydrolyzate is at a pH of from about 3 to about 11. In some embodiments, the sugar hydrolyzate is at a pH of from about 4 to about 9.

In some embodiments of the first aspect, the water is added in an amount of from about 0.1 to about 10 diafiltration volumes. For example, the water can be added in an amount of about: 0.1-10, 0.1-7, 0.1-5, 0.1-3, 0.1-2, 0.1-1, 0.1-0.5, 0.5-10, 0.5-7, 0.5-5, 0.5-3, 0.5-2, 0.5-1, 1-10, 1-7, 1-5, 1-3, 1-2, 2-10, 2-7, 2-5, 2-3, 3-10, 3-7, 3-5, 5-10, 5-7, 7-10, 0.1, 0.2, 0.3, 0.4, 0.5, 0.6, 0.7, 0.8, 0.9, 1, 1.25, 1.5, 1.75, 2, 2.25, 2.5, 2.75, 3, 3.25, 3.5, 3.75, 4, 4.25, 4.5, 4.75, 5, 5.5, 6, 6.5, 7, 7.5, 8, 8.5, 9, 9.5, or 10 diafiltration volumes. In some embodiments, the water is added in an amount of from about 0.25 to about 6 diafiltration volumes. In some embodiments, the water is added in an amount of from about 0.1 to about 1 diafiltration volumes. In some embodiments, the water is added in an amount of from about 0.1 to about 0.5 diafiltration volumes.

In some embodiments of the first aspect, the water is added continuously.

In some embodiments of the first aspect, the water is added one or more times during contacting. In some embodiments, the water is added when a retentate volume reaches from 10% to about 75% of a starting volume of the sugar hydrolyzate. For example, the water can be added when the retentate volume reaches about: 10-75%, 10-50%, 10-25%, 10-15%, 15-75%, 15-50%, 15-25%, 25-75%, 25-50%, 50-75%, 10%, 15%, 20%, 25%, 30%, 35%, 40%, 45%, 50%, 55%, 60%, 65%, 70%, or 75% of the starting volume of the sugar hydrolyzate. In some embodiments, the water is added when a retentate volume reaches from 15% to about 50% of a starting volume of the sugar hydrolyzate. In some embodiments, the water is added when a retentate volume reaches about 25% of a starting volume of the sugar hydrolyzate.

In some embodiments of the first aspect, the C6 sugars comprise glucose. In some embodiments, the C5 sugars comprise xylose, arabinose, or a combination thereof.

In some embodiments of the first aspect, the sugar hydrolyzate comprises from about 1% to about 90% sugars by weight. For example, the sugar hydrolyzate can comprise about: 1-90%, 1-75%, 1-50%, 1-35%, 1-25%, 1-20%, 1-15%, 1-10%, 1-5%, 5-90%, 5-75%, 5-50%, 5-35%, 5-25%, 5-20%, 5-15%, 5-10%, 10-90%, 10-75%, 10-50%, 10-35%, 10-25%, 10-20%, 10-15%, 15-90%, 15-75%, 15-50%, 15-35%, 15-25%, 15-20%, 20-90%, 20-75%, 20-50%, 20-35%, 20-25%, 25-90%, 25-75%, 25-50%, 25-35%, 35-90%, 35-75%, 35-50%, 50-90%, 50-75%, or 75-90% sugars by weight. In some embodiments, the sugar hydrolyzate comprises from about 1% to about 50% sugars by weight. In some embodiments, the sugar hydrolyzate comprises from about 1% to about 35% sugars by weight. In some embodiments, the sugar hydrolyzate comprises from about 5% to about 50% sugars by weight.

In some embodiments of the first aspect, the sugar hydrolyzate comprises the C5 sugars and the C6 sugars in a 5:95% ratio to a 95:5% ratio by weight. For example, the sugar hydrolyzate can comprise the C5 sugars and the C6 sugars in about: a 5:95% ratio to a 95:5% ratio, a 5:95% ratio to a 80:20% ratio, a 5:95% ratio to a 60:40% ratio, a 5:95% ratio to a 50:50% ratio, a 5:95% ratio to a 40:60% ratio, a 5:95% ratio to a 20:80% ratio, a 20:80% ratio to a 95:5% ratio, a 20:80% ratio to a 80:20% ratio, a 20:80% ratio to a 60:40% ratio, a 20:80% ratio to a 50:50% ratio, a 20:80% ratio to a 40:60% ratio, a 40:60% ratio to a 95:5% ratio, a 40:60% ratio to a 80:20% ratio, a 40:60% ratio to a 60:40% ratio, a 40:60% ratio to a 50:50% ratio, a 50:50% ratio to a 95:5% ratio, a 50:50% ratio to a 80:20% ratio, a 50:50% ratio to a 60:40% ratio, a 60:40% ratio to a 95:5% ratio, a 60:40% ratio to a 80:20% ratio, or a 80:20% ratio to a 95:5% ratio by weight. In some embodiments, the sugar hydrolyzate comprises the C5 sugars and the C6 sugars in a 25:75% ratio to a 75:25% ratio by weight.

In some embodiments of the first aspect, pretreating or hydrolyzing the biomass comprises mechanical size reduction, hot water treatment, acid treatment, base treatment, steam explosion, acid-catalyzed steam explosion, ammonia fiber/freeze explosion, enzymatic hydrolysis, or a combination thereof.

In some embodiments of the first aspect, pretreating or hydrolyzing the biomass comprises mechanical size reduction, acid treatment and enzymatic hydrolysis.

In some embodiments of the first aspect, the sugar hydrolysate was produced by: (1) hydrating the biomass in an acidic medium; (2) mechanical size reduction of the biomass; (3) heating the biomass; and (4) enzymatically hydrolyzing the biomass.

In some embodiments of the first aspect, the sugar hydrolysate was produced by: (1) pretreating the biomass comprising lignocellulosic material with hot water or an acid to solubilize hemicellulose in the biomass, (2) substantially separating solubilized hemicellulose from remaining lignocellulosic solids, and (3) enzymatically hydrolyzing cellulose in the remaining lignocellulosic solids.

In some embodiments of the first aspect, the sugar hydrolysate was produced by: (a) pretreating a biomass comprising cellulosic, hemicellulosic, or lignocellulosic material to produce a pretreated biomass comprising solid particles, wherein at least 50% of the solid particles have a size of less than 1.5 mm, and optionally a yield of C5 monomers and/or dimers that is at least 50% of a theoretical maximum, wherein pretreating comprises: (i) hydration of the biomass in an aqueous medium to produce a hydrated biomass, (ii) mechanical size reduction of the hydrated biomass to produce the solid particles, and (iii) heating the hydrated biomass for a time sufficient to produce the pretreated biomass comprising the optional yield of C5 monosaccharides and/or disaccharides; and (b) hydrolyzing the pretreated biomass composition with one or more enzymes for a time sufficient to produce the sugar hydrolyzate. In some embodiments, the aqueous medium comprises and acid. In some embodiments, the acid is sulfuric acid, peroxyacetic acid, lactic acid, formic acid, acetic acid, citric acid, phosphoric acid, hydrochloric acid, sulfurous acid, chloroacetic acid, dichloroacetic acid, trichloroacetic acid, trifluoroacetic acid, oxalic acid, benzoic acid, or a combination thereof.

In a second aspect, disclosed are methods of refining a sugar hydrolyzate comprising C5 sugars and C6 sugars produced by pretreating or hydrolyzing of a biomass comprising cellulosic, hemicellulosic, or lignocellulosic material, the methods comprising: (a) contacting the sugar hydrolyzate with a microfiltration or ultrafiltration membrane to remove color molecules and suspended solids; (b) contacting the sugar hydrolyzate with a first nanofiltration membrane to remove one or more inhibitors; (c) contacting the sugar hydrolyzate with a second nanofiltration membrane to produce a C6 enriched retentate and a C5 enriched filtrate.

In some embodiments of the second aspect, the contacting the sugar hydrolyzate with the first nanofiltration membrane is diafiltration wherein water is added to the sugar hydrolyzate during the contacting.

In some embodiments of the second aspect, the contacting the sugar hydrolyzate with the second nanofiltration membrane is diafiltration wherein water is added to the sugar hydrolyzate during the contacting.

In some embodiments of the second aspect, the contacting the sugar hydrolyzate with the microfiltration or ultrafiltration membrane is diafiltration wherein water is added to the sugar hydrolyzate during the contacting.

In a third aspect, disclosed are methods of refining a sugar hydrolyzate comprising C5 sugars and C6 sugars produced by the pretreatment or hydrolysis of lignocellulosic material, the methods comprising: (a) contacting the sugar hydrolyzate with a microfiltration or ultrafiltration membrane to produce a retentate comprising color molecules and suspended solids and a filtrate comprising C5 sugars and C6 sugars; (b) contacting the filtrate comprising C5 sugars and C6 sugars with a first nanofiltration membrane to produce a nanofiltration retentate comprising C5 and C6 sugars and a nanofiltration filtrate comprising one or more inhibitors; (c) contacting the nanofiltration retentate comprising C5 and C6 sugars with a second nanofiltration membrane to produce a C6 enriched retentate and a C5 enriched filtrate.

In some embodiments of the third aspect, contacting the filtrate comprising C5 sugars and C6 sugars with the first nanofiltration membrane is diafiltration wherein water is added to the filtrate comprising C5 sugars and C6 sugars during the contacting.

In some embodiments of the third aspect, contacting the nanofiltration retentate comprising C5 and C6 sugars with the second nanofiltration membrane is diafiltration wherein water is added to the nanofiltration retentate comprising C5 and C6 sugars during the contacting.

In some embodiments of the third aspect, contacting the sugar hydrolyzate with the microfiltration or ultrafiltration membrane is diafiltration wherein water is added to the sugar hydrolyzate during the contacting.

The methods of the second or third aspect can further comprise contacting the nanofiltration filtrate with a reverse osmosis membrane to recover water.

In a fourth aspect, disclosed are methods of producing sugars, the methods comprising: (a) pretreating a biomass composition comprising lignocellulosic material, wherein pretreating comprises: (i) hydration of the biomass composition in an aqueous medium, (ii) mechanical size reduction of the biomass composition to produce a mixture of solid particles wherein at least 50% of the solid particles have a size of less than 1.5 mm, and (iii) heating the biomass composition; (b) hydrolyzing the biomass composition with one or more enzymes to produce a sugar hydrolyzate comprising C5 sugars and C6 sugars; and (c) contacting the sugar hydrolyzate with a first nanofiltration membrane to produce a C6 enriched retentate and a C5 enriched filtrate.

In some embodiments of the fourth aspect, the contacting is diafiltration wherein water is added to the sugar hydrolyzate during the contacting.

The methods of the fourth aspect can further comprise contacting the sugar hydrolyzate with an ultrafiltration membrane to remove color molecules and suspended solids. In some embodiments, the sugar hydrolyzate is contacted with the ultrafiltration membrane prior to the nanofiltration membrane.

The methods of the fourth aspect can further comprise contacting the sugar hydrolyzate with a second nanofiltration membrane to remove one or more inhibitors. In some embodiments, the one or more inhibitors are removed prior to producing the C6 enriched retentate and the C5 enriched retentate. In some embodiments, the one or more inhibitors are removed after removal of color molecules and suspended solids with an ultrafiltration membrane. In some embodiments, the one or more inhibitors are removed after removal of color molecules and suspended solids with an ultrafiltration membrane and prior to producing the C6 enriched retentate and the C5 enriched retentate with the first nanofiltration membrane.

In some embodiments of the fourth aspect, contacting the sugar hydrolyzate with the nanofiltration membrane is diafiltration wherein water is added to the sugar hydrolyzate during the contacting.

In some embodiments of the fourth aspect, contacting the sugar hydrolyzate with the second nanofiltration membrane is diafiltration wherein water is added to the sugar hydrolyzate during the contacting.

In some embodiments of the fourth aspect, contacting the sugar hydrolyzate with the ultrafiltration membrane is diafiltration wherein water is added to the sugar hydrolyzate during the contacting.

The methods of the second, third, or fourth aspects can further comprise contacting the C6 enriched retentate or the C5 enriched retentate with a reverse osmosis membrane to concentrate the sugars.

In some embodiments of the second, third, or fourth aspects, the C6 enriched retentate comprises a C6 sugar content that is at least about a 1.1 times higher than the sugar hydrolyzate, based on total sugar content. For example, the C6 enriched retentate can comprise a C6 sugar content that is at least about: 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 3.5, 4, 4.5, 5, 6, 7, 8, 9, or 10 times higher that the sugar hydrolyzate based on total sugar content. In some embodiments, the C6 enriched retentate comprises a C6 sugar content that is at least about a 1.5 times higher than the sugar hydrolyzate, based on total sugar content. In some embodiments, the C6 enriched retentate comprises a C6 sugar content that is at least about a 2 times higher than the sugar hydrolyzate, based on total sugar content.

In some embodiments of the second, third, or fourth aspects, the C5 enriched filtrate comprises a C5 sugar content that is at least about a 1.1 times higher than the sugar hydrolyzate, based on total sugar content. For example, the C5 enriched filtrate can comprise a C5 sugar content that is at least about: 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 3.5, 4, 4.5, 5, 6, 7, 8, 9, or 10 times higher that the sugar hydrolyzate based on total sugar content. In some embodiments, the C5 enriched filtrate comprises a C5 sugar content that is at least about a 1.5 times higher than the sugar hydrolyzate, based on total sugar content. In some embodiments, the C5 enriched filtrate comprises a C5 sugar content that is at least about a 2 times higher than the sugar hydrolyzate, based on total sugar content.

In some embodiments of the second, third, or fourth aspects, the C6 enriched retentate has a transparency that is at least about 2 fold higher than the sugar hydrolyzate when measured at 600 nm. For example, the C6 enriched retentate can have a transparency that is at least: 2, 3, 4, 5, 6, 7, 8, 9, 10, 11, 12, 13, 14, 15, 16, 17, 18, 19, 20, 25, 30, 35, 40, 45, or 50 fold higher than the sugar hydrolyzate when measured at 600 nm. In some embodiments, the C6 enriched retentate has a transparency that is at least about 5 fold higher than the sugar hydrolyzate when measured at 600 nm. In some embodiments, the C6 enriched retentate has a transparency that is at least about 10 fold higher than the sugar hydrolyzate when measured at 600 nm.

In some embodiments of the second, third, or fourth aspects, the C6 enriched retentate has a transparency that is at least about 10% higher than the sugar hydrolyzate when measured at 600 nm. For example, the C6 enriched retentate can have a transparency that is at least about: 10%, 15%, 20%, 25%, 30%, 35%, 40%, 45%, 50%, 60%, 70%, 80%, 90%, or 95% higher than the sugar hydrolyzate. If the sugar hydrolyzate has a transparency of 2% and the C6 enriched retentate has a transparency of 12%, that would be a 10% increase in transparency. Transparency can also be termed % transmittance. In some embodiments, the C6 enriched retentate has a transparency that is at least about 25% higher than the sugar hydrolyzate when measured at 600 nm. In some embodiments, the C6 enriched retentate has a transparency that is at least about 50% higher than the sugar hydrolyzate when measured at 600 nm.

In some embodiments of the second, third, or fourth aspects, the C6 enriched retentate comprises an amount of one or more inhibitors that is, individually, at least about 10% lower than in the sugar hydrolyzate by weight. For example, the c6 enriched retentate can comprise an amount of one or more inhibitors that is, individually, at least about: 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99%, or 100% low that in the sugar hydrolysate by weight. In some embodiments, the C6 enriched retentate comprises an amount of one or more inhibitors that is, individually, at least about 50% lower than in the sugar hydrolyzate by weight. In some embodiments, the C6 enriched retentate comprises an amount of one or more inhibitors that is, individually, at least about 75% lower than in the sugar hydrolyzate by weight. In some embodiments, the C6 enriched retentate comprises an amount of one or more inhibitors that is, individually, from 10% to about 100% lower than in the sugar hydrolyzate by weight. In some embodiments, the one or more inhibitors comprise furfural, hydroxymethylfurfural, acetic acid, formic acid, or a combination thereof.

In some embodiments of the second, third, or fourth aspects, the first nanofiltration membrane is a NF99, NF99HF, NF-45, NF-90, NF-200, NF-400, SU-210, SU-220, SU-600, SU-610, NF9790, or NF 9940 membrane. In some embodiments, the first nanofiltration membrane is a NF9790 membrane. In some embodiments, the first nanofiltration membrane is a NF9940 membrane.

In some embodiments of the second, third, or fourth aspects, the first nanofiltration membrane is a spiral wound nanofiltration membrane. In some embodiments, the first nanofiltration membrane is a tubular nanofiltration membrane. In some embodiments, the first nanofiltration membrane is a hollow fiber nanofiltration membrane.

In some embodiments of the second, third, or fourth aspects, the first nanofiltration membrane has a pore size of about 1 nm to about 2 nm. For example, the first nanofiltration membrane can have a pore size of about: 1 nm, 1.1 nm, 1.2 nm, 1.3 nm, 1.4 nm, 1.5 nm, 1.6 nm, 1.7 nm, 1.8 nm, 1.9 nm, or 2 nm.

In some embodiments of the second, third, or fourth aspects, the first nanofiltration membrane has a molecular weight cutoff of about 0.1 kDa to about 5 kDa. For example, the first nanofiltration membrane can have a molecular weight cutoff of about: 0.1-5 kDa, 0.1-4 kDa, 0.1-3 kDa, 0.1-2 kDa, 0.1-1 kDa, 0.1-0.5 kDa, 0.1-0.25 kDa, 0.25-5 kDa, 0.25-4 kDa, 0.25-3 kDa, 0.25-2 kDa, 0.25-1 kDa, 0.25-0.5 kDa, 0.5-5 kDa, 0.5-4 kDa, 0.5-3 kDa, 0.5-2 kDa, 0.5-1 kDa, 1-5 kDa, 1-4 kDa, 1-3 kDa, 1-2 kDa, 2-5 kDa, 2-4 kDa, 2-3 kDa, 3-5 kDa, 3-4 kDa, 4-5 kDa, 0.1 kDa, 0.15 kDa, 0.2 kDa, 0.25 kDa, 0.3 kDa, 0.35 kDa, 0.4 kDa, 0.45 kDa, 0.5 kDa, 0.6 kDa, 0.7 kDa, 0.8 kDa, 0.9 kDa, 1 kDa, 1.1 kDa, 1.2 kDa, 1.3 kDa, 1.4 kDa, 1.5 kDa, 1.6 kDa, 1.7 kDa, 1.8 kDa, 1.9 kDa, 2 kDa, 2.25 kDa, 2.5 kDa, 2.75 kDa, 3 kDa, 3.25 kDa, 3.5 kDa, 3.75 kDa, 4 kDa, 4.25 kDa, 4.5 kDa, 4.75 kDa, or 5 kDa.

In some embodiments of the second, third, or fourth aspects, the first nanofiltration membrane has a MgSO₄ rejection of at least about 80%. For example, the first nanofiltration membrane can have a MgSO₄ rejection of at least about 80%, 81%, 82%, 83%, 84%, 85%, 86%, 97%, 88%, 89%, 90%, 91%, 92%, 93%, 94%, 95%, 96%, 97%, 98%, or 99%. In some embodiments, the first nanofiltration membrane has a MgSO₄ rejection of about 80% to about 99%. For example, the first nanofiltration membrane can have a MgSO₄ rejection of about: 80-99%, 80-97%, 80-95%, 80-90%, 80-85%, 85-99%, 85-97%, 85-95%, 85-90%, 90-99%, 90-97%, 90-95%, 95-99%, 95-97%, 97-99%, 80%, 81%, 82%, 83%, 84%, 85%, 86%, 87%, 88%, 89%, 90%, 91%, 92%, 93%, 94%, 95%, 96%, 97%, 98%, or 99%. In some embodiments, the first nanofiltration membrane has a MgSO₄ rejection of about 99%. In some embodiments, the first nanofiltration membrane has a MgSO₄ rejection of about 97%.

In some embodiments of the second, third, or fourth aspects, the first nanofiltration membrane has a NaCl rejection of at least about 30%. For example, the first nanofiltration membrane can have a NaCl rejection of at least about: 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the first nanofiltration membrane has a NaCl rejection of about 30% to 99%. For example, the first nanofiltration membrane can have a NaCl rejection of about: 30-99%, 30-95%, 30-90%, 30-80%, 30-70%, 30-60%, 30-50%, 30-40%, 40-99%, 40-95%, 40-90%, 40-80%, 40-70%, 40-60%, 40-50%, 50-99%, 50-95%, 50-90%, 50-80%, 50-70%, 50-60%, 60-99%, 60-95%, 60-90%, 60-80%, 60-70%, 70-99%, 70-95%, 70-90%, 70-80%, 80-99%, 80-95%, 80-90%, 90-99%, 90-95%, 95-99%, 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the first nanofiltration membrane has a NaCl rejection of about 30% to 99%. In some embodiments, the first nanofiltration membrane has a NaCl rejection of about 40%. In some embodiments, the first nanofiltration membrane has a NaCl rejection of about 90%.

In some embodiments of the second, third, or fourth aspects, the second nanofiltration membrane is a NF99, NF99HF, NF-45, NF-90, NF-200, NF-400, SU-210, SU-220, SU-600, SU-610, NF9790, or NF 9940 membrane. In some embodiments, the second nanofiltration membrane is a NF9790 membrane. In some embodiments, the second nanofiltration membrane is a NF9940 membrane.

In some embodiments of the second, third, or fourth aspects, the second nanofiltration membrane is a spiral wound nanofiltration membrane. In some embodiments, the second nanofiltration membrane is a tubular nanofiltration membrane. In some embodiments, the second nanofiltration membrane is a hollow fiber nanofiltration membrane.

In some embodiments of the second, third, or fourth aspects, the second nanofiltration membrane has a pore size of about 1 nm to about 2 nm. For example, the second nanofiltration membrane can have a pore size of about: 1 nm, 1.1 nm, 1.2 nm, 1.3 nm, 1.4 nm, 1.5 nm, 1.6 nm, 1.7 nm, 1.8 nm, 1.9 nm, or 2 nm.

In some embodiments of the second, third, or fourth aspects, the second nanofiltration membrane has a molecular weight cutoff of about 0.1 kDa to about 5 kDa. For example, the second nanofiltration membrane can have a molecular weight cutoff of about: 0.1-5 kDa, 0.1-4 kDa, 0.1-3 kDa, 0.1-2 kDa, 0.1-1 kDa, 0.1-0.5 kDa, 0.1-0.25 kDa, 0.25-5 kDa, 0.25-4 kDa, 0.25-3 kDa, 0.25-2 kDa, 0.25-1 kDa, 0.25-0.5 kDa, 0.5-5 kDa, 0.5-4 kDa, 0.5-3 kDa, 0.5-2 kDa, 0.5-1 kDa, 1-5 kDa, 1-4 kDa, 1-3 kDa, 1-2 kDa, 2-5 kDa, 2-4 kDa, 2-3 kDa, 3-5 kDa, 3-4 kDa, 4-5 kDa, 0.1 kDa, 0.15 kDa, 0.2 kDa, 0.25 kDa, 0.3 kDa, 0.35 kDa, 0.4 kDa, 0.45 kDa, 0.5 kDa, 0.6 kDa, 0.7 kDa, 0.8 kDa, 0.9 kDa, 1 kDa, 1.1 kDa, 1.2 kDa, 1.3 kDa, 1.4 kDa, 1.5 kDa, 1.6 kDa, 1.7 kDa, 1.8 kDa, 1.9 kDa, 2 kDa, 2.25 kDa, 2.5 kDa, 2.75 kDa, 3 kDa, 3.25 kDa, 3.5 kDa, 3.75 kDa, 4 kDa, 4.25 kDa, 4.5 kDa, 4.75 kDa, or 5 kDa.

In some embodiments of the second, third, or fourth aspects, the second nanofiltration membrane has a MgSO₄ rejection of at least about 80%. For example, the second nanofiltration membrane can have a MgSO₄ rejection of at least about 80%, 81%, 82%, 83%, 84%, 85%, 86%, 97%, 88%, 89%, 90%, 91%, 92%, 93%, 94%, 95%, 96%, 97%, 98%, or 99%. In some embodiments, the second nanofiltration membrane has a MgSO₄ rejection of about 80% to about 99%. For example, the second nanofiltration membrane can have a MgSO₄ rejection of about: 80-99%, 80-97%, 80-95%, 80-90%, 80-85%, 85-99%, 85-97%, 85-95%, 85-90%, 90-99%, 90-97%, 90-95%, 95-99%, 95-97%, 97-99%, 80%, 81%, 82%, 83%, 84%, 85%, 86%, 87%, 88%, 89%, 90%, 91%, 92%, 93%, 94%, 95%, 96%, 97%, 98%, or 99%. In some embodiments, the second nanofiltration membrane has a MgSO₄ rejection of about 99%. In some embodiments, the second nanofiltration membrane has a MgSO₄ rejection of about 97%.

In some embodiments of the second, third, or fourth aspects, the second nanofiltration membrane has a NaCl rejection of at least about 30%. For example, the second nanofiltration membrane can have a NaCl rejection of at least about: 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the second nanofiltration membrane has a NaCl rejection of about 30% to 99%. For example, the second nanofiltration membrane can have a NaCl rejection of about: 30-99%, 30-95%, 30-90%, 30-80%, 30-70%, 30-60%, 30-50%, 30-40%, 40-99%, 40-95%, 40-90%, 40-80%, 40-70%, 40-60%, 40-50%, 50-99%, 50-95%, 50-90%, 50-80%, 50-70%, 50-60%, 60-99%, 60-95%, 60-90%, 60-80%, 60-70%, 70-99%, 70-95%, 70-90%, 70-80%, 80-99%, 80-95%, 80-90%, 90-99%, 90-95%, 95-99%, 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the second nanofiltration membrane has a NaCl rejection of about 40%. In some embodiments, the second nanofiltration membrane has a NaCl rejection of about 90%.

In some embodiments of the second, third, or fourth aspects, the ultrafiltration membrane is an ES404 membrane.

In some embodiments of the second, third, or fourth aspects, the ultrafiltration membrane has a pore size of about 2 nm to about 100 nm. For example, the ultrafiltration membrane can have a pore size of about: 2-100 nm, 2-75 nm, 2-50 nm, 2-25 nm, 2-10 nm, 2-5 nm, 5-100 nm, 5-75 nm, 5-50 nm, 5-25 nm, 5-10 nm, 10-100 nm, 10-75 nm, 10-50 nm, 10-25 nm, 25-100 nm, 25-75 nm, 25-50 nm, 50-100 nm, 50-75 nm, 75-100 nm, 2 nm, 3 nm, 4 nm, 5 nm, 6 nm, 7 nm, 8 nm, 9 nm, 10 nm, 12.5 nm, 15 nm, 17.5 nm, 20 nm, 22.5 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, or 100 nm.

In some embodiments of the second, third, or fourth aspects, the ultrafiltration membrane has a molecular weight cutoff of from about 5 kDa to about 5000 kDa. For example, the ultrafiltration membrane can have a molecular weight cutoff of about: 5-5000 kDa, 5-4000 kDa, 5-3000 kDa, 5-2000 kDa, 5-1000 kDa, 5-500 kDa, 5-250 kDa, 5-100 kDa, 5-50 kDa, 5-25 kDa, 5-10 kDa, 10-5000 kDa, 10-4000 kDa, 10-3000 kDa, 10-2000 kDa, 10-1000 kDa, 10-500 kDa, 10-250 kDa, 10-100 kDa, 10-50 kDa, 10-25 kDa, 25-5000 kDa, 25-4000 kDa, 25-3000 kDa, 25-2000 kDa, 25-1000 kDa, 25-500 kDa, 25-250 kDa, 25-100 kDa, 25-50 kDa, 50-5000 kDa, 50-4000 kDa, 50-3000 kDa, 50-2000 kDa, 50-1000 kDa, 50-500 kDa, 50-250 kDa, 50-100 kDa, 100-5000 kDa, 100-4000 kDa, 100-3000 kDa, 100-2000 kDa, 100-1000 kDa, 100-500 kDa, 100-250 kDa, 250-5000 kDa, 250-4000 kDa, 250-3000 kDa, 250-2000 kDa, 250-1000 kDa, 250-500 kDa, 500-5000 kDa, 500-4000 kDa, 500-3000 kDa, 500-2000 kDa, 500-1000 kDa, 1000-5000 kDa, 1000-4000 kDa, 1000-3000 kDa, 1000-2000 kDa, 2000-5000 kDa, 2000-4000 kDa, 2000-3000 kDa, 3000-5000 kDa, 3000-4000 kDa, 4000-5000 kDa, 5 kDa, 6 kDa, 7 kDa, 8 kDa, 9 kDa, 10 kDa, 11 kDa, 12 kDa, 13 kDa, 14 kDa, 15 kDa, 17.5 kDa, 20 kDa, 22.5 kDa, 25 kDa, 30 kDa, 35 kDa, 40 kDa, 45 kDa, 50 kDa, 60 kDa, 70 kDa, 80 kDa, 90 kDa, 100 kDa, 125 kDa, 150 kDa, 175 kDa, 200 kDa, 225 kDa, 250 kDa, 275 kDa, 300 kDa, 325 kDa, 350 kDa, 375 kDa, 400 kDa, 425 kDa, 450 kDa, 475 kDa, 500 kDa, 600 kDa, 700 kDa, 800 kDa, 900 kDa, 1000 kDa, 1250 kDa, 1500 kDa, 1750 kDa, 2000 kDa, 2250 kDa, 2500 kDa, 2750 kDa, 3000 kDa, 3250 kDa, 3500 kDa, 3750 kDa, 4000 kDa, 4250 kDa, 4500 kDa, 4750 kDa, or 5000 kDa. In some embodiments, the ultrafiltration membrane has a molecular weight cutoff of about 4000 kDa.

In some embodiments of the second, third, or fourth aspects, contacting the sugar hydrolysate and the first nanofiltration membrane is performed in a cross-flow configuration. In some embodiments, contacting the sugar hydrolysate and the first nanofiltration membrane is performed in a dead-end configuration.

In some embodiments of the second, third, or fourth aspects, contacting the sugar hydrolysate and the ultrafiltration membrane is performed in a cross-flow configuration. In some embodiments, contacting the sugar hydrolysate and the ultrafiltration membrane is performed in a dead-end configuration.

In some embodiments of the second, third, or fourth aspects, contacting the sugar hydrolysate and the second nanofiltration membrane is performed in a cross-flow configuration. In some embodiments, contacting the sugar hydrolysate and the second nanofiltration membrane is performed in a dead-end configuration.

In some embodiments of the second, third, or fourth aspects, contacting the sugar hydrolyzate with the first nanofiltration membrane, the second nanofiltration membrane, or the ultrafiltration membrane is performed at a pressure of about 10 psi to about 1000 psi. For example, contacting the sugar hydrolyzate with the first nanofiltration membrane, the second nanofiltration membrane, or the ultrafiltration membrane can be performed at a pressure of about: 10-1000 psi, 10-750 psi, 10-600 psi, 10-500 psi, 10-400 psi, 10-250 psi, 10-100 psi, 10-50 psi, 50-1000 psi, 50-750 psi, 50-600 psi, 50-500 psi, 50-400 psi, 50-250 psi, 50-100 psi, 100-1000 psi, 100-750 psi, 100-600 psi, 100-500 psi, 100-400 psi, 100-250 psi, 250-1000 psi, 250-750 psi, 250-600 psi, 250-500 psi, 250-400 psi, 400-1000 psi, 400-750 psi, 400-600 psi, 400-500 psi, 500-1000 psi, 500-750 psi, 500-600 psi, 600-1000 psi, 600-750 psi, 750-1000 psi, 10 psi, 20 psi, 30 psi, 40 psi, 50 psi, 60 psi, 70 psi, 80 psi, 90 psi, 100 psi, 125 psi, 150 psi, 175 psi, 200 psi, 225 psi, 250 psi, 275 psi, 300 psi, 325 psi, 350 psi, 375 psi, 400 psi, 425 psi, 450 psi, 475 psi, 500 psi, 525 psi, 550 psi, 575 psi, 600 psi, 625 psi, 650 psi, 675 psi, 700 psi, 750 psi, 800 psi, 850 psi, 900 psi, 950 psi, or 1000 psi. In some embodiments, contacting the sugar hydrolyzate with the first nanofiltration membrane, the second nanofiltration membrane, or the ultrafiltration membrane is performed at a pressure of about 100 psi to about 900 psi. In some embodiments, contacting the sugar hydrolyzate with the first nanofiltration membrane, the second nanofiltration membrane, or the ultrafiltration membrane is performed at a pressure of about 250 psi to about 750 psi. In some embodiments, contacting the sugar hydrolyzate with the first nanofiltration membrane, the second nanofiltration membrane, or the ultrafiltration membrane is performed at a pressure of about 500 psi to about 600 psi.

In some embodiments of the second, third, or fourth aspects, the sugar hydrolyzate is at a temperature of about 20° C. to about 80° C. For example, the sugar hydrolyzate can be at a temperature of about: 20-80° C., 20-70° C., 20-60° C., 20-50° C., 20-40° C., 20-30° C., 30-80° C., 30-70° C., 30-60° C., 30-50° C., 30-40° C., 40-80° C., 40-70° C., 40-60° C., 40-50° C., 50-80° C., 50-70° C., 50-60° C., 60-80° C., 60-70° C., 70-80° C., 20° C., 25° C., 30° C., 35° C., 40° C., 45° C., 50° C., 55° C., 60° C., 65° C., 70° C., 75° C., or 80° C.

In some embodiments of the second, third, or fourth aspects, the sugar hydrolyzate is at a pH of from about 1 to about 14. For example, the sugar hydrolyzate can have a pH of about: 1-14, 1-11, 1-9, 1-7, 1-6, 1-4, 1-2, 2-14, 2-11, 2-9, 2-7, 2-6, 2-4, 4-14, 4-11, 4-9, 4-7, 4-6, 6-14, 6-11, 6-9, 6-7, 7-14, 7-11, 7-9, 9-14, 9-11, 11-14, 1, 2, 3, 4, 5, 6, 7, 8, 9, 10, 11, 12, 13, or 14. In some embodiments, the sugar hydrolyzate is at a pH of from about 3 to about 11. In some embodiments, the sugar hydrolyzate is at a pH of from about 4 to about 9.

In some embodiments of the second, third, or fourth aspects, the water is added in an amount of from about 0.1 to about 10 diafiltration volumes. For example, the water can be added in an amount of about: 0.1-10, 0.1-7, 0.1-5, 0.1-3, 0.1-2, 0.1-1, 0.1-0.5, 0.5-10, 0.5-7, 0.5-5, 0.5-3, 0.5-2, 0.5-1, 1-10, 1-7, 1-5, 1-3, 1-2, 2-10, 2-7, 2-5, 2-3, 3-10, 3-7, 3-5, 5-10, 5-7, 7-10, 0.1, 0.2, 0.3, 0.4, 0.5, 0.6, 0.7, 0.8, 0.9, 1, 1.25, 1.5, 1.75, 2, 2.25, 2.5, 2.75, 3, 3.25, 3.5, 3.75, 4, 4.25, 4.5, 4.75, 5, 5.5, 6, 6.5, 7, 7.5, 8, 8.5, 9, 9.5, or 10 diafiltration volumes. In some embodiments, the water is added in an amount of from about 0.25 to about 6 diafiltration volumes. In some embodiments, the water is added in an amount of from about 0.1 to about 1 diafiltration volumes. In some embodiments, the water is added in an amount of from about 0.1 to about 0.5 diafiltration volumes.

In some embodiments of the second, third, or fourth aspects, the water is added continuously.

In some embodiments of the second, third, or fourth aspects, the water is added one or more times during contacting. In some embodiments, the water is added when a retentate volume reaches from 10% to about 75% of a starting volume of the sugar hydrolyzate. For example, the water can be added when the retentate volume reaches about: 10-75%, 10-50%, 10-25%, 10-15%, 15-75%, 15-50%, 15-25%, 25-75%, 25-50%, 50-75%, 10%, 15%, 20%, 25%, 30%, 35%, 40%, 45%, 50%, 55%, 60%, 65%, 70%, or 75% of the starting volume of the sugar hydrolyzate. In some embodiments, the water is added when a retentate volume reaches from 15% to about 50% of a starting volume of the sugar hydrolyzate. In some embodiments, the water is added when a retentate volume reaches about 25% of a starting volume of the sugar hydrolyzate.

In some embodiments of the second, third, or fourth aspects, the C6 sugars comprise glucose.

In some embodiments of the second, third, or fourth aspects, the C5 sugars comprise xylose, arabinose, or a combination thereof.

In some embodiments of the second, third, or fourth aspects, the sugar hydrolyzate comprises from about 1% to about 90% sugars by weight. For example, the sugar hydrolyzate can comprise about: 1-90%, 1-75%, 1-50%, 1-35%, 1-25%, 1-20%, 1-15%, 1-10%, 1-5%, 5-90%, 5-75%, 5-50%, 5-35%, 5-25%, 5-20%, 5-15%, 5-10%, 10-90%, 10-75%, 10-50%, 10-35%, 10-25%, 10-20%, 10-15%, 15-90%, 15-75%, 15-50%, 15-35%, 15-25%, 15-20%, 20-90%, 20-75%, 20-50%, 20-35%, 20-25%, 25-90%, 25-75%, 25-50%, 25-35%, 35-90%, 35-75%, 35-50%, 50-90%, 50-75%, or 75-90% sugars by weight. In some embodiments, the sugar hydrolyzate comprises from about 1% to about 50% sugars by weight. In some embodiments, the sugar hydrolyzate comprises from about 1% to about 35% sugars by weight. In some embodiments, the sugar hydrolyzate comprises from about 5% to about 50% sugars by weight.

In some embodiments of the second, third, or fourth aspects, the sugar hydrolyzate comprises the C5 sugars and the C6 sugars in a 5:95% ratio to a 95:5% ratio by weight. For example, the sugar hydrolyzate can comprise the C5 sugars and the C6 sugars in about: a 5:95% ratio to a 95:5% ratio, a 5:95% ratio to a 80:20% ratio, a 5:95% ratio to a 60:40% ratio, a 5:95% ratio to a 50:50% ratio, a 5:95% ratio to a 40:60% ratio, a 5:95% ratio to a 20:80% ratio, a 20:80% ratio to a 95:5% ratio, a 20:80% ratio to a 80:20% ratio, a 20:80% ratio to a 60:40% ratio, a 20:80% ratio to a 50:50% ratio, a 20:80% ratio to a 40:60% ratio, a 40:60% ratio to a 95:5% ratio, a 40:60% ratio to a 80:20% ratio, a 40:60% ratio to a 60:40% ratio, a 40:60% ratio to a 50:50% ratio, a 50:50% ratio to a 95:5% ratio, a 50:50% ratio to a 80:20% ratio, a 50:50% ratio to a 60:40% ratio, a 60:40% ratio to a 95:5% ratio, a 60:40% ratio to a 80:20% ratio, or a 80:20% ratio to a 95:5% ratio by weight. In some embodiments the sugar hydrolyzate comprises the C5 sugars and the C6 sugars in a 25:75% ratio to a 75:25% ratio by weight.

In some embodiments of the second, third, or fourth aspects, pretreating or hydrolyzing the biomass comprises mechanical size reduction, hot water treatment, acid treatment, base treatment, steam explosion, acid-catalyzed steam explosion, ammonia fiber/freeze explosion, enzymatic hydrolysis, or a combination thereof.

In some embodiments of the second, third, or fourth aspects, pretreating or hydrolyzing the biomass comprises mechanical size reduction, acid treatment and enzymatic hydrolysis.

In some embodiments of the second, third, or fourth aspects, the sugar hydrolysate was produced by: (1) hydrating the biomass in an acidic medium; (2) mechanical size reduction of the biomass; (3) heating the biomass; and (4) enzymatically hydrolyzing the biomass.

In some embodiments of the second, third, or fourth aspects, the sugar hydrolysate was produced by: (1) pretreating the biomass comprising lignocellulosic material with hot water or an acid to solubilize hemicellulose in the biomass, (2) substantially separating solubilized hemicellulose from remaining lignocellulosic solids, and (3) enzymatically hydrolyzing cellulose in the remaining lignocellulosic solids.

In some embodiments of the second, third, or fourth aspects, the sugar hydrolysate was produced by: (a) pretreating a biomass comprising cellulosic, hemicellulosic, or lignocellulosic material to produce a pretreated biomass comprising solid particles, wherein at least 50% of the solid particles have a size of less than 1.5 mm, and optionally a yield of C5 monomers and/or dimers that is at least 50% of a theoretical maximum, wherein pretreating comprises: (i) hydration of the biomass in an aqueous medium to produce a hydrated biomass, (ii) mechanical size reduction of the hydrated biomass to produce the solid particles, and (iii) heating the hydrated biomass for a time sufficient to produce the pretreated biomass comprising the optional yield of C5 monosaccharides and/or disaccharides; and (b) hydrolyzing the pretreated biomass composition with one or more enzymes for a time sufficient to produce the sugar hydrolyzate. In some embodiments, the aqueous medium comprises and acid. In some embodiments, the acid is sulfuric acid, peroxyacetic acid, lactic acid, formic acid, acetic acid, citric acid, phosphoric acid, hydrochloric acid, sulfurous acid, chloroacetic acid, dichloroacetic acid, trichloroacetic acid, trifluoroacetic acid, oxalic acid, benzoic acid, or a combination thereof.

Also provided are C6 enriched retentates produced by any of the methods disclosed herein.

Also provided are C5 enriched filtrates produced by any of the methods disclosed herein.

In a fifth aspect, disclosed are systems for refining a sugar hydrolyzate, the systems comprising: (a) a sugar hydrolyzate comprising C5 sugars and C6 sugars produced by pretreating or hydrolyzing of a biomass comprising cellulosic, hemicellulosic, or lignocellulosic material; (b) a first nanofiltration membrane that produces a C6 enriched retentate and a C5 enriched filtrate when the sugar hydrolyzate is contacted with the first nanofiltration membrane; and (c) a water source that adds water to the sugar hydrolyzate when the sugar hydrolyzate is contacted with the first nanofiltration membrane.

The systems of the fifth aspect can further comprise an ultrafiltration membrane to remove color molecules and suspended solids from the sugar hydrolyzate. In some embodiments, the sugar hydrolyzate is contacted with the ultrafiltration membrane prior to the nanofiltration membrane.

The systems of the fifth aspect can further comprise a second nanofiltration membrane to remove one or more inhibitors from the sugar hydrolyzate. In some embodiments, the sugar hydrolyzate is contacted with the second nanofiltration membrane prior to the first nanofiltration membrane.

The systems of the fifth aspect can further comprise a reverse osmosis membrane to concentrate the sugars in the C6 enriched retentate or the C5 enriched filtrate.

In some embodiments of the fifth aspect, the C6 enriched retentate comprises a C6 sugar content that is at least about a 1.1 times higher than the sugar hydrolyzate, based on total sugar content. For example, the C6 enriched retentate can comprise a C6 sugar content that is at least about: 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 3.5, 4, 4.5, 5, 6, 7, 8, 9, or 10 times higher that the sugar hydrolyzate based on total sugar content. In some embodiments, the C6 enriched retentate comprises a C6 sugar content that is at least about a 1.5 times higher than the sugar hydrolyzate, based on total sugar content. In some embodiments, the C6 enriched retentate comprises a C6 sugar content that is at least about a 2 times higher than the sugar hydrolyzate, based on total sugar content.

In some embodiments of the fifth aspect, the C5 enriched filtrate comprises a C5 sugar content that is at least about a 1.1 times higher than the sugar hydrolyzate, based on total sugar content. For example, the C5 enriched filtrate can comprise a C5 sugar content that is at least about: 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3, 3.5, 4, 4.5, 5, 6, 7, 8, 9, or 10 times higher than the sugar hydrolyzate based on total sugar content. In some embodiments, the C5 enriched filtrate comprises a C5 sugar content that is at least about a 1.5 times higher than the sugar hydrolyzate, based on total sugar content. In some embodiments, the C5 enriched filtrate comprises a C5 sugar content that is at least about a 2 times higher than the sugar hydrolyzate, based on total sugar content.

In some embodiments of the fifth aspect, the C6 enriched retentate has a transparency that is at least about 2 fold higher than the sugar hydrolyzate when measured at 600 nm. For example, the C6 enriched retentate can have a transparency that is at least: 2, 3, 4, 5, 6, 7, 8, 9, 10, 11, 12, 13, 14, 15, 16, 17, 18, 19, 20, 25, 30, 35, 40, 45, or 50 fold higher than the sugar hydrolyzate when measured at 600 nm. In some embodiments, the C6 enriched retentate has a transparency that is at least about 5 fold higher than the sugar hydrolyzate when measured at 600 nm. In some embodiments, the C6 enriched retentate has a transparency that is at least about 10 fold higher than the sugar hydrolyzate when measured at 600 nm.

In some embodiments of the fifth aspect, the C6 enriched retentate has a transparency that is at least about 10% higher than the sugar hydrolyzate when measured at 600 nm. For example, the C6 enriched retentate can have a transparency that is at least about: 10%, 15%, 20%, 25%, 30%, 35%, 40%, 45%, 50%, 60%, 70%, 80%, 90%, or 95% higher than the sugar hydrolyzate. If the sugar hydrolyzate has a transparency of 2% and the C6 enriched retentate has a transparency of 12%, that would be a 10% increase in transparency. Transparency can also be termed % transmittance. In some embodiments, the C6 enriched retentate has a transparency that is at least about 25% higher than the sugar hydrolyzate when measured at 600 nm. In some embodiments, the C6 enriched retentate has a transparency that is at least about 50% higher than the sugar hydrolyzate when measured at 600 nm.

In some embodiments of the fifth aspect, the C6 enriched retentate comprises an amount of one or more inhibitors that is, individually, at least about 10% lower than in the sugar hydrolyzate by weight. For example, the C6 enriched retentate can comprise an amount of one or more inhibitors that is, individually, at least about: 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99%, or 100% low that in the sugar hydrolysate by weight. In some embodiments, the C6 enriched retentate comprises an amount of one or more inhibitors that is, individually, at least about 50% lower than in the sugar hydrolyzate by weight. In some embodiments, the C6 enriched retentate comprises an amount of one or more inhibitors that is, individually, at least about 75% lower than in the sugar hydrolyzate by weight. In some embodiments, the C6 enriched retentate comprises an amount of one or more inhibitors that is, individually, from 10% to about 100% lower than in the sugar hydrolyzate by weight. In some embodiments, the one or more inhibitors comprise furfural, hydroxymethylfurfural, acetic acid, formic acid, or a combination thereof.

In some embodiments of the fifth aspect, the first nanofiltration membrane is a NF99, NF99HF, NF-45, NF-90, NF-200, NF-400, SU-210, SU-220, SU-600, SU-610, NF9790, or NF 9940 membrane. In some embodiments, the first nanofiltration membrane is a NF9790 membrane. In some embodiments, the first nanofiltration membrane is a NF9940 membrane.

In some embodiments of the fifth aspect, the first nanofiltration membrane is a spiral wound nanofiltration membrane. In some embodiments, the first nanofiltration membrane is a tubular nanofiltration membrane. In some embodiments, the first nanofiltration membrane is a hollow fiber nanofiltration membrane.

In some embodiments of the fifth aspect, the first nanofiltration membrane has a pore size of about 1 nm to about 2 nm. For example, the first nanofiltration membrane can have a pore size of about: 1 nm, 1.1 nm, 1.2 nm, 1.3 nm, 1.4 nm, 1.5 nm, 1.6 nm, 1.7 nm, 1.8 nm, 1.9 nm, or 2 nm.

In some embodiments of the fifth aspect, the first nanofiltration membrane has a molecular weight cutoff of about 0.1 kDa to about 5 kDa. For example, the first nanofiltration membrane can have a molecular weight cutoff of about: 0.1-5 kDa, 0.1-4 kDa, 0.1-3 kDa, 0.1-2 kDa, 0.1-1 kDa, 0.1-0.5 kDa, 0.1-0.25 kDa, 0.25-5 kDa, 0.25-4 kDa, 0.25-3 kDa, 0.25-2 kDa, 0.25-1 kDa, 0.25-0.5 kDa, 0.5-5 kDa, 0.5-4 kDa, 0.5-3 kDa, 0.5-2 kDa, 0.5-1 kDa, 1-5 kDa, 1-4 kDa, 1-3 kDa, 1-2 kDa, 2-5 kDa, 2-4 kDa, 2-3 kDa, 3-5 kDa, 3-4 kDa, 4-5 kDa, 0.1 kDa, 0.15 kDa, 0.2 kDa, 0.25 kDa, 0.3 kDa, 0.35 kDa, 0.4 kDa, 0.45 kDa, 0.5 kDa, 0.6 kDa, 0.7 kDa, 0.8 kDa, 0.9 kDa, 1 kDa, 1.1 kDa, 1.2 kDa, 1.3 kDa, 1.4 kDa, 1.5 kDa, 1.6 kDa, 1.7 kDa, 1.8 kDa, 1.9 kDa, 2 kDa, 2.25 kDa, 2.5 kDa, 2.75 kDa, 3 kDa, 3.25 kDa, 3.5 kDa, 3.75 kDa, 4 kDa, 4.25 kDa, 4.5 kDa, 4.75 kDa, or 5 kDa.

In some embodiments of the fifth aspect, the first nanofiltration membrane has a MgSO₄ rejection of at least about 80%. For example, the first nanofiltration membrane can have a MgSO₄ rejection of at least about 80%, 81%, 82%, 83%, 84%, 85%, 86%, 97%, 88%, 89%, 90%, 91%, 92%, 93%, 94%, 95%, 96%, 97%, 98%, or 99%. In some embodiments, the first nanofiltration membrane has a MgSO₄ rejection of about 80% to about 99%. For example, the first nanofiltration membrane can have a MgSO₄ rejection of about: 80-99%, 80-97%, 80-95%, 80-90%, 80-85%, 85-99%, 85-97%, 85-95%, 85-90%, 90-99%, 90-97%, 90-95%, 95-99%, 95-97%, 97-99%, 80%, 81%, 82%, 83%, 84%, 85%, 86%, 87%, 88%, 89%, 90%, 91%, 92%, 93%, 94%, 95%, 96%, 97%, 98%, or 99%. In some embodiments, wherein the first nanofiltration membrane has a MgSO₄ rejection of about 99%. In some embodiments, the first nanofiltration membrane has a MgSO₄ rejection of about 97%.

In some embodiments of the fifth aspect, the first nanofiltration membrane has a NaCl rejection of at least about 30%. For example, the first nanofiltration membrane can have a NaCl rejection of at least about: 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the first nanofiltration membrane has a NaCl rejection of about 30% to 99%. For example, the first nanofiltration membrane can have a NaCl rejection of about: 30-99%, 30-95%, 30-90%, 30-80%, 30-70%, 30-60%, 30-50%, 30-40%, 40-99%, 40-95%, 40-90%, 40-80%, 40-70%, 40-60%, 40-50%, 50-99%, 50-95%, 50-90%, 50-80%, 50-70%, 50-60%, 60-99%, 60-95%, 60-90%, 60-80%, 60-70%, 70-99%, 70-95%, 70-90%, 70-80%, 80-99%, 80-95%, 80-90%, 90-99%, 90-95%, 95-99%, 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the first nanofiltration membrane has a NaCl rejection of about 40%. In some embodiments, the first nanofiltration membrane has a NaCl rejection of about 90%.

In some embodiments of the fifth aspect, the second nanofiltration membrane is a NF99, NF99HF, NF-45, NF-90, NF-200, NF-400, SU-210, SU-220, SU-600, SU-610, NF9790, or NF 9940 membrane. In some embodiments, the second nanofiltration membrane is a NF9790 membrane. In some embodiments, the second nanofiltration membrane is a NF9940 membrane.

In some embodiments of the fifth aspect, the second nanofiltration membrane is a spiral wound nanofiltration membrane. In some embodiments, the second nanofiltration membrane is a tubular nanofiltration membrane. In some embodiments, the second nanofiltration membrane is a hollow fiber nanofiltration membrane.

In some embodiments of the fifth aspect, the second nanofiltration membrane has a pore size of about 1 nm to about 2 nm. For example, the second nanofiltration membrane can have a pore size of about: 1 nm, 1.1 nm, 1.2 nm, 1.3 nm, 1.4 nm, 1.5 nm, 1.6 nm, 1.7 nm, 1.8 nm, 1.9 nm, or 2 nm.

In some embodiments of the fifth aspect, the second nanofiltration membrane has a molecular weight cutoff of about 0.1 kDa to about 5 kDa. For example, the second nanofiltration membrane can have a molecular weight cutoff of about: 0.1-5 kDa, 0.1-4 kDa, 0.1-3 kDa, 0.1-2 kDa, 0.1-1 kDa, 0.1-0.5 kDa, 0.1-0.25 kDa, 0.25-5 kDa, 0.25-4 kDa, 0.25-3 kDa, 0.25-2 kDa, 0.25-1 kDa, 0.25-0.5 kDa, 0.5-5 kDa, 0.5-4 kDa, 0.5-3 kDa, 0.5-2 kDa, 0.5-1 kDa, 1-5 kDa, 1-4 kDa, 1-3 kDa, 1-2 kDa, 2-5 kDa, 2-4 kDa, 2-3 kDa, 3-5 kDa, 3-4 kDa, 4-5 kDa, 0.1 kDa, 0.15 kDa, 0.2 kDa, 0.25 kDa, 0.3 kDa, 0.35 kDa, 0.4 kDa, 0.45 kDa, 0.5 kDa, 0.6 kDa, 0.7 kDa, 0.8 kDa, 0.9 kDa, 1 kDa, 1.1 kDa, 1.2 kDa, 1.3 kDa, 1.4 kDa, 1.5 kDa, 1.6 kDa, 1.7 kDa, 1.8 kDa, 1.9 kDa, 2 kDa, 2.25 kDa, 2.5 kDa, 2.75 kDa, 3 kDa, 3.25 kDa, 3.5 kDa, 3.75 kDa, 4 kDa, 4.25 kDa, 4.5 kDa, 4.75 kDa, or 5 kDa.

In some embodiments of the fifth aspect, the second nanofiltration membrane has a MgSO₄ rejection of at least about 80%. For example, the second nanofiltration membrane can have a MgSO₄ rejection of at least about 80%, 81%, 82%, 83%, 84%, 85%, 86%, 97%, 88%, 89%, 90%, 91%, 92%, 93%, 94%, 95%, 96%, 97%, 98%, or 99%. In some embodiments, the second nanofiltration membrane has a MgSO₄ rejection of about 80% to about 99%. For example, the second nanofiltration membrane can have a MgSO₄ rejection of about: 80-99%, 80-97%, 80-95%, 80-90%, 80-85%, 85-99%, 85-97%, 85-95%, 85-90%, 90-99%, 90-97%, 90-95%, 95-99%, 95-97%, 97-99%, 80%, 81%, 82%, 83%, 84%, 85%, 86%, 87%, 88%, 89%, 90%, 91%, 92%, 93%, 94%, 95%, 96%, 97%, 98%, or 99%. In some embodiments, the second nanofiltration membrane has a MgSO₄ rejection of about 99%. In some embodiments, the second nanofiltration membrane has a MgSO₄ rejection of about 97%.

In some embodiments of the fifth aspect, the second nanofiltration membrane has a NaCl rejection of at least about 30%. For example, the second nanofiltration membrane can have a NaCl rejection of at least about: 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the second nanofiltration membrane has a NaCl rejection of about 30% to 99%. For example, the second nanofiltration membrane can have a NaCl rejection of about: 30-99%, 30-95%, 30-90%, 30-80%, 30-70%, 30-60%, 30-50%, 30-40%, 40-99%, 40-95%, 40-90%, 40-80%, 40-70%, 40-60%, 40-50%, 50-99%, 50-95%, 50-90%, 50-80%, 50-70%, 50-60%, 60-99%, 60-95%, 60-90%, 60-80%, 60-70%, 70-99%, 70-95%, 70-90%, 70-80%, 80-99%, 80-95%, 80-90%, 90-99%, 90-95%, 95-99%, 30%, 35%, 40%, 45%, 50%, 55%, 60%, 65%, 70%, 75%, 80%, 85%, 90%, 91%, 92%, 93%, 94%, 95%, 96%, 97%, 98%, or 99%. In some embodiments, the second nanofiltration membrane has a NaCl rejection of about 40%. In some embodiments, the second nanofiltration membrane has a NaCl rejection of about 90%.

In some embodiments of the fifth aspect, the ultrafiltration membrane is an ES404 membrane.

In some embodiments, the ultrafiltration membrane has a pore size of about 2 nm to about 100 nm. For example, the ultrafiltration membrane can have a pore size of about: 2-100 nm, 2-75 nm, 2-50 nm, 2-25 nm, 2-10 nm, 2-5 nm, 5-100 nm, 5-75 nm, 5-50 nm, 5-25 nm, 5-10 nm, 10-100 nm, 10-75 nm, 10-50 nm, 10-25 nm, 25-100 nm, 25-75 nm, 25-50 nm, 50-100 nm, 50-75 nm, 75-100 nm, 2 nm, 3 nm, 4 nm, 5 nm, 6 nm, 7 nm, 8 nm, 9 nm, 10 nm, 12.5 nm, 15 nm, 17.5 nm, 20 nm, 22.5 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, or 100 nm.

In some embodiments of the fifth aspect, the ultrafiltration membrane has a molecular weight cutoff of from about 5 kDa to about 5000 kDa. For example, the ultrafiltration membrane can have a molecular weight cutoff of about: 5-5000 kDa, 5-4000 kDa, 5-3000 kDa, 5-2000 kDa, 5-1000 kDa, 5-500 kDa, 5-250 kDa, 5-100 kDa, 5-50 kDa, 5-25 kDa, 5-10 kDa, 10-5000 kDa, 10-4000 kDa, 10-3000 kDa, 10-2000 kDa, 10-1000 kDa, 10-500 kDa, 10-250 kDa, 10-100 kDa, 10-50 kDa, 10-25 kDa, 25-5000 kDa, 25-4000 kDa, 25-3000 kDa, 25-2000 kDa, 25-1000 kDa, 25-500 kDa, 25-250 kDa, 25-100 kDa, 25-50 kDa, 50-5000 kDa, 50-4000 kDa, 50-3000 kDa, 50-2000 kDa, 50-1000 kDa, 50-500 kDa, 50-250 kDa, 50-100 kDa, 100-5000 kDa, 100-4000 kDa, 100-3000 kDa, 100-2000 kDa, 100-1000 kDa, 100-500 kDa, 100-250 kDa, 250-5000 kDa, 250-4000 kDa, 250-3000 kDa, 250-2000 kDa, 250-1000 kDa, 250-500 kDa, 500-5000 kDa, 500-4000 kDa, 500-3000 kDa, 500-2000 kDa, 500-1000 kDa, 1000-5000 kDa, 1000-4000 kDa, 1000-3000 kDa, 1000-2000 kDa, 2000-5000 kDa, 2000-4000 kDa, 2000-3000 kDa, 3000-5000 kDa, 3000-4000 kDa, 4000-5000 kDa, 5 kDa, 6 kDa, 7 kDa, 8 kDa, 9 kDa, 10 kDa, 11 kDa, 12 kDa, 13 kDa, 14 kDa, 15 kDa, 17.5 kDa, 20 kDa, 22.5 kDa, 25 kDa, 30 kDa, 35 kDa, 40 kDa, 45 kDa, 50 kDa, 60 kDa, 70 kDa, 80 kDa, 90 kDa, 100 kDa, 125 kDa, 150 kDa, 175 kDa, 200 kDa, 225 kDa, 250 kDa, 275 kDa, 300 kDa, 325 kDa, 350 kDa, 375 kDa, 400 kDa, 425 kDa, 450 kDa, 475 kDa, 500 kDa, 600 kDa, 700 kDa, 800 kDa, 900 kDa, 1000 kDa, 1250 kDa, 1500 kDa, 1750 kDa, 2000 kDa, 2250 kDa, 2500 kDa, 2750 kDa, 3000 kDa, 3250 kDa, 3500 kDa, 3750 kDa, 4000 kDa, 4250 kDa, 4500 kDa, 4750 kDa, or 5000 kDa. In some embodiments, the ultrafiltration membrane has a molecular weight cutoff of about 4000 kDa.

In some embodiments of the fifth aspect, the first nanofiltration membrane is in a cross-flow configuration. In some embodiments, the first nanofiltration membrane is in a dead-end configuration.

In some embodiments of the fifth aspect, the ultrafiltration membrane is in a cross-flow configuration. In some embodiments, the ultrafiltration membrane is in a dead-end configuration.

In some embodiments of the fifth aspect, the second nanofiltration membrane is in a cross-flow configuration. In some embodiments, the second nanofiltration membrane is in a dead-end configuration.

In some embodiments of the fifth aspect, the sugar hydrolyzate is contacted with the first nanofiltration membrane, second nanofiltration membrane, or the ultrafiltration membrane at a pressure of about 10 psi to about 1000 psi. For example, contacting the sugar hydrolyzate with the first nanofiltration membrane, the second nanofiltration membrane, or the ultrafiltration membrane can be performed at a pressure of about: 10-1000 psi, 10-750 psi, 10-600 psi, 10-500 psi, 10-400 psi, 10-250 psi, 10-100 psi, 10-50 psi, 50-1000 psi, 50-750 psi, 50-600 psi, 50-500 psi, 50-400 psi, 50-250 psi, 50-100 psi, 100-1000 psi, 100-750 psi, 100-600 psi, 100-500 psi, 100-400 psi, 100-250 psi, 250-1000 psi, 250-750 psi, 250-600 psi, 250-500 psi, 250-400 psi, 400-1000 psi, 400-750 psi, 400-600 psi, 400-500 psi, 500-1000 psi, 500-750 psi, 500-600 psi, 600-1000 psi, 600-750 psi, 750-1000 psi, 10 psi, 20 psi, 30 psi, 40 psi, 50 psi, 60 psi, 70 psi, 80 psi, 90 psi, 100 psi, 125 psi, 150 psi, 175 psi, 200 psi, 225 psi, 250 psi, 275 psi, 300 psi, 325 psi, 350 psi, 375 psi, 400 psi, 425 psi, 450 psi, 475 psi, 500 psi, 525 psi, 550 psi, 575 psi, 600 psi, 625 psi, 650 psi, 675 psi, 700 psi, 750 psi, 800 psi, 850 psi, 900 psi, 950 psi, or 1000 psi. In some embodiments, contacting the sugar hydrolyzate with the first nanofiltration membrane, the second nanofiltration membrane, or the ultrafiltration membrane is performed at a pressure of about 100 psi to about 900 psi. In some embodiments, contacting the sugar hydrolyzate with the first nanofiltration membrane, the second nanofiltration membrane, or the ultrafiltration membrane is performed at a pressure of about 250 psi to about 750 psi. In some embodiments, contacting the sugar hydrolyzate with the first nanofiltration membrane, the second nanofiltration membrane, or the ultrafiltration membrane is performed at a pressure of about 500 psi to about 600 psi. In some embodiments of the fifth aspect, the sugar hydrolyzate is at a temperature of about 20° C. to about 80° C. For example, the sugar hydrolyzate can be at a temperature of about: 20-80° C., 20-70° C., 20-60° C., 20-50° C., 20-40° C., 20-30° C., 30-80° C., 30-70° C., 30-60° C., 30-50° C., 30-40° C., 40-80° C., 40-70° C., 40-60° C., 40-50° C., 50-80° C., 50-70° C., 50-60° C., 60-80° C., 60-70° C., 70-80° C., 20° C., 25° C., 30° C., 35° C., 40° C., 45° C., 50° C., 55° C., 60° C., 65° C., 70° C., 75° C., or 80° C.

In some embodiments of the fifth aspect, the sugar hydrolyzate is at a pH of from about 1 to about 14. For example, the sugar hydrolyzate can have a pH of about: 1-14, 1-11, 1-9, 1-7, 1-6, 1-4, 1-2, 2-14, 2-11, 2-9, 2-7, 2-6, 2-4, 4-14, 4-11, 4-9, 4-7, 4-6, 6-14, 6-11, 6-9, 6-7, 7-14, 7-11, 7-9, 9-14, 9-11, 11-14, 1, 2, 3, 4, 5, 6, 7, 8, 9, 10, 11, 12, 13, or 14. In some embodiments, the sugar hydrolyzate is at a pH of from about 3 to about 11. In some embodiments, the sugar hydrolyzate is at a pH of from about 4 to about 9.

In some embodiments of the fifth aspect, the water is added in an amount of from about 0.1 to about 10 diafiltration volumes. For example, the water can be added in an amount of about: 0.1-10, 0.1-7, 0.1-5, 0.1-3, 0.1-2, 0.1-1, 0.1-0.5, 0.5-10, 0.5-7, 0.5-5, 0.5-3, 0.5-2, 0.5-1, 1-10, 1-7, 1-5, 1-3, 1-2, 2-10, 2-7, 2-5, 2-3, 3-10, 3-7, 3-5, 5-10, 5-7, 7-10, 0.1, 0.2, 0.3, 0.4, 0.5, 0.6, 0.7, 0.8, 0.9, 1, 1.25, 1.5, 1.75, 2, 2.25, 2.5, 2.75, 3, 3.25, 3.5, 3.75, 4, 4.25, 4.5, 4.75, 5, 5.5, 6, 6.5, 7, 7.5, 8, 8.5, 9, 9.5, or 10 diafiltration volumes. In some embodiments, the water is added in an amount of from about 0.25 to about 6 diafiltration volumes. In some embodiments, the water is added in an amount of from about 0.1 to about 1 diafiltration volumes. In some embodiments, the water is added in an amount of from about 0.1 to about 0.5 diafiltration volumes.

In some embodiments of the fifth aspect, the water is added continuously.

In some embodiments of the fifth aspect, the water is added one or more times during contacting. In some embodiments, the water is added when a retentate volume reaches from 10% to about 75% of a starting volume of the sugar hydrolyzate. For example, the water can be added when the retentate volume reaches about: 10-75%, 10-50%, 10-25%, 10-15%, 15-75%, 15-50%, 15-25%, 25-75%, 25-50%, 50-75%, 10%, 15%, 20%, 25%, 30%, 35%, 40%, 45%, 50%, 55%, 60%, 65%, 70%, or 75% of the starting volume of the sugar hydrolyzate. In some embodiments, the water is added when a retentate volume reaches from 15% to about 50% of a starting volume of the sugar hydrolyzate. In some embodiments, the water is added when a retentate volume reaches about 25% of a starting volume of the sugar hydrolyzate.

In some embodiments of the fifth aspect, the C6 sugars comprise glucose. In some embodiments, the C5 sugars comprise xylose, arabinose, or a combination thereof.

In some embodiments of the fifth aspect, the sugar hydrolyzate comprises from about 1% to about 90% sugars by weight. For example, the sugar hydrolyzate can comprise about: 1-90%, 1-75%, 1-50%, 1-35%, 1-25%, 1-20%, 1-15%, 1-10%, 1-5%, 5-90%, 5-75%, 5-50%, 5-35%, 5-25%, 5-20%, 5-15%, 5-10%, 10-90%, 10-75%, 10-50%, 10-35%, 10-25%, 10-20%, 10-15%, 15-90%, 15-75%, 15-50%, 15-35%, 15-25%, 15-20%, 20-90%, 20-75%, 20-50%, 20-35%, 20-25%, 25-90%, 25-75%, 25-50%, 25-35%, 35-90%, 35-75%, 35-50%, 50-90%, 50-75%, or 75-90% sugars by weight. In some embodiments, the sugar hydrolyzate comprises from about 1% to about 50% sugars by weight. In some embodiments, the sugar hydrolyzate comprises from about 1% to about 35% sugars by weight. In some embodiments, the sugar hydrolyzate comprises from about 5% to about 50% sugars by weight.

In some embodiments of the fifth aspect, the sugar hydrolyzate comprises the C5 sugars and the C6 sugars in a 5:95% ratio to a 95:5% ratio by weight. For example, the sugar hydrolyzate can comprise the C5 sugars and the C6 sugars in about: a 5:95% ratio to a 95:5% ratio, a 5:95% ratio to a 80:20% ratio, a 5:95% ratio to a 60:40% ratio, a 5:95% ratio to a 50:50% ratio, a 5:95% ratio to a 40:60% ratio, a 5:95% ratio to a 20:80% ratio, a 20:80% ratio to a 95:5% ratio, a 20:80% ratio to a 80:20% ratio, a 20:80% ratio to a 60:40% ratio, a 20:80% ratio to a 50:50% ratio, a 20:80% ratio to a 40:60% ratio, a 40:60% ratio to a 95:5% ratio, a 40:60% ratio to a 80:20% ratio, a 40:60% ratio to a 60:40% ratio, a 40:60% ratio to a 50:50% ratio, a 50:50% ratio to a 95:5% ratio, a 50:50% ratio to a 80:20% ratio, a 50:50% ratio to a 60:40% ratio, a 60:40% ratio to a 95:5% ratio, a 60:40% ratio to a 80:20% ratio, or a 80:20% ratio to a 95:5% ratio by weight. In some embodiments, the sugar hydrolyzate comprises the C5 sugars and the C6 sugars in a 25:75% ratio to a 75:25% ratio by weight.

In some embodiments of the fifth aspect, pretreating or hydrolyzing the biomass comprises mechanical size reduction, hot water treatment, acid treatment, base treatment, steam explosion, acid-catalyzed steam explosion, ammonia fiber/freeze explosion, enzymatic hydrolysis, or a combination thereof.

In some embodiments of the fifth aspect, pretreating or hydrolyzing the biomass comprises mechanical size reduction, acid treatment and enzymatic hydrolysis.

In some embodiments of the fifth aspect, the sugar hydrolysate was produced by: (1) hydrating the biomass in an acidic medium; (2) mechanical size reduction of the biomass; (3) heating the biomass; and (4) enzymatically hydrolyzing the biomass.

In some embodiments of the fifth aspect, the sugar hydrolysate was produced by: (1) pretreating the biomass comprising lignocellulosic material with hot water or an acid to solubilize hemicellulose in the biomass, (2) substantially separating solubilized hemicellulose from remaining lignocellulosic solids, and (3) enzymatically hydrolyzing cellulose in the remaining lignocellulosic solids.

In some embodiments of the fifth aspect, the sugar hydrolysate was produced by: (a) pretreating a biomass comprising cellulosic, hemicellulosic, or lignocellulosic material to produce a pretreated biomass comprising solid particles, wherein at least 50% of the solid particles have a size of less than 1.5 mm, and optionally a yield of C5 monomers and/or dimers that is at least 50% of a theoretical maximum, wherein pretreating comprises: (i) hydration of the biomass in an aqueous medium to produce a hydrated biomass, (ii) mechanical size reduction of the hydrated biomass to produce the solid particles, and (iii) heating the hydrated biomass for a time sufficient to produce the pretreated biomass comprising the optional yield of C5 monosaccharides and/or disaccharides; and (b) hydrolyzing the pretreated biomass composition with one or more enzymes for a time sufficient to produce the sugar hydrolyzate. In some embodiments, the aqueous medium comprises and acid. In some embodiments, the acid is sulfuric acid, peroxyacetic acid, lactic acid, formic acid, acetic acid, citric acid, phosphoric acid, hydrochloric acid, sulfurous acid, chloroacetic acid, dichloroacetic acid, trichloroacetic acid, trifluoroacetic acid, oxalic acid, benzoic acid, or a combination thereof.

### Examples

The following examples serve to illustrate certain embodiments and aspects and are not to be construed as limiting the scope thereof.

Materials

ES404 Membrane: Removal of Color and Suspended Solids

Tubular ultrafiltration membrane with a 4000 kDa molecular weight cut off was used with the intention to void the cellulosic sugar stream of larger macromolecules (color components and proteins).

NF9790 Membrane: Sugar Concentration

A tight spiral wound nanofiltration membrane with a MgSO4 rejection of 97% and a NaCl rejection of 90% (hence referred to as NF9790) was used with the intention to concentrate the sugars.

NF9940 Membrane: Inhibitor Removal and Sugar Ratios

A spiral wound nanofiltration membrane (used to remove monovalent salts and retain divalent salts) with a MgSO₄ rejection of 99% and a NaCl rejection of 40% (hence referred to as NF9940) was used in combination with a fill and draw diafiltration technique with the intention to concentrate the sugars and percolate inhibitors.

C5/C6 Sugar Hydrolysate—5.5% Total Sugar

Methods

Preparation of the Hydrolysate

Barkless hardwood was processed through a continuous Carbofrac 1MT/day ton Biogasol reactor and was followed by enzymatically hydrolyzing the pretreated material using commercially available enzymes. The resulting sugar stream was a 5.5% w/v C5/C6 blended stream. The sugar hydrolysate was then filter pressed to remove lignin and other solids. This sugar recovered as filtered hydrolysate was then ready for membrane filtration.

Initial Cleaning and Setup of the Membranes

Each membrane was cleaned using a caustic solution at pH 9 to remove the membrane preservative. The membranes were then flushed with water. After the initial flushing, the membrane was tested with water to gauge the initial water flux of the membrane. The process was carried out in accordance with standard protocols. All cleaning and flux data was recorded.

Ultrafiltration Unit

The use of an ultrafiltration (UF) membrane was investigated for the removal of color and larger macromolecules. The tests were run using a BRO/BUF pilot unit (Membrane Specialists) with tubular UF membranes installed in the module.

Ulrafiltration Test to Remove Color Bodies and Suspended Solids

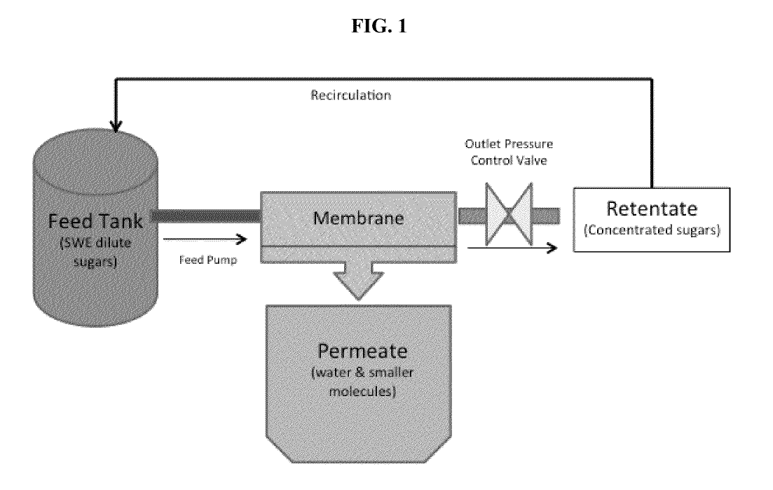

After completing the initial washing step of the ES404 membrane, dilute sugar solution was placed into the membrane feed tank of the typical membrane module, as seen in FIG. 1.

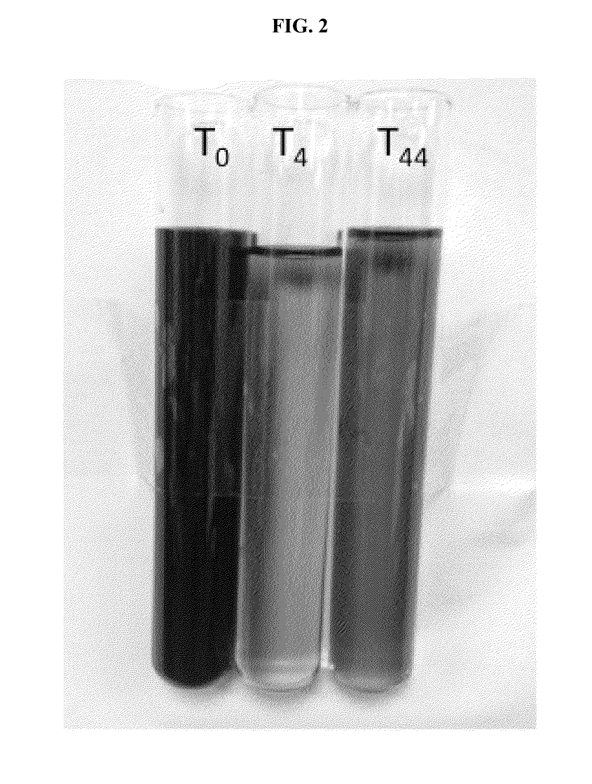

The feed liquid was then recirculated through the module and the flux was measured as the temperature was raised and a flux/temperature relationship was established. The pressure was then set to 600 psi and the permeate drainage tube was taken out of the feed tank and redirected to a separate tank to begin the run. The permeate flow was measured every 10 minutes, noting temperature and pressure in and out of the module until minimum holdup volume was reached and the run was terminated. Throughout the run, samples of the permeate and the retentate were retained for analysis of sugar and inhibitor profiles. The final retentate and permeate were also collected and the volumes of each were recorded. OD data (measured at 600 nm) and photos of removal of so called complex organic ‘color bodies’ can be seen in Table 1 below and FIG. 2.

TABLE 1
OD measurements of ES404 treated hydrolysate.

| Sample | Percent Transmittance |
|---|---|
| T0 | 2.80% |
| Bulk Permeate | 53% |

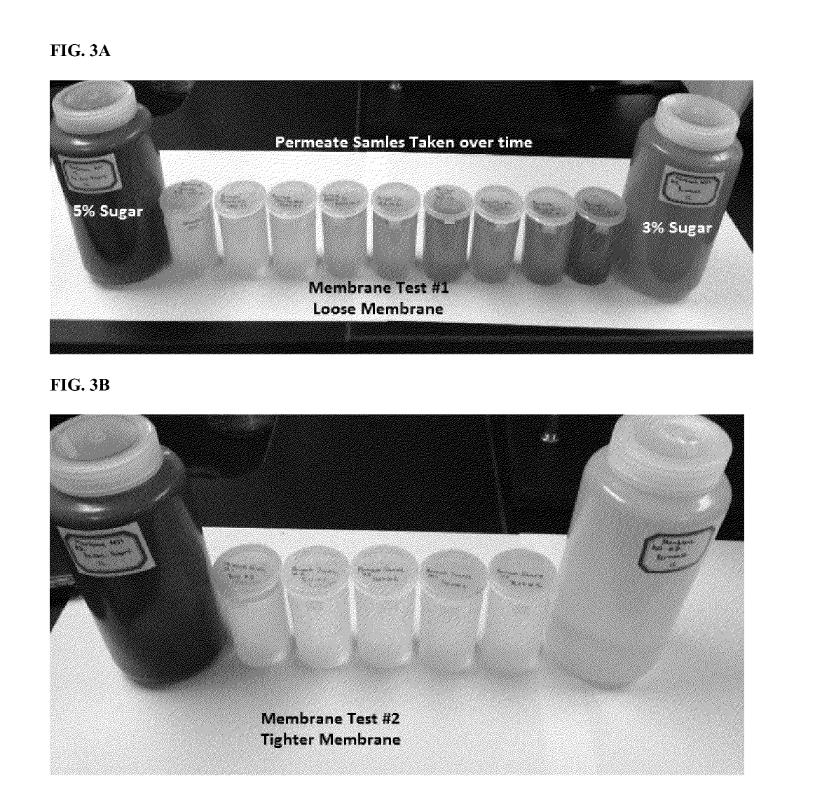

Color removal can also be achieved to a higher degree using NF9940 and NF9790 membranes as shown in FIGS. 3A and 3B. Photographs of the permeate solutions for each test show the change in color over time using UF and NF membranes. Nanofiltration membranes, such as the NF9940 and NF9790, were more effective in reducing the color intensity. Most of the ‘color bodies’ were retained in retentate and the permeate was highly clarified and an almost clear decolorized sugar syrup.

Nanofiltration Units

The primary goal of the test was to investigate the use of spiral wound nanofiltration (NF) membranes for the concentration of sugars while monitoring the changes in C5 and C6 ratios and the removal of organic acids. The goal for the final concentration of sugars was 20-30 brix while allowing smaller molecular weight species, such as acetic acid, to pass into the permeate; i.e., to achieve a higher degree of purity of the sugar and separation of C5 and C6 concentrate. Two different NF membranes based on the pore size were used in the tests. The first membrane was considered a “typical loose” referred to as NF9940 membrane (used to remove monovalent salts and retain divalent salts) and had a NaCl rejection of 40%; the second was described as a more “tight” NF membrane and had a tighter pores that enabled NaCl rejection of 90% (used to concentrate sugars) and referred to as NF9790. The tests were run using a BRO/BUF pilot unit provided by Membrane Specialists, LLC (Hamilton, Ohio) with spiral NF membranes installed in the modules.

Nanofiltration Test to Concentrate Sugars

30 gallons of the dilute sugar solution was placed into the membrane feed tank of the typical membrane module, seen in FIG. 1 above. The feed liquid was then recirculated through the module and the flux was measured as the temperature was raised to 55° F. and a flux/temperature relationship was established.

Once the temperature of 55° F. was reached, the permeate drainage tube was taken out of the feed tank and redirected to a separate tank to begin the run. When the feed tank volume reached approximately 50% of the original volume, 5 gallons of additional dilute sugar solution was added to the feed tank to continue concentration. During the entirety of the run, the permeate flow was measured every 10 minutes, noting temperature and pressure in and out of the module until maximum concentration was reached when the back pressure on the membrane reached 820 psi with no measurable permeate flow on the flow meter. Throughout the run, samples of the permeate and the retentate were retained for analysis of sugar and inhibitor profiles.

The final retentate and permeate were also collected and the volumes of each were recorded.

Table 2 shows the analysis of the initial and final sugar concentrations as well as the inhibitor concentrations over time in NF9790 filtration to concentrate the sugars.

TABLE 2
Sugar and inhibitor concentrations during the NF9790 nanofiltration test.

| NF9790 | | | Formic | Acetic | | |
|---|---|---|---|---|---|---|
| Membrane Test | Glucose | Xylose | Acid | Acid | HMF (%) | Furfural |
| Initial Sugar Solution | 3351.6 g | 4085.8 g | 55.6 g | 1020.0 g | 38.4 g | 128.3 g |
| Final Sugar Concentrate Solution | 100.9% | 93.5% | 88.5% | 92.8% | 57.0% | 25.6% |
| Bulk Permeate Solution | 0.5% | 0.6% | 14.4% | 18.7% | 56.3% | 70.5% |

Use of the NF9790 membrane resulted in about 99% of the total sugar remaining in the retentate. There was an approximate 15% removal of organic acids from the retentate solution, as well as over 60% removal in furans. Thus furans and organic acids can be separated from C5 and C6 sugar through this particular membrane filtration system.

Diafiltration Test to Remove Inhibitors and Organic Acid and Refine the Retentate

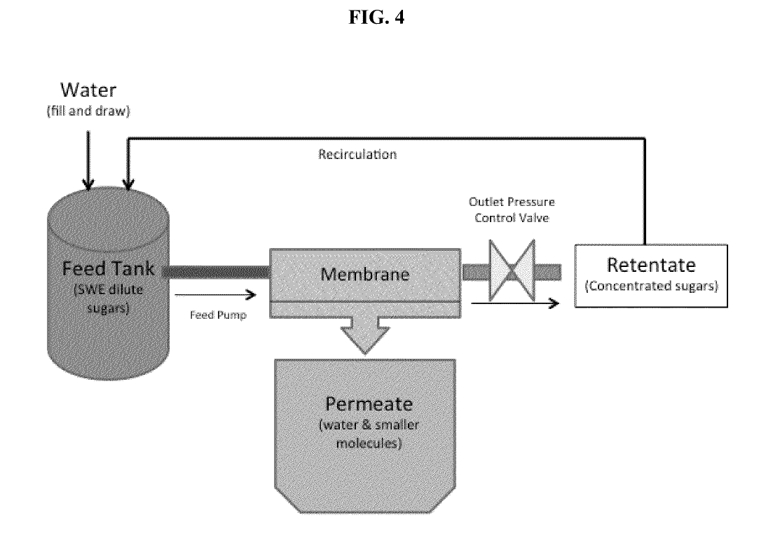

35 gallons of permeate from the ES404 membrane test was filled into the membrane feed tank of the diafiltration membrane module, as seen in FIG. 4.

The feed liquid was then recirculated through the module and the flux was measured as the temperature was raised and a flux/temperature relationship was established. The pressure was then set to 500 psi and the permeate was directed to a separate tank to begin the run. When the feed tank volume reached approximately 25% of the original volume, (drain) 10 gallons of water was added to the feed tank and concentration was continued (fill and drain operation). Again when the feed tank volume reached approximately 25% of the original volume, an additional 5 gallons of extra water was added to the feed tank and concentration was continued. The permeate flow was measured every 10 minutes, noting temperature and pressure in and out of the module until minimum holdup volume was reached after both additions of water. Throughout the run samples of the permeate and the retentate were retained for analysis of sugar and inhibitor profiles. The final retentate and permeate were also collected and the final volumes of each were recorded.

Table 3 shows the changes and alteration in the sugar and inhibitor concentrations due to the filtration of the hydrolysate through the NF9940 membrane using the fill and draw diafiltration method.

TABLE 3
Sugar and inhibitor concentrations during the
NF9940 nanofiltration test using diafiltration.

| | Glucose | Xylose | Arabinose | Total Sugar | Formic Acid | Acetic Acid |
|---|---|---|---|---|---|---|
| Sample | (Kg) | (Kg) | (Kg) | (Kg) | (Kg) | (Kg) |
| T0 | 4.79 | 2.30 | 0.07 | 7.09 | 0.09 | 0.29 |
| Bulk Permeate | 1.94 | 1.47 | 0.06 | 3.41 | 0.10 | 0.29 |
| Bulk Retentate | 1.95 | 0.54 | 0.02 | 2.49 | 0.00 | 0.00 |

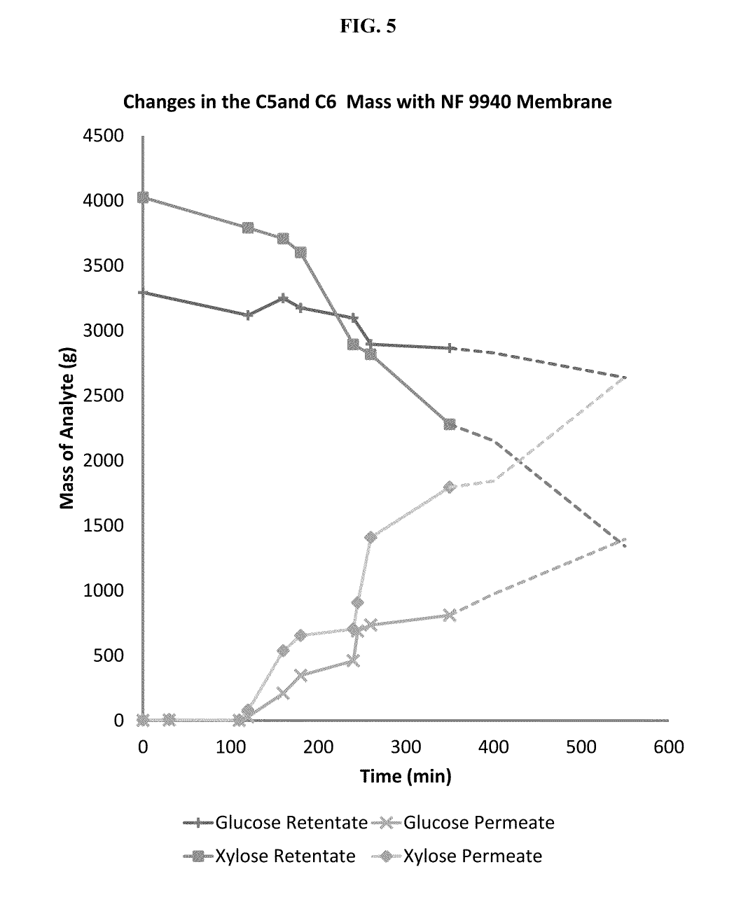

Changes and alteration in the sugar concentrations during the filtration of hydrolysate through the NF9940 membrane can also be achieved without the use of diafiltration as shown in FIG. 5. The dotted lines indicate the theoretical potential of this test had the filtration been continued.

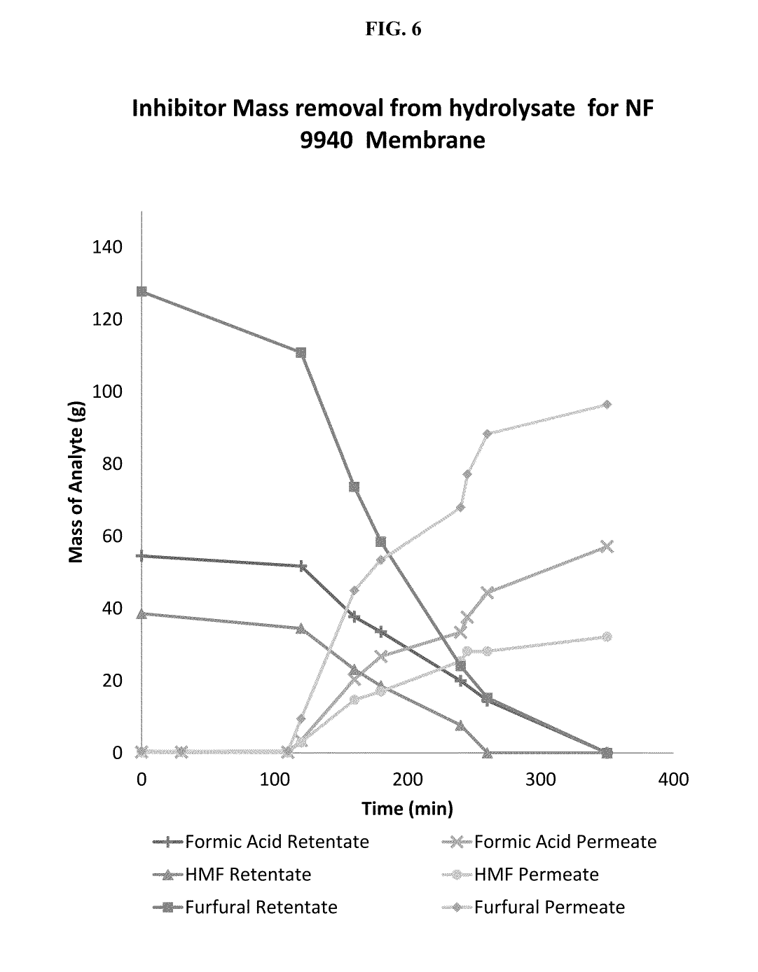

FIG. 6 shows the changes in the inhibitor levels during the filtration of the hydrolysate through the NF9940 membrane without the use of diafiltration.

TABLE 4
Percentage of each inhibitor found in the sugar concentrate and
the bulk permeate for NF9940 membrane test without diafiltration.

| NF9940 | | | Formic | Acetic | | |
|---|---|---|---|---|---|---|
| Membrane Test | Glucose | Xylose | Acid | Acid | HMF | Furfural |
| Initial Sugar Solution | 3293.1 g | 4024.6 g | 54.2 g | 1005.5 g | 38.4 g | 127.0 g |
| Final Sugar Concentrate Solution | 86.0% | 56.0% | 0.0% | 21.2% | 0.0% | 0.0% |
| Bulk Permeate Solution | 24.0% | 43.5% | 102.7% | 79.1% | 82.0% | 74.5% |

NF9940 membrane tests with the use of diafiltration, showed that sugars could be completely separated from inhibitors with the use of this NF membrane. In addition the production of an enriched C6 rich stream void of inhibitors and diminished of C5 from the NF9940 membrane test without diafiltration also found that sugar could be separated but only 80% of the acetic acid was removed, but all of the furans and formic acid were removed. Additionally, the ratio of glucose to xylose can be changed during filtration.

### CONCLUSIONS

These experiments were designed to concentrate the sugar solutions through the use of membrane technology. It was discovered however, that by using different pore size membranes, it is possible to separate color, phenolics, organic acids and furans from sugar using membranes (e.g., through a multi-stage membrane system). More importantly, it is demonstrated that membrane filtration enables the separation of a C5 sugar from a C6 sugar. This system can change the C5/C6 ratios of monosaccharides while removing inhibitors as well.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1.-312. (canceled)

313. A method of clarifying and refining a sugar hydrolyzate comprising C5 sugars and C6 sugars, the method comprising: contacting the sugar hydrolyzate with a first nanofiltration membrane to produce a C6 enriched retentate and a C5 enriched filtrate, wherein the contacting is diafiltration and wherein water is added to the sugar hydrolyzate during the contacting.

314. The method of claim 313, further comprising contacting the sugar hydrolyzate with an ultrafiltration membrane to remove color molecules and suspended solids.

315. The method of claim 314, wherein the sugar hydrolyzate is contacted with the ultrafiltration membrane prior to the first nanofiltration membrane.

316. The method of claim 313, further comprising contacting the sugar hydrolyzate with a second nanofiltration membrane to remove one or more inhibitors.

317. The method of claim 316, wherein the one or more inhibitors are removed prior to producing the C6 enriched retentate and the C5 enriched retentate.

318. The method of claim 313, further comprising contacting the C6 enriched retentate or the C5 enriched retentate with a reverse osmosis membrane to concentrate the C6 or C5 sugars.

319. The method of claim 316, wherein the one or more inhibitors comprise furfural, hydroxymethylfurfural, acetic acid, formic acid, or a combination thereof.

320. The method of claim 313, wherein the first nanofiltration membrane is a spiral wound nanofiltration membrane.

321. The method of claim 313, wherein contacting the sugar hydrolyzate with the first nanofiltration membrane or the second nanofiltration membrane is performed at a pressure of about 250 psi to about 750 psi.

322. The method of claim 313, wherein the water is added when a retentate volume reaches from about 10% to about 75% of a starting volume of the sugar hydrolyzate.

323. The method of claim 313, wherein the C6 sugars comprise glucose.

324. The method of claim 313, wherein the C5 sugars comprise xylose, arabinose, or a combination thereof.

325. The method of claim 313, wherein the sugar hydrolyzate was produced by pretreating or hydrolyzing a biomass comprising cellulosic, hemicellulosic, or lignocellulosic material.

326. A method of refining a sugar hydrolyzate comprising C5 sugars and C6 sugars, the method comprising:
(a) contacting the sugar hydrolyzate with a microfiltration or ultrafiltration membrane to remove color molecules and suspended solids;
(b) contacting the sugar hydrolyzate with a first nanofiltration membrane to remove one or more inhibitors; and
(c) contacting the sugar hydrolyzate with a second nanofiltration membrane to produce a C6 enriched retentate and a C5 enriched filtrate.

327. A system for refining a sugar hydrolyzate, the system comprising:
(a) a sugar hydrolyzate comprising C5 sugars and C6 sugars produced by pretreating or hydrolyzing of a biomass comprising cellulosic, hemicellulosic, or lignocellulosic material;
(b) a first nanofiltration membrane that produces a C6 enriched retentate and a C5 enriched filtrate when the sugar hydrolyzate is contacted with the first nanofiltration membrane; and
(c) a water source that adds water to the sugar hydrolyzate when the sugar hydrolyzate is contacted with the first nanofiltration membrane.

328. The system of claim 327, further comprising an ultrafiltration membrane to remove color molecules and suspended solids from the sugar hydrolyzate.

329. The system of claim 328, wherein the sugar hydrolyzate is contacted with the ultrafiltration membrane prior to the first nanofiltration membrane.

330. The system of claim 327, further comprising a second nanofiltration membrane to remove one or more inhibitors from the sugar hydrolyzate.

331. The system of claim 330, wherein the sugar hydrolyzate is contacted with the second nanofiltration membrane prior to the first nanofiltration membrane.

332. The system of claim 327, further comprising a reverse osmosis membrane to concentrate the C6 or the C5 sugars in the C6 enriched retentate or the C5 enriched filtrate.
